(19) United States
(12) Patent Application Publication
(10) Pub. No.: US 2026/0129188 A1
(43) Pub. Date: May 7, 2026

(54) METHOD FOR ENCODING, METHOD FOR DECODING, AND STORAGE MEDIUM

(71) Applicant: GUANGDONG OPPO MOBILE TELECOMMUNICATIONS CORP., LTD., Dongguan (CN)

(72) Inventor: Zexing SUN, Dongguan (CN)

(73) Assignee: GUANGDONG OPPO MOBILE TELECOMMUNICATIONS CORP., LTD., Dongguan (CN)

(21) Appl. No.: 19/438,833

(22) Filed: Jan. 2, 2026

Related U.S. Application Data
(63) Continuation of application No. PCT/CN2023/106646, filed on Jul. 10, 2023.

(51) Int. Cl. H04N 19/105; H04N 19/107; H04N 19/172; H04N 19/597; H04N 19/70

(52) U.S. Cl. CPC H04N 19/105; H04N 19/107; H04N 19/172; H04N 19/597; H04N 19/70

(57) ABSTRACT

A method for decoding includes: a prediction mode corresponding to a current node is determined; in a case where the prediction mode is a first mode, neighbouring nodes corresponding to the current node are determined in a current picture, and a reference node corresponding to the current node is determined in a reference picture corresponding to the current picture; and a prediction value of the current node is determined according to a first prediction value of the reference node and a second prediction value of the neighbouring nodes.

### CROSS REFERENCE TO RELATED APPLICATION

This is a continuation of International Application No. PCT/CN2023/106646 filed on Jul. 10, 2023, the disclosure of which is hereby incorporated by reference in its entirety.

### TECHNICAL FIELD

Embodiments of the present disclosure relate to the technical field of point cloud encoding and decoding, in particular to a method for encoding, a method for decoding, and a storage medium.

### BACKGROUND

In a Geometry-based Point Cloud Compression (G-PCC) encoding and decoding framework, geometry information and attribute information of a point cloud are encoded separately. The attribute coding of G-PCC may include: Prediction Transform (PT), Lifting Transform (LT), and Region Adaptive Hierarchical Transform (RAHT).

However, the common attribute prediction coding scheme does not take into account the correlation between inter and intra prediction and the attribute value of the current node, which leads to low RAHT attribute coding efficiency of the current node cloud, reduces the prediction effect of the attribute information, and reduces the encoding and decoding performance of the point cloud.

### BRIEF DESCRIPTION OF THE DRAWINGS

FIG. 1A is a schematic diagram of a three-dimensional (3D) point cloud picture;

FIG. 1B is a partial enlargement diagram of a three-dimensional point cloud picture;

FIG. 2A is a schematic diagram of six viewing angles of a point cloud picture;

FIG. 2B is a schematic diagram of a data storage format corresponding to a point cloud picture;

FIG. 3 is a schematic diagram of network architecture of point cloud encoding and decoding;

FIG. 4A is a schematic diagram of a composition framework of a G-PCC encoder;

FIG. 4B is a schematic diagram of a composition framework of a G-PCC decoder;

FIG. 5A is a schematic diagram of a bottom virtual plane position in a Z-axis direction;

FIG. 5B is a schematic diagram of a top virtual plane position in a Z-axis direction;

FIG. 6 is a schematic diagram of a node encoding order;

FIG. 7A is a schematic diagram of plane identification information;

FIG. 7B is another schematic diagram of plane identification information;

FIG. 8 is a schematic diagram of a sibling node of a current node;

FIG. 9 is a schematic diagram of an intersection of a Lidar and a node;

FIG. 10 is a schematic diagram of a neighbourhood node at a same partitioning depth and at a same coordinates;

FIG. 11A is a schematic diagram of a current node located at a bottom virtual plane position of a parent node;

FIG. 11B is another schematic diagram of a current node located at a bottom virtual plane position of a parent node;

FIG. 11C is yet another schematic diagram of a current node located at a bottom virtual plane position of a parent node;

FIG. 12A is a schematic diagram of a current node located at a top virtual plane position of a parent node;

FIG. 12B is another schematic diagram of a current node located at a top virtual plane position of a parent node;

FIG. 12C is yet another schematic diagram of a current node located at a top virtual plane position of a parent node;

FIG. 13 is a schematic diagram of prediction coding of Lidar point cloud plane position information;

FIG. 14 is a schematic diagram of Infer Direct Coding Model (IDCM) coding;

FIG. 15 is a schematic diagram of coordinate conversion of a point cloud obtained by a rotating Lidar;

FIG. 16 is a schematic diagram of prediction coding in an X-axis or Y-axis direction;

FIG. 17A is a schematic diagram of predicting an angle of a Y-plane by a horizontal azimuth angle;

FIG. 17B is a schematic diagram of predicting an angle of an X-plane by a horizontal azimuth angle;

FIG. 18 is another schematic diagram of prediction coding in an X-axis or Y-axis direction;

FIG. 19A is a schematic diagram of three vertices included in a sub-block;

FIG. 19B is a schematic diagram of a triangle soup (trisoup) fitted using three vertices;

FIG. 19C is a schematic diagram of upsampling a trisoup;

FIG. 20 is a schematic diagram of a distance-based Level of Detail (LOD) construction process;

FIG. 21 is a schematic diagram of a visualization result of a LOD generation process;

FIG. 22 is a schematic diagram of an encoding process of an attribute prediction;

FIG. 23 is a schematic diagram of a composition of a pyramid structure;

FIG. 24 is a schematic diagram of a composition of another pyramid structure;

FIG. 25 is a schematic diagram of an LOD structure of an inter-layer nearest neighbour search;

FIG. 26 is a schematic diagram of a nearest neighbour search structure based on a spatial relationship;

FIG. 27A is a schematic diagram of a coplanar spatial relationship;

FIG. 27B is a schematic diagram of a coplanar and collinear spatial relationship;

FIG. 27C is a schematic diagram of a coplanar, collinear, and co-point spatial relationship;

FIG. 28 is a schematic diagram of an inter-layer prediction based on fast search;

FIG. 29 is a schematic structural diagram of LOD of an attribute intra-layer nearest neighbour search;

FIG. 30 is a schematic diagram of an intra-layer prediction based on fast search;

FIG. 31 is a schematic diagram of a block-based neighbourhood search structure;

FIG. 32 is a schematic diagram of an encoding process of a lifting transform;

FIG. 33 is a schematic diagram of an RAHT transform structure;

FIG. 34 is a schematic diagram of a transform process of an RAHT along x, y and z directions;

FIG. 35A is a schematic diagram of a process of a forward RAHT transform;

FIG. 35B is a schematic diagram of a process of an inverse RAHT transform;

FIG. 36 is a schematic structural diagram of an attribute coding block;

FIG. 37 is a schematic diagram of an overall process of an RAHT attribute prediction transform coding;

FIG. 38 is a schematic diagram of a neighbourhood prediction relationship of a current block;

FIG. 39 is a schematic diagram of a calculation process of an attribute transform coefficient;

FIG. 40 is a schematic structural diagram of an RAHT attribute inter prediction coding;

FIG. 41 is a schematic flowchart of a method for decoding according to an embodiment of the present disclosure;

FIG. 42 is a schematic structural diagram of an RAHT attribute coding layer according to an embodiment of the present disclosure;

FIG. 43 is a schematic flowchart of a method for encoding according to an embodiment of the present disclosure;

FIG. 44 is a first schematic structural diagram of a composition of an encoder according to an embodiment of the present disclosure;

FIG. 45 is a second schematic structural diagram of a composition of an encoder according to an embodiment of the present disclosure;

FIG. 46 is a first schematic structural diagram of a composition of a decoder according to an embodiment of the present disclosure;

FIG. 47 is a second schematic structural diagram of a composition of a decoder according to an embodiment of the present disclosure.

### DETAILED DESCRIPTION

In order to understand characteristics and technical contents of the embodiments of the disclosure more thoroughly, implementations of the embodiments of the disclosure will be described in detail below with reference to the drawings. The drawings are only for the purpose of reference and explanation, and are not intended to limit the embodiments of the disclosure.

Unless otherwise defined, all technical and scientific terms used here have the same meanings as those usually understood by technicians in the technical field to which the disclosure belongs. The terms used here are only for the purpose of describing the embodiments of the disclosure, and are not intended to limit the disclosure.

In the following descriptions, reference is made to “some embodiments” which describe a subset of all possible embodiments; however, it may be understood that “some embodiments” may be the same or different subsets of all possible embodiments, and may be combined with each other without conflict.

It should also be pointed out that terms “first\second\third” involved in the embodiments of the disclosure are only intended to distinguish similar objects and do not represent a specific order of the objects. It may be understood that “first\second\third” may be interchanged in a specific order or sequence if allowable, such that the embodiments of the disclosure described here may be implemented in an order besides that illustrated or described here.

Point Cloud is a three-dimensional representation of the surface of an object. The Point Cloud (data) on the surface of an object may be collected through a collection device such as photoelectric radar, Lidar, laser scanner, and multi-view camera.

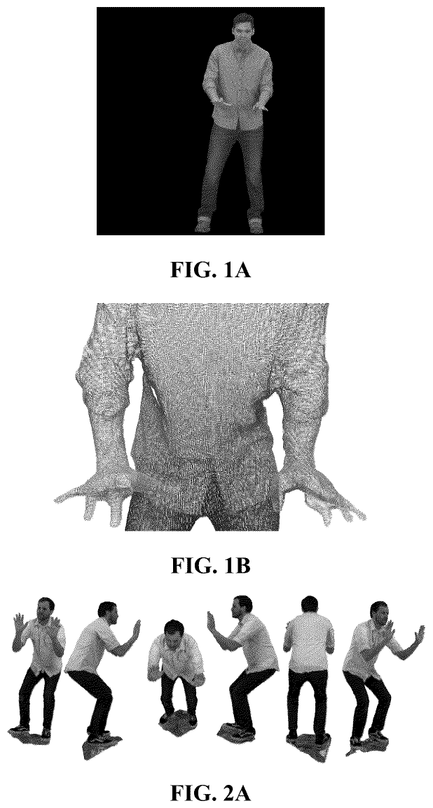

The point cloud is a set of discrete points irregularly distributed in the space and expressing the spatial structure and surface attributes of a three-dimensional object or scene. FIG. 1A shows a three-dimensional point cloud picture and FIG. 1B shows a partial enlargement diagram of the three-dimensional point cloud picture. It can be seen that the point cloud surface is composed of densely distributed points.

For a two-dimensional (2D) picture, each pixel has information presentation and pixels are regularly distributed, so it is not necessary to record position information additionally of each pixel. However, the distribution of points in the point cloud in three-dimensional space is random and irregular, so it is necessary to record a position of each point in the space, so as to completely express one point cloud. Similar to the two-dimensional picture, in an acquisition process, each position has correspondence attribute information, usually being the RGB colour value that reflects a colour of the object. For the point cloud, in addition to the colour information, the attribute information corresponding to each point is more common to be a reflectance value that reflects a surface material of the object. Therefore, the point cloud data usually includes position information of the points and attribute information of the points. The position information of the point may also be referred to as the geometry information of the point. For example, the geometry information of the point may be three-dimensional coordinate information (x, y, z) of the point. The attribute information of the point may include colour information and/or reflectance, and the like. For example, the reflectance may be one-dimensional reflectance information (r). For example, the colour information may be any kind of information in a colour space, or the colour information may be three-dimensional colour information, such as RGB information. Here, R represents Red (R), G represents Green (G), and B represents Blue (B). As another example, the colour information may be luma-chroma (YCbCr, YUV) information. Here, Y represents brightness (Luma), Cb (U) represents blue colour aberration, and Cr (V) represents red colour aberration.

Points in the point cloud obtained according to the principle of laser measurement may include three-dimensional coordinate information of the points and reflectance of the points. For another example, points in the point cloud obtained according to the principle of photogrammetry may include three-dimensional coordinate information of the points and colour information of the points. For another example, points in the point cloud obtained by combining the principles of laser measurement and photogrammetry may include three-dimensional coordinate information of the points, reflectance of the points, and three-dimensional colour information of the points.

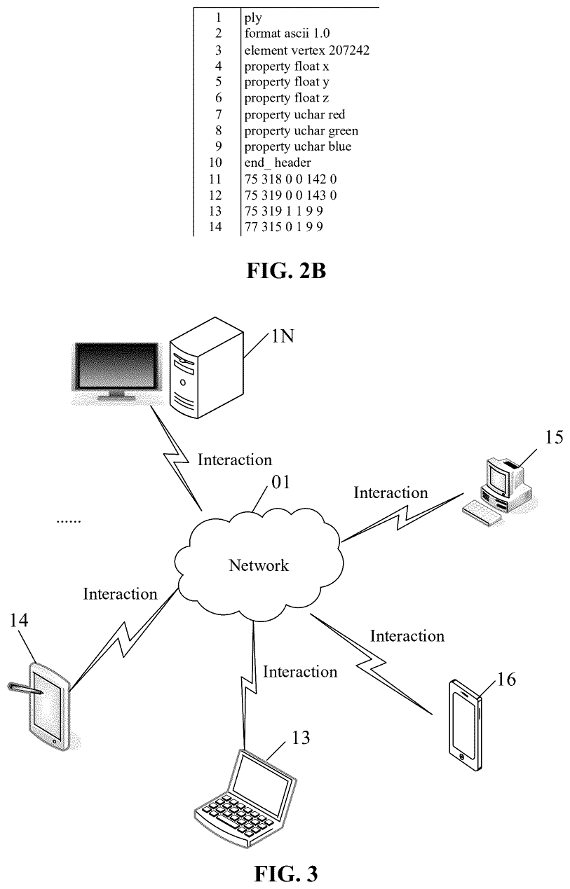

FIG. 2A and FIG. 2B show a point cloud picture and its corresponding data storage format. Here, FIG. 2A provides six viewing angles of the point cloud picture, and FIG. 2B is composed of a file header information part and a data part. The header information includes a data format, a data representation type, a total number of points in the point cloud, and the content represented by the point cloud. For example, the point cloud is in a “.ply” format, represented by ASCII code, with a total number of points of 207242, and each point has three-dimensional coordinate information (x, y, z) and three-dimensional colour information (r, g, b).

Point clouds may be classified according to acquisition method into: static point cloud, dynamic point cloud and dynamically acquired point cloud.

For the static point cloud, the object is stationary, and the device that acquires the point cloud is also stationary.

For the dynamic point cloud, the object is motional, but the device that acquires the point cloud is stationary.

For the dynamically acquired point cloud, the device that acquires the point cloud is motional.

For example, point clouds may be classified according to purpose of the point clouds into two broad categories: machine perception point cloud and human eye perception point cloud.

The first category of the machine perception point cloud may be used in autonomous navigation systems, real-time inspection systems, geographic information systems, visual sorting robots, emergency rescue and disaster relief robots and other scenarios.

The second category of the human eye perception point cloud may be used in point cloud application scenarios such as digital cultural heritage, free viewpoint broadcasting, three-dimensional immersive communication, and three-dimensional immersive interaction.

The point cloud may flexibly and conveniently express the spatial structure and surface attributes of the three-dimensional object or scene; and since the point cloud is obtained by directly sampling a real object, it is possible to provide a strong sense of realism on the premise of ensuring accuracy. Consequently, it is widely used in applications such as virtual reality games, computer-aided design, geographic information system, automatic navigation system, digital cultural heritage, free viewpoint broadcasting, three-dimensional immersive telepresence, three-dimensional reconstruction of biological tissues and organs, etc.

Point clouds are primarily acquired through the following manners: generating by a computer, 3D laser scanning, 3D photogrammetry, etc. A computer is capable of generating a point cloud of a virtual three-dimensional object and scene; the 3D laser scanning is capable of acquiring point cloud of a three-dimensional object or scene in the static real world, and may acquire a point cloud having an order of millions per second; and the 3D photogrammetry is capable of acquiring point cloud of a three-dimensional object or scene in the dynamic real world, and may acquire a point cloud having an order of tens of millions per second. These technologies reduce the cost and time period of acquiring the point cloud data, and improve the accuracy of data. The reformation of a manner for acquiring the point cloud data makes it possible to acquire a large amount of point cloud data. With a growth of a requirement of the application, processing of massive 3D point cloud data encounters the bottleneck of storage space and transmission bandwidth limitation.

Exemplarily, taking a point cloud video with a frame rate of 30 frames per second (fps) as an example, the number of points in each frame of the point cloud is 700,000, and each point has coordinate information xyz (that has a data type of float) and colour information RGB (that has a data type of uchar). The data amount of a 10 seconds (s) point cloud video is about 0.7 million×(4 Byte×3+1 Byte×3)×30 fps×10 s=3.15 GB, where 1 Byte is 10 bits. However, for a 2D video with a resolution of 1280×720 having the YUV sampling format of 4:2:0 and the frame rate of 24 fps, the data amount of such 10 seconds 2D video is about 1280×720×12 bit×24 fps×10 s≈0.33 GB. In this case, the data amount of a 10 seconds 3D video having two views is about 0.33×2=0.66 GB. As can be seen that the data amount of a point cloud video far exceeds the data amount of a two-dimensional video and a three-dimensional video when the point cloud video has a duration same as the two-dimensional video and three-dimensional video. Therefore, in order to better realize data management, save the storage space of a server, and reduce transmission traffic and transmission time between a server and a client, the point cloud compression has become a key issue to promote the development of point cloud industry.

That is to say, since the point cloud is a set of massive points, storage of the point cloud will not only consume a lot of memory, but also it is not conducive to transmission. There is no such large bandwidth to support the direct transmission of the point cloud at the network layer without compression. Therefore, it is necessary to compress the point cloud.

At present, a point cloud encoding framework that can compress the point clouds may be a Geometry-based Point Cloud Compression (G-PCC) encoding and decoding framework or a Video-based Point Cloud Compression (V-PCC) encoding and decoding framework provided by the Moving Picture Experts Group (MPEG), or may also be an Audio Video Standard (AVS)-PCC encoding and decoding framework provided by the AVS. The G-PCC encoding and decoding framework may be used for performing compression on the first type of static point cloud and the third type of dynamically acquired point cloud, which may be based on a point cloud compression test platform Test Model Compression 13 (TMC13), and the V-PCC encoding and decoding framework may be used for performing compression on the second type of dynamic point cloud, which may be based on a point cloud compression test platform Test Model Compression 2 (TMC2). Therefore, the G-PCC encoding and decoding framework is also referred to as a point cloud codec TMC13, and the V-PCC encoding and decoding framework is also referred to as a point cloud codec TMC2.

The embodiments of the present disclosure provide network architecture of a point cloud encoding and decoding system including a method for decoding and a method for encoding. FIG. 3 is a schematic diagram of network architecture of point cloud encoding and decoding according to an embodiment of the present disclosure. As illustrated in FIG. 3, the network architecture includes one or more electronic devices 13 to 1N and a communication network 01. The electronic devices 13 to 1N may perform video interaction through the communication network 01. The electronic device may be various types of devices having point cloud encoding and decoding functions in the process of implementation, for example, the electronic device may include a mobile phone, a tablet computer, a personal computer, a personal digital assistant, a navigator, a digital telephone, a video telephone, a television, a sensing device, a server, and the like, which is not limited in the embodiments of the present disclosure. The decoder or encoder in the embodiments of the present disclosure may be the electronic device described above.

The electronic device in the embodiments of the present disclosure has a point cloud encoding and decoding function, and generally includes a point cloud encoder (i.e., an encoder) and a point cloud decoder (i.e., a decoder).

The related art is described by taking the G-PCC encoding and decoding framework as an example.

It may be understood that in the point cloud G-PCC encoding and decoding framework, the to-be-encoded point cloud data is first partitioned into a plurality of slices by slice partitioning. In each slice, the geometry information of the point cloud and the attribute information corresponding to each point are encoded separately.

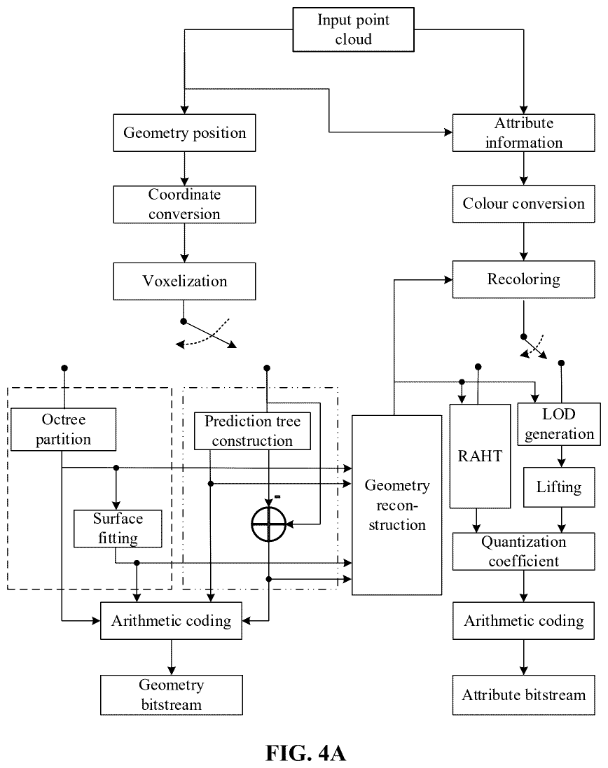

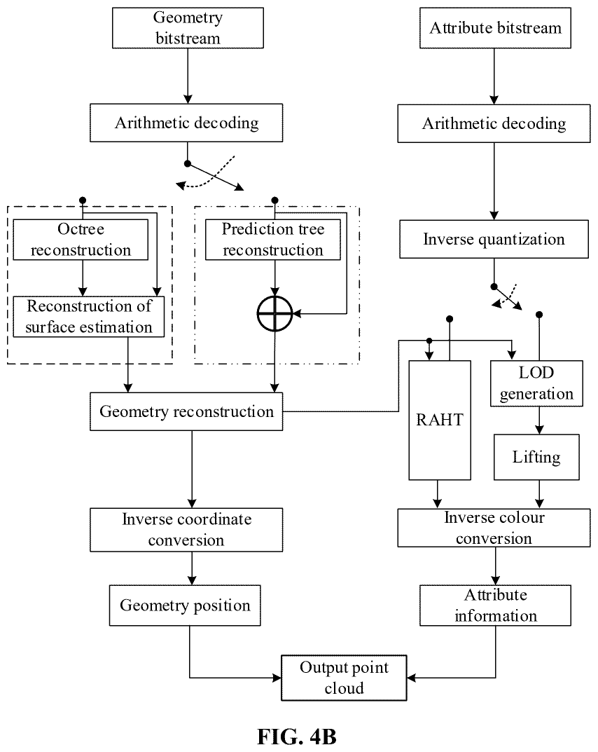

FIG. 4A illustrates a schematic diagram of the composition framework of a G-PCC encoder. As illustrated in FIG. 4A, in the process of geometry encoding, coordinate conversion is performed on geometry information, so that all point clouds are included in a bounding Box, and then are quantized. This step of quantization mainly plays the role of scaling. Due to quantization rounding, the geometry information of some point clouds is the same, so whether to remove repetitive points is decided based on parameters. The process of quantizing and removing repetitive points is also called voxelization process. Then octree partitioning and prediction tree construction are performed on the Bounding Box. In this process, the points in the partitioned leaf nodes are arithmetically encoded to generate a binary geometry bitstream, or the intersection points (the vertices) generated by the partition are arithmetically encoded (surface fitting is performed based on the intersection points) to generate a binary geometry bitstream. In the process of encoding for the attribute, after the geometry encoding is completed and the geometry information is reconstructed, it is necessary to perform colour conversion first to convert the colour information (i.e., attribute information) from RGB colour space to YUV colour space. Then, the point cloud is recolored by using the reconstructed geometry information, so that the attribute information that is not encoded corresponds to the reconstructed geometry information. Attribute encoding is mainly performing for colour information. In the process of encoding for the colour information, there are two main transform methods, one is distance-based lifting transform which depends on LOD partitioning, and the other is direct RAHT. By both methods, colour information will be converted from spatial domain to frequency domain, and high-frequency coefficients and low-frequency coefficients are obtained through transform. Finally, the coefficients are quantized, and then the quantized coefficients are arithmetically encoded to generate a binary attribute bitstream.

FIG. 4B illustrates a schematic diagram of the composition framework of a G-PCC decoder. As illustrated in FIG. 4B, for the obtained binary bitstream, firstly the geometry bitstream and the attribute bitstream in the binary bitstream are decoded independently. When decoding the geometry bitstream, the geometry information of the point cloud is obtained by arithmetic decoding-octree reconstruction/prediction tree reconstruction-geometry reconstruction-inverse coordinate conversion. When decoding the attribute bitstream, the attribute information of the point cloud is obtained by arithmetic decoding-inverse quantization-LOD partitioning/RAHT-inverse colour conversion, and the point cloud data to be encoded is restored (i.e., output point cloud) based on the geometry information and the attribute information.

It should be noted that, as shown in FIG. 4A or FIG. 4B, at present, the geometry encoding and decoding of G-PCC can be divided into octree geometry encoding and decoding (identified by a dashed box) and predictive geometry encoding and decoding (identified by a dash-dotted box).

For octree geometry encoding (OctGeomEnc), the process includes: the coordinate conversion is firstly performed on the geometry information to include all the point cloud in a bounding box. Then quantization is performed. This operation of quantization mainly plays the role of scaling. Because of the quantization rounding, the geometry information of some points is the same. Whether to remove repetitive points is determined according to parameters. The process of quantization and removing repetitive points is also called voxelization process. Next, tree (such as octree, quadtree, binary tree, etc.) partitioning is continuously performed on the bounding box in the order of breadth-first traversal, and the occupancy code of each node is encoded. In the related art, a company proposed an implicit geometry partitioning mode. First, the bounding box of the point cloud (2^{d}^{ₓ}, 2^{d}^{_{y}}, 2^{d}^{_{z}}) is calculated, assuming that dₓ>d_{y}>d_{z}, the bounding box corresponds to a cuboid. During geometry partitioning, binary tree partitioning is first performed continuously based on the x-axis to obtain two child nodes; until the condition of dₓ=d_{y}>d_{z} is met, the quadtree partitioning will be performed continuously based on the x and y axes to obtain four child nodes; when the condition of dₓ=d_{y}=d_{z} is finally met, the octree partitioning will be performed until the partitioned leaf nodes become a 1×1×1 unit cube, and the points in the leaf nodes are encoded to generate a binary bitstream. In the process of binary tree/quadtree/octree partitioning, two parameters: K and M are introduced. The parameter K indicates the maximum number of binary tree/quadtree partitioning before octree partitioning. The parameter M indicates the minimum block side length when during binary tree/quadtree partitioning, which is 2^{M}. Furthermore, K and M must meet the conditions: assuming that dₘₐₓ=max(dₓ,d_{y},d_{z}), dₘᵢₙ=min(dₓ,d_{y},d_{z}), the parameter K meets: K≥dₘₐₓ−dₘᵢₙ; the parameter M meets: M≥dₘᵢₙ. The reason why parameters K and M meet the above conditions is that in the process of geometry implicit partitioning of G-PCC at present, the priority of partitioning modes is binary tree, quadtree and octree. When the node block size does not meet the condition of binary tree/quadtree, octree partitioning will be performed on the node until it is partitioned into the minimum unit of leaf nodes of 1×1×1. The octree geometry information encoding can effectively encode the geometry information of the point cloud by using the correlation between neighbouring nodes in space, but for some flat nodes or nodes with planar characteristics, the coding efficiency of the point cloud geometry information can be further improved by using plane coding.

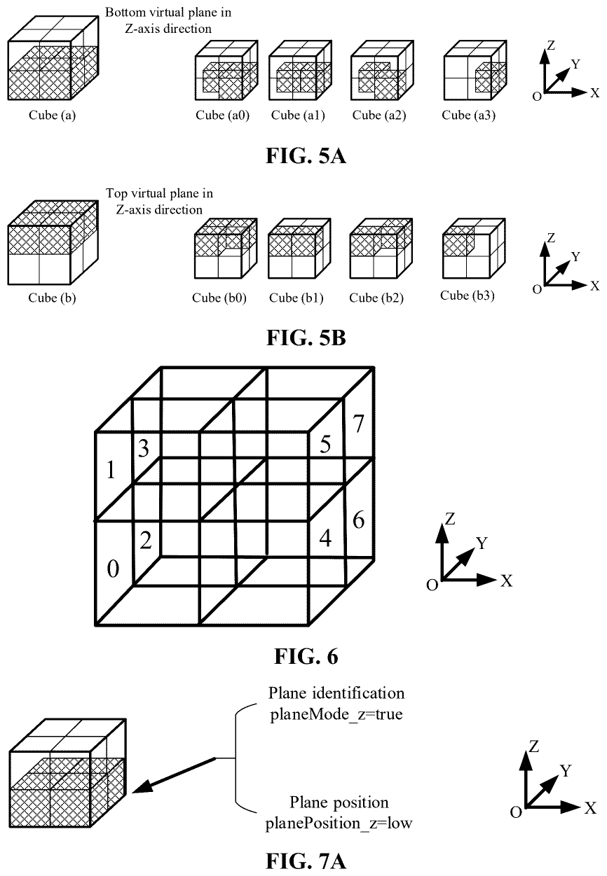

Exemplarily, FIG. 5A and FIG. 5B provide plane position schematic diagrams. FIG. 5A shows a schematic diagram of a bottom virtual plane position in the Z-axis direction, and FIG. 5B shows a schematic diagram of a top virtual plane position in the Z-axis direction. As shown in FIG. 5A, cubes (a), (a0), (a1), (a2), and (a3) here all belong to the bottom virtual plane position in the Z-axis direction. Taking cube (a) as an example, it can be seen that four occupied child nodes in the current node are all located at the bottom virtual plane position of the current node in the Z-axis direction, so it can be considered that the current node belongs to a Z-plane and is a bottom virtual plane in the Z-axis direction. Similarly, as shown in FIG. 5B, cubes (b), (b0), (b1), (b2), and (b3) here all belong to the top virtual plane position in the Z-axis direction. Taking cube (b) as an example, it can be seen that four occupied child nodes in the current node are located at the top virtual plane position of the current node in the Z-axis direction, so it can be considered that the current node belongs to a Z-plane and is a top virtual plane in the Z-axis direction.

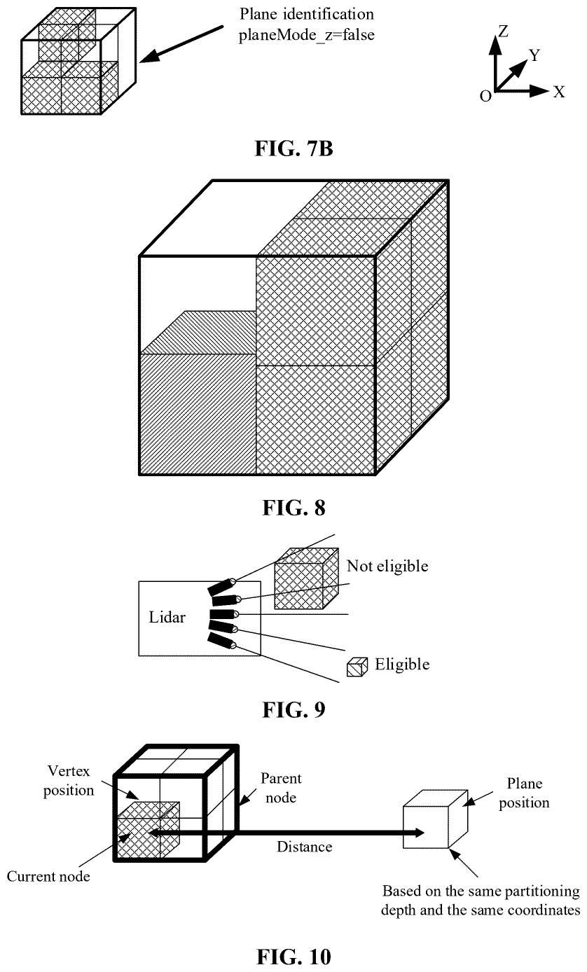

Further, taking cube (a) in FIG. 5A as an example to compare the efficiencies of octree coding and plane coding, FIG. 6 provides a schematic diagram of a node encoding order, that is, node encoding is performed in the order of 0, 1, 2, 3, 4, 5, 6, and 7 shown in FIG. 6. Here, if the octree coding mode is adopted for cube (a) in FIG. 5A, the occupancy information of the current node is expressed as: 11001100. However, if the plane coding mode is adopted, firstly, an identifier needs to be encoded to indicate that the current node is a plane in the Z-axis direction, and secondly, if the current node is a plane in the Z-axis direction, the plane position of the current node needs to be represented; thirdly, only the occupancy information of the bottom virtual plane node in the Z-axis direction needs to be encoded (that is, the occupancy information of the four child nodes 0, 2, 4, and 6). Therefore, only 6 bits need to be encoded to encode the current node based on the plane coding mode, which can reduce the representation of 2 bits compared with the octree coding of the related art. Based on this analysis, plane coding has significantly higher coding efficiency than octree coding. Therefore, for an occupied node, if plane coding mode is applied in in a certain dimension, firstly, the plane identification (planarMode) and plane position (PlanePos) information of the current node in this dimension need to be represented, and secondly, the occupancy information of the current node needs to be encoded based on the plane information of the current node. Exemplarily, FIG. 7A shows a schematic diagram of plane identification information. As shown in FIG. 7A, the current node here is a bottom virtual plane in the Z-axis direction; correspondingly, the value of the plane identification information is true or 1, that is, planarMode_z=true; plane position information is bottom virtual plane (low), that is, PlanePosition_z=low. FIG. 7B shows another schematic diagram of plane identification information. As shown in FIG. 7B, the current node here is not a plane in the Z-axis direction; correspondingly, the value of the plane identification information is false or 0, that is, planarMode_z=false.

It should be noted that for PlaneMode_ᵢ: 0 means that the current node is not a plane in the i-axis direction, and 1 means that the current node is a plane in the i-axis direction. If the current node is a plane in the i-axis direction, for PlanePosition_ᵢ: 0 means that the current node is a plane in the i-axis direction and the plane position is a bottom virtual plane, and 1 means that the current node is a top virtual plane in the i-axis direction. Here, i represents a coordinate dimension, which can be the X-axis direction, the Y-axis direction, or the Z-axis direction, so that i=0, 1, 2.

In the G-PCC standard, when determining whether a node meets the plane coding condition or not and when the node meets the plane coding condition, prediction coding for the plane identification and plane position information of the node is required.

In the embodiment of the present disclosure, there are three kinds of determination conditions in the current G-PCC standard for determining whether a node meets the conditions for plane coding, which are described in detail one by one below.

### I. Determine According to the Plane Probability of the Node in Each Dimension.

(1) Determine the local region density (local_node_density) of the current node.

(2) Determine the probability Prob(i) of the current node in each dimension.

When the local region density of the node is less than the threshold Th (e.g., Th=3), the plane probability Prob(i) of the current node in three coordinate dimensions are compared with the thresholds Th0, Th1, and Th2, where Th0<Th1<Th2 (e.g., Th0=0.6, Th1=0.77, Th2=0.88), where Eligibleᵢ (i=0, 1, 2) can be used to indicate whether plane coding is enabled in each dimension: Eligibleᵢ=Prob(i)>=threshold.

It should be noted that the threshold is adaptively changed, for example, when Prob(0)>Prob(1)>Prob(2), Eligibleᵢ is set as follows:

$$Elig {ible}_{0} = Prob ( 0 ) >= Th 0 ; \\ Elig {ible}_{1} = Prob ( 1 ) >= Th l ; \\ {Eligible}_{2} = Prob ( 2 ) >= Th 2 .$$

When Prob(1)>Prob(0)>Prob(2), Eligibleᵢ is set as follows:

$$Elig {ible}_{0} = Prob ( 0 ) >= Th 1 ; \\ Elig {ible}_{1} = Prob ( 1 ) >= Th 0 ; \\ {Eligible}_{2} = Prob ( 2 ) >= Th 2 .$$

Here, Prob(i) is updated as follows:

$$Prob {( i )}_{new} = ( L \times P r o b ( i ) + δ ( coded node ) ) / L + 1 \qquad ( 1 )$$

Where L=255; in addition, if the coded node is a plane, δ(coded node) is 1; otherwise δ(coded node) is 0.

Here, local_node_density is updated as follows:

$$1 ocal\_node {\_density}_{new} = 1 ocal\_node \_density + 4 * numSiblings \qquad ( 2 )$$

Where local_node_density is initialized to 4, and numSiblings is the number of sibling nodes of this node. Exemplarily, FIG. 8 shows a schematic diagram of a sibling node of a current node. As shown in FIG. 8, the current node is a node padded with oblique lines, and the node padded with grids are sibling nodes, so the number of sibling nodes of the current node is 5 (including the current node itself).

### II. Determine Whether the Nodes of the Current Layer Meet the Plane Coding Condition According to the Point Cloud Density of the Current Layer.

The density of points of the current layer is used to determine whether to perform plane coding on the nodes of the current layer. It is assumed that the number of points in the current to-be-encoded point cloud is pointCount, and the number of points that have been reconstructed by Infer Direct Coding Model (IDCM) coding is numPointCountRecon, since the octree coding is based on the order of breadth-first traversal, the number of to-be-encoded nodes in the current layer can be obtained as nodeCount, and then whether the current layer enables plane coding is assumed to be planarEligibleKOctreeDepth, specifically: planarEligibleK OctreeDepth=(pointCount−numPointCountRecon)<nodeCount×1.3.

Where if (pointCount−numPointCountRecon) is less than nodeCount×1.3, then planarEligibleKOctreeDepth is true; If (pointCount−numPointCountRecon) is not less than nodeCount×1.3, then planarEligibleKOctreeDepth is false. In this way, when planarEligibleKOctreeDepth is true, plane coding is applied to all nodes in the current layer; otherwise, plane coding is not applied to any node in the current layer, but only octree coding is used.

### III. Determine Whether the Current Node Meets the Plane Coding Condition According to the Acquisition Parameters of the Lidar Point Cloud.

FIG. 9 shows a schematic diagram of an intersection of a Lidar and a node. As shown in FIG. 9, the node padded with grids is passed through by two lasers simultaneously, so that the current node is not a plane in the Z-axis vertical direction. A node padded with oblique lines is sufficiently small that it cannot be passed through by two lasers simultaneously. Hence, it is possible that the node padded with oblique lines is a plane in the Z-axis vertical direction.

Further, for a node meeting the plane coding condition, prediction coding of plane identification information and plane position information may be performed.

Firstly, prediction coding of plane identification information.

Here, only three pieces of context information are used for encoding, that is, the plane identification on each coordinate dimension is separately designed for context.

Secondly, prediction coding of plane position information.

It should be understood that, for encoding of non-Lidar point cloud plane position information, prediction coding of plane position information may include the following.

(a) Using the occupancy information of the neighbourhood nodes to predict the plane position information of the current node, resulting in three elements: predicted as bottom virtual plane, predicted as top virtual plane, and unpredictable.

(b) The spatial distance between the node at the same partitioning depth and the same coordinates as the current node and the current node: “near” and “far”.

(c) If the node at the same partitioning depth and the same coordinates as the current node is a plane, determining the plane position of the node.

(d) Coordinate dimensions (i=0, 1, 2).

It should be noted that, in the embodiment of the present disclosure, after determining the spatial distance between the node at the same partitioning depth and the same coordinates as the current node and the current node, if the spatial distance is less than a preset distance threshold, it may be determined that the spatial distance is “near”. Alternatively, if the spatial distance is greater than the preset distance threshold, it may be determined that the spatial distance is “far”.

Exemplarily, FIG. 10 shows a schematic diagram of a neighbourhood node at the same partitioning depth and the same coordinates. As shown in FIG. 10, the bold large cube represents a parent node, and the small cube padded with grids inside the large cube represents the current node, and the vertex position of the current node is shown. The small cube padded with white represents a neighbourhood node at the same partitioning depth and the same coordinates. The distance between the current node and the neighbourhood node is the spatial distance, which can be determined as “near” or “far”. In addition, if the neighbourhood node is a plane, the plane position (also known as the planar position) of the neighbourhood node is also required.

In this way, as shown in FIG. 10, the current node is the small cube padded with grids, the neighbourhood nodes is searched as the small cube padded with white under the same octree partitioning depth level and the same vertical coordinates, the distance between the two nodes is determined as “near” or “far”, and the plane position of the node is referred to.

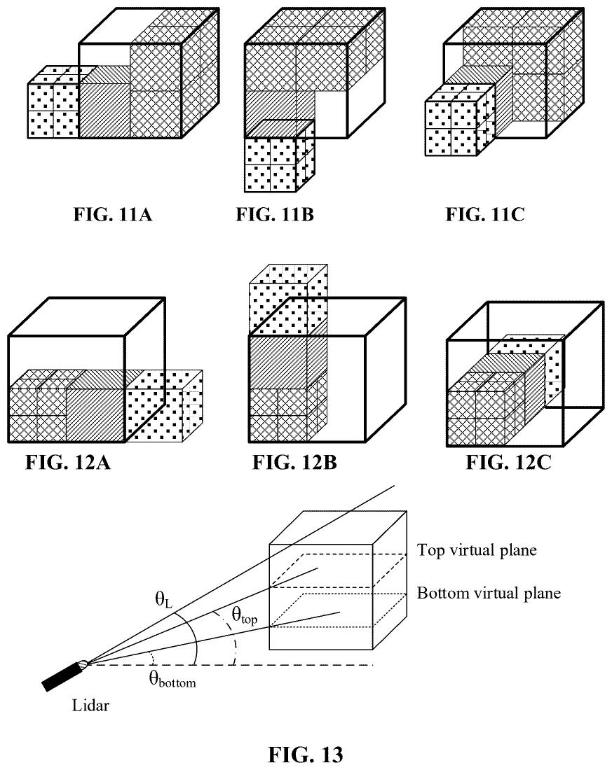

Further, in the embodiment of the present disclosure, FIGS. 11A to 11C show schematic diagrams of a current node located at a bottom virtual plane position of a parent node. FIGS. 11A to 11C show examples of three kinds of current nodes located at the bottom virtual plane position of the parent node. Specific instructions are as follows.

\textcircled{1} If any of the child nodes 4 to 7 of the point-padded node is occupied, but all the grid-padded nodes are not occupied, it is very likely that there is a plane in the current node (padded with oblique lines), and the position of the plane is low.

\textcircled{2} If none of the child nodes 4 to 7 of the point-padded node is occupied, but any of the grid-padded node is occupied, it is very likely that there is a plane in the current node (padded with oblique lines), and the position of the plane is high.

\textcircled{3} If the child nodes 4 to 7 of the point-padded node are all empty nodes, and the grid-padded nodes are all empty nodes, the plane position cannot be inferred, so it is marked as unknown.

\textcircled{4} If any of the child nodes 4 to 7 of the point-padded node is occupied, and any of the grid-padded nodes is occupied, the plane position cannot be inferred at this time, so it is marked as unknown.

In the embodiment of the present disclosure, FIGS. 12A to 12C show schematic diagrams of a current node located at a top virtual plane position of a parent node. FIGS. 12A to 12C show examples of three kinds of current nodes located at the top virtual plane position of the parent node. Specific instructions are as follows.

\textcircled{1} If any of the child nodes 4 to 7 of the grid-padded node is occupied, but the point-padded node is not occupied, it is very likely that there is a plane in the current node (padded with oblique lines), and the plane position is low.

\textcircled{2} If none of the child nodes 4 to 7 of the grid-padded node is occupied, but the point-padded node is occupied, it is very likely that there is a plane in the current node (padded with oblique lines), and the plane position is high.

\textcircled{3} If all the child nodes 4 to 7 of the grid-padded node are not occupied, and the point-padded node is not occupied, the plane position cannot be inferred at this time, so it is marked as unknown.

\textcircled{4} If one of the child nodes 4 to 7 of the grid-padded node is occupied, and the point-padded node is occupied, the plane position cannot be inferred at this time, so it is marked as unknown.

It should also be understood that FIG. 13 shows a schematic diagram of prediction coding of Lidar point cloud plane position information for encoding of Lidar point cloud plane position information. As shown in FIG. 13, when the emission angle of the Lidar is θ_{bottom}, it can be mapped to a bottom virtual plane; when the emission angle of the Lidar is θₜₒₚ, it can be mapped to a top virtual plane.

That is, the plane position of the current node is predicted by using the Lidar acquisition parameters, and the position is quantified into a plurality of intervals by using the position where the current node intersects with the laser, and finally serves as context information of the plane position of the current node. The specific calculation process is as follows: assuming that the coordinates of the Lidar are (x_{Lidar}, y_{Lidar}, z_{Lidar}) and the geometry coordinates of the current node are (x, y, z), then first calculate the vertical tangent value tan θ of the current node relative to the Lidar, and the calculation formula is as follows:

$$tan θ = \frac{z - {z}_{Lidar}}{\sqrt{{( x - {x}_{Lidar} )}^{2} + {( y - {y}_{Lidar} )}^{2}}} \qquad ( 3 )$$

Furthermore, because each laser will have a certain offset angle relative to the Lidar, it is also necessary to calculate the relative tangent value tan θ_{corr, L} of the current node relative to the laser. The specific calculation is as follows:

$$tan {θ}_{c o r r} , L = \frac{z - {z}_{Lidar} - {z}_{L}}{\sqrt{{( x - {x}_{Lidar} )}^{2} + {( y - {y}_{Lidar} )}^{2}}} = tan θ - \frac{{z}_{L}}{r} \qquad ( 4 )$$

Finally, the plane position of the current node is predicted by using the relative tangent value tan θ_{corr, L} of the current node. Specifically, assuming that the tangent value of the bottom boundary of the current node is tan(θ_{bottom}) and the tangent value of the top boundary is tan(θₜₒₚ), the plane position is quantized into four quantization intervals according to tan θ_{corr, L}, that is, the context information of the plane position is determined.

However, the octree geometry information coding mode only has a high compression rate for points with spatial correlation, while for the isolated points in geometry space, using Direct Coding Model (DCM) can greatly reduce the complexity. For all nodes in the octree, the use of DCM is not represented by flag information, but inferred by the parent node and neighbouring information of the current node. There are three ways to determine whether the current node is eligible for DCM coding, the details are as follows.

(1) The current node has no sibling child nodes, that is, the parent node of the current node has only one child node, and the parent node of the parent node of the current node has only two occupied child nodes, that is, the current node has only one neighbouring node at most.

(2) The parent node of the current node has only one occupied child node, which is the current node itself, and the six neighbouring nodes that share a plane with the current node are all empty nodes.

(3) The number of the sibling nodes of the current node is greater than 1.

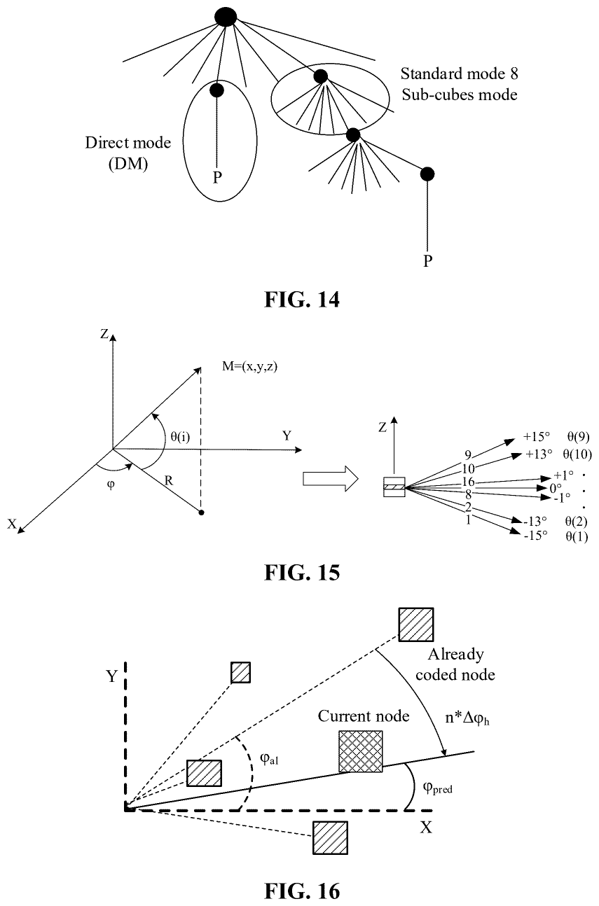

Exemplarily, FIG. 14 provides a schematic diagram of IDCM coding. If the current node is not eligible for DCM coding, octree partitioning will be perform on the current node; if the current node is eligible for DCM coding, the number of points included in the node will be further determined. When the number of points is less than a threshold (such as 2), DCM coding will be performed on the node; otherwise, the octree partitioning will be continued. When applying DCM coding mode, it is first necessary to encode whether the current node is a real isolated point, that is, IDCM_flag is encoded. When IDCM_flag is true, the current node adopts DCM coding, otherwise it still adopts octree coding. When the current node meets the requirements of DCM coding, it is necessary to encode the DCM coding mode of the current node. At present, there are two DCM modes, namely: (a) only one point exists (or multiple points exist, but they are repetitive points); (b) two points are included. Finally, the geometry information of each point needs to be encoded. Assuming that the side length of a node is 2^{d}, d bits are needed to encode each component of the geometry coordinates of the node, and this bit information is directly encoded into the bitstream. It should be noted that when encoding the Lidar point cloud, the coding efficiency of geometry information can be further improved by using the Lidar collection parameters to perform prediction coding on the coordinate information of three dimensions.

Further, the process of IDCM coding will be described in detail below.

When the current node meets the requirements of the DCM coding mode, the number of points numPoints of the current node is first encoded; the number of points of the current node is encoded according to different modes (DirectMode).

(1) If the current node does not meet the requirements of the DCM node, exit directly (i.e., the number of points is greater than 2, and the points are not repetitive points).

(2) If the number of points numPonts included in the current node is less than or equal to 2, the encoding process is as follows.
(i) Firstly, encode whether the numPonts of the current node is greater than 1.
(ii) If the current node has only one point and the geometry encoding environment is geometry lossless encoding, it is necessary to encode that the second point of the current node is not a repetitive point.

(3) If the number of points numPonts included in the current node is greater than 2, the encoding process is as follows.
(i) Firstly, encode that the numPonts of the current node is less than or equal to 1.
(ii) Secondly, encode that the second point of the current node is a repetitive point, and then, encode that whether the number of repetitive points of the current node is greater than 1. When the number of repetitive points is greater than 1, it is necessary to perform exponential Columbus decoding on the remaining number of repetitive points.

After the number of points of the current node is encoded, coordinate information of the points included in the current node is encoded. The Lidar point cloud and the eye-oriented point cloud will be introduced in detail below.

### (I) Eye-Oriented Point Cloud.

(1) If the current node includes only one point, the geometry information of the three dimensional directions of the point will be directly encoded (Bypass coding).

(2) If the current node includes two points, the prioritized encoding axis dirextAxis will be obtained first by using the geometry coordinates of the points. It should be noted that the coordinate axes currently compared only include the x-axis and y-axis, and do not include the z-axis. Assuming that the geometry coordinates of the current node are nodePos, the determination is made as follows:

$$dirextAxis = ! ( nodePos [ 0 ] < nodePos [ 1 ] ) \qquad ( 5 )$$

That is, the axis having a small coordinate value of the geometry position of the node is used as the prioritized encoding coordinate axis dirextAxis, and secondly, the geometry information of the prioritized encoding coordinate axis dirextAxis is first encoded as follows. Assuming that the to-be-encoded geometry bit depth corresponding to the prioritized encoding axis is nodeSizeLog2, and assuming that the coordinates of the two points are pointPos[0] and pointPos[1], respectively. The specific encoding process is as follows:

```
  Bool sameBit=true;
    while(nodeSizeLog2&& sameBit){
      int mask=1<< nodeSizeLog2;
      --nodeSizeLog2;
      bool bit0=!!( pointPos[0]& mask)
bool bit1=!!( pointPos[1]& mask)
      sameBits=bit0==bit1;
      entropyCodeSameBit(sameBits); ///<entropy coding
      if(sameBits)
        encodePosBit(bit0);///<Bypass coding
        }
```

After the prioritized encoding coordinate axis dirextAxis is encoded, direct encoding of the geometry coordinates of the current node is continued. Assuming that the remaining encoding bit depth of each point is nodeSizeLog2, the specific encoding process is as follows:

for(int axisIdx=0;axisIdx<3;++axisIdx)
for(int mask=(1<< nodeSizeLog2[axisIdx])>>1;mask;mask>>1)
encodePosBit(!!(pointPos[axisIdx]&mask)).

### (II) Lidar-Oriented Point Cloud.

If the current node includes two points, the prioritized encoding axis dirextAxis will be obtained first by using the geometry coordinates of the points. Assuming that the geometry coordinates of the current node are nodePos, the determination is made as follows:

$$dirextAxis = ! ( nodePos [ 0 ] < nodePos [ 1 ] )$$

That is, the axis having a small coordinate value of the geometry position of the node is used as the prioritized encoding coordinate axis dirextAxis. It should be noted that the coordinate axes currently compared only include the x-axis and y-axis, and do not include the z-axis. Secondly, the geometry information of the prioritized encoding coordinate axis dirextAxis is first encoded as follows. Assuming that the to-be-encoded geometry bit depth corresponding to the prioritized encoding axis is nodeSizeLog2, and assuming that the coordinates of the two points are pointPos[0] and pointPos[1], respectively. The specific encoding process is as follows:

```
  Bool sameBit=true;
    while(nodeSizeLog2&& sameBit){
      int mask=1<< nodeSizeLog2;
      --nodeSizeLog2;
      bool bit0=!!( pointPos[0]& mask)
bool bit1=!!( pointPos[1]& mask)
      sameBits=bit0==bit1;
      entropyCodeSameBit(sameBits);
      if(sameBits)
        encodePosBit(bit0);
        }
```

After the prioritized encoding coordinate axis dirextAxis is encoded, the geometry coordinates of the current node are encoded.

Since the Lidar point cloud can obtain the acquisition parameters of the Lidar point cloud, the geometry information encoding efficiency of the point cloud can be further improved by using the geometry coordinate information that can predict the current node. Similarly, the geometry information nodePos of the current node is first used to obtain a directly encoded main axis direction, and secondly, the geometry information of the encoded direction is used to perform prediction coding on the geometry information of another dimension. Similarly, assuming that the directly encoded axis direction is directAxis, and assuming that the to-be-encoded bit depth in direct encoding is nodeSizeLog2, the coding process is as follows:

for(int mask=(1<< nodeSizeLog2)>>1;mask;mask>>1);
encodePosBit(!!(pointPos[directAxis]&mask)).

It should be noted that all the geometry accuracy information of the directAxis direction will be encoded here.

Exemplarily, FIG. 15 provides a schematic diagram of coordinate conversion of a point cloud obtained by a rotating Lidar. In the Cartesian coordinate system, the (x, y, z) coordinates of each node can be converted to (R, φ, i). In addition, the laser scanner can perform laser scanning at a preset angle, and different θ(i) can be obtained under different values of i. For example, when i is equal to 1, θ(1) can be obtained at this time, and the corresponding scanning angle is −15°; When i is equal to 2, θ(2) can be obtained at this time, and the corresponding scanning angle is −13°; When i is equal to 10, θ(10) can be obtained at this time, and the corresponding scanning angle is +13°; When i is equal to 9, θ(19) can be obtained at this time, and the corresponding scanning angle is +15°.

In this way, after all the precision of the directAxis coordinate direction is encoded, the LaserIdx corresponding to the current node (i.e., the pointLaserIdx in FIG. 15) is first calculated, and the LaserIdx of the current node (i.e., nodeLaserIdx) is calculated. Secondly, the LaserIdx of the node (i.e., nodeLaserIdx) is used to perform prediction coding on the LaserIdx of the point (i.e., pointLaserIdx), where the calculation of the LaserIdx of the node or point is as follows. Assuming that the geometry coordinate of the point is pointPos, the starting coordinate of the laser is LidarOrigin, and the number of Lasers is LaserNum, the tangent value of each Laser is tan θᵢ, and the offset position of each Laser in the vertical direction is Zᵢ, then:

```
  Int bestLaserIdx=0;
    Int Distoration=INT_MAX;
  For(int LaserIdx=0; LaserIdx<numLaser;++ LaserIdx){
$int radius = \sqrt{( pointPos [ 0 ] - LidarOrigin [ 0 ] ) 2 + ( pointPos [ 1 ] - LidarOrigin [ 1 ] ) 2}$
    int invRadius=1/ radius
    int Z=pointPos[2]+ Zᵢ
    int tanTheta= Z×invRadius
    if(std::abs(tanTheta-tanθᵢ)< Distoration){
    Distoration= std::abs(tanTheta-tanθᵢ);
    bestLaserIdx= LaserIdx;
    }
  }
```

After the LaserIdx of the current node is calculated, prediction coding is first performed on the pointLaserIdx of the point by using the LaserIdx of the current node. After the LaserIdx of the current node is encoded, prediction coding is performed on the geometry information of three dimensions of the current node by using the acquisition parameters of the Lidar.

Exemplarily, FIG. 16 shows a schematic diagram of prediction coding in an X-axis or Y-axis direction. As shown in FIG. 16, the box padded with grids represents the current node (current point), and boxes padded with oblique lines represent the coded point (already coded node). Here, the LaserIdx corresponding to the current node is first used to obtain the prediction value of the corresponding horizontal azimuth angle, that is, φ_{pred}. Secondly, the horizontal azimuth angle φ_{node} corresponding to the node is obtained by using the geometry information of the node corresponding to the current node. Assuming that the geometry coordinate of the node is nodePos, the calculation between the horizontal azimuth angle φ and the geometry information of the node is as follows:

$$φ = arctan ( nodePos [ 1 ] / nodePos [ 0 ] ) \qquad ( 6 )$$

By using the acquisition parameters of the Lidar, the number of rotation points numPoints of each Laser can be obtained, which represents the number of points obtained by each laser during one full rotation, and the rotation angular velocity deltaPhi of each laser can be calculated by using the number of rotation points of each laser, and the calculation is as follows:

$$deltaPhi = \frac{2 π}{n u m P oints} \qquad ( 7 )$$

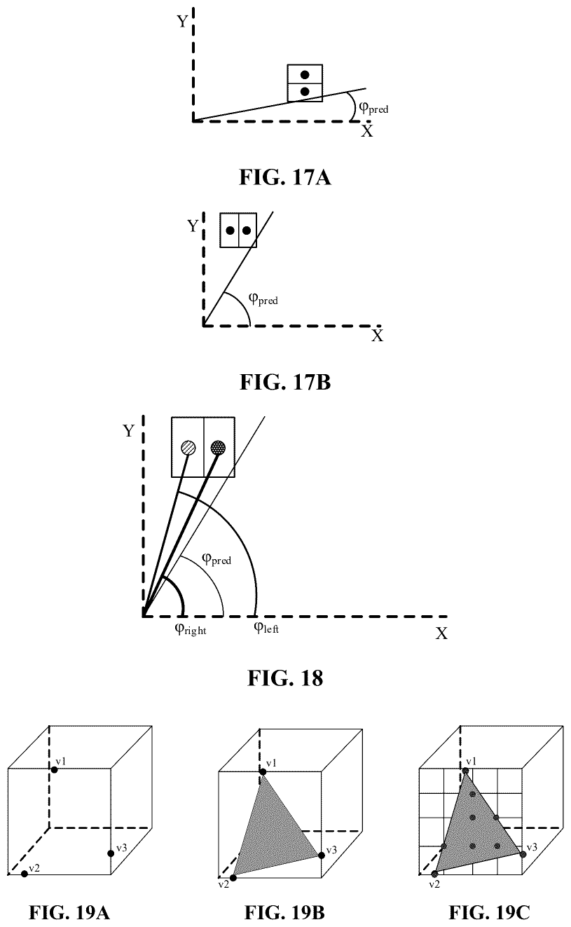

Further, the horizontal azimuth angle prediction value φ_{predPoint} corresponding to the current node (that is, the horizontal azimuth angle prediction value shown in FIG. 17A and FIG. 17B) is calculated by using the horizontal azimuth angle φ_{node} of the node and the horizontal azimuth angle φ_{pred} of the previous coding point of the laser corresponding to the current node. Here, FIG. 17A shows a schematic diagram of predicting an angle of a Y-plane by a horizontal azimuth angle, and FIG. 17B shows a schematic diagram of predicting an angle of an X-plane by a horizontal azimuth angle. Here, the calculation of the horizontal azimuth angle prediction value φ_{predPoint} corresponding to the current node is as follows:

$${φ}_{p r e d P o i n t} = \frac{φ pred - φ node}{deltaPhi} \times deltaPhi + φ pred \qquad ( 8 )$$

Exemplarily, FIG. 18 shows another schematic diagram of prediction coding in an X-axis or Y-axis direction. As shown in FIG. 18, the portion padded with grids (left side) represents the bottom virtual plane, the portion padded with points (right side) represents the top virtual plane, φleft represents the bottom virtual plane horizontal azimuth angle of the current node, φright represents the top virtual plane horizontal azimuth angle of the current node, and φpred represents the horizontal azimuth angle prediction value corresponding to the current node.

In this way, prediction coding is performed on the geometry information of the current node by using the prediction value φ_{predPoint} of the horizontal azimuth angle and the bottom virtual plane horizontal azimuth angle φ_{left} and the top virtual plane horizontal azimuth angle φ_{right} of the current node. The details are as follows:

$$int angLel = {φ}_{left} - {φ}_{pred} ;$$

$$int angLeR = {φ}_{right} - {φ}_{pred} ;$$

$$int context = ( angLel \geq 0 \&\& angLeR \geq 0 ) \vert \vert ( angLel < 0 \&\& angLeR < 0 ) ? 0 : 2 ;$$

$$int min Angle = std ∷ min ( abs ( angLel ) , abs ( angLeR ) ) ;$$

$$int max Angle = std ∷ max ( abs ( angLel ) , abs ( angLeR ) ) ;$$

$$context + max Angle > min Angle ? 0 : 1 ;$$

$$context + max Angle > min Angle ? 0 : 4 ;$$

After the LaserIdx of the point is encoded, prediction coding is performed on the Z-axis direction of the current node by using the LaserIdx corresponding to the current node, that is, the depth information radius of the radar coordinate system is calculated by using the x and y information of the current node, and then the tangent value of the current node and the offset amount in the vertical direction are obtained by using the laser LaserIdx of the current node, so that the prediction value of the current node in the Z-axis direction, that is, Z_pred, can be obtained. The details are as follows:

$$int radius = \sqrt{{( point Pos [ 0 ] - LidarOrigin [ 0 ] )}^{2} + {( point Pos [ 1 ] - LidarOrigin [ 1 ] )}^{2}} ;$$

$$int tan Theta = tan {θ}_{laserIdx} ;$$

$$int z Offset = {Z}_{laserIdx} ;$$

$$Z\_pred = radius \times tan Theta - z Offset .$$

Further, prediction coding is performed on the geometry information of the Z-axis direction of the current node by using Z_pred to obtain the prediction residual Z_res, and finally Z_res is encoded.

It should be noted that when the nodes are partitioned into leaf nodes, the number of repetitive points in the leaf nodes needs to be encoded in the case of geometry lossless coding. Finally, the occupancy information of all nodes is encoded to generate a binary bitstream. In addition, G-PCC currently introduces a plane coding mode. In the process of geometry partition, it will determine whether the child nodes of the current node are in the same plane. If the child nodes of the current node meet the conditions of the same plane, the plane will be used to represent the child nodes of the current node.

For the octree geometry decoding, before decoding the occupancy information of each node in the order of breadth-first traversal, the decoding end will first determine whether plane decoding or IDCM decoding is performed on the current node by using the reconstructed geometry information, if the current node meets the condition of plane decoding, the plane identification and plane position information of the current node will be first decoded, and then the occupancy information of the current node is decoded based on the plane information. If the current node meets the conditions of IDCM decoding, whether the current node is a real IDCM node will be first decoded, if it is a real IDCM node, the DCM decoding mode of the current node is further parsed, secondly, the number of points in the current DCM node may be obtained, and finally the geometry information of each point is decoded. For nodes that meet neither the plane decoding nor the DCM decoding conditions, the occupancy information of the current node is decoded. The occupancy code of each node is obtained by continuously parsing in this manner, and the nodes are continuously partitioned in turn until the unit cube of 1×1×1 is obtained by partitioning, and the number of points included in each leaf node is obtained by parsing, and finally the geometry reconstruction point cloud information is restored.

The process of IDCM decoding will be described in detail below.

Similar to the processing of the encoding end, first, the prior information is used to determine whether the node enables IDCM, that is, the enabling conditions of IDCM are as follows.

(1) The current node has no sibling child nodes, that is, the parent node of the current node has only one child node, and the parent node of the parent node of the current node has only two occupied child nodes, that is, the current node has only one neighbouring node at most.

(2) The parent node of the current node has only one occupied child node, which is the current node itself, and the six neighbouring nodes that share a plane with the current node are all empty nodes.

(3) The number of the sibling nodes of the current node is greater than 1.

Further, when the node meets the condition of DCM coding, whether the current node is a real DCM node (i.e., IDCM_flag) is first decoded. When IDCM_flag is true, the current node adopts DCM coding, otherwise it still adopts octree coding.

Secondly, the number of points numPoints of the current node is decoded. The specific decoding process is as follows.

i) Firstly, decode whether the numPonts of the current node is greater than 1.

ii) If it is decoded that the numPonts of the current node is greater than 1, proceed to decode whether the second point is a repetitive point. If the second point is not a repetitive point, it can be implicitly inferred that the second one of the DCM modes is met, and only two points are included.

iii) If it is decoded that the numPonts of the current node is less than or equal to 1, proceed to decode whether the second point is a repetitive point. If the second point is not a repetitive point, it can be implicitly inferred that the second one of the DCM modes is met, and only one point is included. If it is decoded that the second point is a repetitive point, it can be inferred that the third one of the DCM modes is met, multiple points are included, but all of them are repetitive points, then continue to decode whether the number of repetitive points is greater than 1 (entropy decoding), and if it is greater than 1, continue to decode the number of remaining repetitive points (decoding by exponential Columbus).

If the current node does not meet the requirements of the DCM node, exit directly (i.e., the number of points is greater than 2, and the points are not repetitive points).

After the number of points of the current node is decoded, coordinate information of the points included in the current node is decoded. The Lidar point cloud and the eye-oriented point cloud will be introduced in detail below.

### (I) Eye-Oriented Point Cloud.

(1) If the current node includes only one point, the geometry information of the three dimensional directions of the point will be directly decoded (Bypass coding).

(2) If the current node includes two points, the prioritized decoding axis dirextAxis will be obtained first by using the geometry coordinates of the points. It should be noted that the coordinate axes currently compared only include the x-axis and y-axis, and do not include the z-axis. Assuming that the geometry coordinates of the current node are nodePos, the determination is made as follows:

$$dirextAxis = ! ( nodePos [ 0 ] < nodePos [ 1 ] ) \qquad ( 9 )$$

That is, the axis having a small coordinate value of the geometry position of is used as the prioritized decoding coordinate axis dirextAxis, and secondly, the geometry information of the prioritized decoding coordinate axis dirextAxis is first decoded as follows. Assuming that the to-be-decoded geometry bit depth corresponding to the prioritized decoding axis is nodeSizeLog2, and assuming that the coordinates of the two points are pointPos[0] and pointPos[1], respectively. The specific decoding process is as follows:

```
  Bool sameBit=true;
    while(nodeSizeLog2&& sameBit){
      pointPos[0][ dirextAxis]<<1;
      pointPos[1][ dirextAxis]<<1;
      --nodeSizeLog2;
        int bit=0;
          deEntropyCodeSameBit(sameBits); ///<entropy coding
        if(sameBits){
            bit =decodePosBit( );///<Bypass coding
            pointPos[0][ dirextAxis]|= bit
            pointPos[1][ dirextAxis]|= bit
        }else
              pointPos[1][ dirextAxis]|= 1///< The reason here is that during
encoding, two points are sorted in the direction of the prioritized encoding axis, so
pointPos[0][dirextAxis] < pointPos[1][dirextAxis] can be guaranteed. Therefore, during
decoding, if the bit information of the two points is different, it can be inferred that the bit
of the first point is 0 and the bit of the second point is 1.
          }
```

After the prioritized decoding coordinate axis dirextAxis is decoded, the direct decoding of the geometry coordinates of the current node is continued. Assuming that the remaining encoding bit depth of each point is nodeSizeLog2, and assuming that the coordinate information of the point is pointPos, the specific decoding process is as follows:

```
for(int axisIdx=0;axisIdx<3;++axisIdx)
for(int idx= nodeSizeLog2[axisIdx]; idx; idx--){
  pointPos[axisIdx]<<1;
  pointPos[axisIdx]|=decodePosBit( );
    }
```

### (II) Lidar-Oriented Point Cloud.

If the current node includes two points, the prioritized decoding axis dirextAxis will be obtained first by using the geometry coordinates of the points. Assuming that the geometry coordinates of the current node are nodePos, the determination is made as follows:

$$dirextAxis = ! ( nodePos [ 0 ] < nodePos [ 1 ] ) \qquad ( 10 )$$

That is to say, the axis having a small coordinate value of the geometry position of the node is used as the prioritized decoding coordinate axis dirextAxis. It should be noted that the coordinate axes currently compared only include the x-axis and y-axis, and do not include the z-axis. Secondly, the geometry information of the prioritized decoding coordinate axis dirextAxis is first decoded as follows. Assuming that the to-be-decoded geometry bit depth corresponding to the prioritized decoding axis is nodeSizeLog2, and assuming that the coordinates of the two points are pointPos [0] and pointPos [1], respectively. The specific decoding process is as follows:

```
  Bool sameBit=true;
  while(nodeSizeLog2&& sameBit){
    pointPos[0][ dirextAxis]<<1;
    pointPos[1][ dirextAxis]<<1;
        --nodeSizeLog2;
        int bit=0;
          deEntropyCodeSameBit(sameBits); ///<entropy coding
        if(sameBits){
          bit =decodePosBit( );///<Bypass coding
          pointPos[0][ dirextAxis]|= bit
          pointPos[1][ dirextAxis]|= bit
        }else
            pointPos[1][ dirextAxis]|= 1///< The reason here is that
during encoding, two points are sorted in the direction of the prioritized encoding axis, so
pointPos[0][dirextAxis] < pointPos[1][dirextAxis] can be guaranteed. Therefore, during
decoding, if the bit information of the two points is different, it can be inferred that the bit
of the first point is 0 and the bit of the second point is 1.
      }
```

After the prioritized decoding coordinate axis dirextAxis is decoded, the geometry coordinates of the current node are decoded.

Similarly, a directly decoded main axis direction is first obtained by using the geometry information nodePos of the current node, and secondly, the geometry information of another dimension is decoded by using the geometry information of the decoded direction. Similarly, assuming that the directly decoded axis direction is directAxis, and assuming that the to-be-decoded bit depth in direct decoding is nodeSizeLog2, the decoding process is as follows:

```
for(int idx= nodeSizeLog2[directAxis]; idx; idx--){
  pointPos[directAxis]<<1;
  pointPos[directAxis]|=decodePosBit( );
    }
```

It should be noted that all the geometry accuracy information of the directAxis direction will be decoded here.

After all the precision of the directAxis coordinate direction is decoded, the LaserIdx of the current node (i.e., nodeLaserIdx) is calculated first. Secondly, prediction decoding is performed on the LaserIdx (i.e., pointLaserIdx) of the point by using the LaserIdx (i.e., nodeLaserIdx) of the node, where the calculation of the LaserIdx of the node or point is the same as that of the encoding end. Finally, the LaserIdx of the current node and the LaserIdx prediction residual information of the node are decoded to obtain ResLaserIdx, and the decoding process is as follows:

$$PointLaser Idx = node Laser Idx + Res Laser Idx \qquad ( 11 )$$

After the LaserIdx of the current node is decoded, prediction decoding is performed on the geometry information of three dimensions of the current node by using the acquisition parameters of the Lidar. The specific algorithm is as follows.

As shown in FIGS. 11A to 11C, the LaserIdx corresponding to the current node is first used to obtain the prediction value of the corresponding horizontal azimuth angle, that is, φ_{pred}. Secondly, the horizontal azimuth angle φ_{node} corresponding to the node is obtained by using the geometry information of the node corresponding to the current node. Assuming that the geometry coordinate of the node is nodePos, the calculation between the horizontal azimuth angle φ and the geometry information of the node is as follows:

$$φ = arctan ( nodePos [ 1 ] / nodePos [ 0 ] ) \qquad ( 12 )$$

By using the acquisition parameters of the Lidar, the number of rotation points numPoints of each Laser can be obtained, which represents the number of points obtained by each laser during one full rotation, and the rotation angular velocity deltaPhi of each laser can be calculated by using the number of rotation points of each laser, and the calculation is as follows:

$$deltaPhi = \frac{2 π}{num Points} \qquad ( 13 )$$

Further, the horizontal azimuth angle prediction value φ_{predPoint} corresponding to the current node (that is, the horizontal azimuth angle prediction value shown in FIG. 17A and FIG. 17B) is calculated by using the horizontal azimuth angle φ_{node} of the node and the horizontal azimuth angle φ_{pred} of the previous coding point of the laser corresponding to the current node. It is calculated as follows:

$${φ}_{predPoint} = \frac{φ pred - φ node}{deltaPhi} \times deltaPhi + φ pred \qquad ( 14 )$$

In this way, prediction decoding is performed on the geometry information of the current node by using the prediction value φ_{predPoint} of the horizontal azimuth angle and the bottom virtual plane horizontal azimuth angle φ_{left} and the top virtual plane horizontal azimuth angle φ_{right} of the current node. The details are as follows:

$$int angLel = {φ}_{left} - {φ}_{pred} ;$$

$$int angLeR = {φ}_{right} - {φ}_{pred} ;$$

$$int context = ( angLel \geq 0 \&\& angLeR \geq 0 ) \vert \vert ( angLel < 0 \&\& angLeR < 0 ) ? 0 : 2 ;$$

$$int abs AngleL = abs ( angLel ) ;$$

$$int abs AngleR = abs ( angLeR ) ;$$

$$context + abs AngleL > abs AngleR ? 0 : 1 ;$$

$$context + max Angle > min Angle ≪ 1 ? 4 : 0.$$

After the LaserIdx of the point is decoded, prediction decoding is performed on the Z-axis direction of the current node by using the LaserIdx corresponding to the current node, that is, the depth information radius of the radar coordinate system is calculated by using the x and y information of the current node, and then the tangent value of the current node and the offset amount in the vertical direction are obtained by using the laser LaserIdx of the current node, so that the prediction value of the current node in the Z-axis direction, that is, Z_pred, can be obtained. The details are as follows:

$$int radius = \sqrt{( point Pos [ 0 ] - LidarOrigin [ 0 ] ) 2 + ( point Pos [ 1 ] - LidarOrigin [ 1 ] ) 2} ;$$

$$int tan Theta = tan {θ}_{laserIdx} ;$$

$$int z Offset = {Z}_{laserIdx} ;$$

$$Z\_pred = radius \times tan Theta - z Offset .$$

Further, Z_res and Z_pred obtained by decoding are used to reconstruct and restore the geometry information of the current node in the Z-axis direction.

For triangle soup (trisoup)-based geometry information coding, in the trisoup-based geometry information coding framework, geometry partitioning is also performed first, but different from binary tree/quadtree/octree geometry information coding, this method does not need to partition the point cloud into unit cubes with side lengths of 1×1×1 step by step. Instead, the partitioning stops when the edge length of sub-blocks reaches W. Based on the surface formed by the distribution of point clouds in each block, at most twelve vertices generated by the surface and the twelve edges of the block are obtained. The vertex coordinates of each block are sequentially encoded to generate a binary bitstream.

For the trisoup-based point cloud geometry information reconstruction, when the point cloud geometry information reconstruction is performed at the decoding end, the vertex coordinates are first decoded to complete the triangle reconstruction, and the process is shown in FIG. 19A, FIG. 19B, and FIG. 19C. There are three vertices (v1, v2, v3) in the block shown in FIG. 19A, and a triangle soup formed by these three vertices in a certain order is also called a trisoup, as shown in FIG. 19B. Thereafter, sampling is performed on the trisoup, and the obtained samples are used as the reconstructed point cloud in the block, as shown in FIG. 19C.

For predictive geometry coding (PredGeomTree), the predictive geometry coding includes: first sorting the input point cloud, and currently employed sorting methods include unordered, Morton ordered, azimuth ordered and radial distance ordered. At the encoding end, the prediction tree structure is established in two different modes, including: high-latency slow mode (KD-Tree) and low-latency fast mode (using Lidar calibration information). When using Lidar calibration information, each point is partitioned into different lasers, and the prediction tree structure is established according to different lasers. Then, based on the structure of the prediction tree, each node in the prediction tree is traversed, and the geometry position information of the node is predicted by selecting different prediction modes to obtain the prediction residual, and the geometry prediction residual is quantized by using quantization parameters. Finally, through continuous iteration, the prediction residual, prediction tree structure and quantization parameters of the prediction tree node position information are encoded to generate a binary bitstream.

For the predictive geometry decoding, the decoding end reconstructs the prediction tree structure by continuously parsing the bitstream, and then obtains the geometry position prediction residual information and quantization parameters of each prediction node by parsing, and performs inverse quantization on the prediction residual to restore the reconstructed geometry position information of each node, and finally completes the geometry reconstruction of the decoding end.

After the geometry encoding is completed, the geometry information needs to be reconstructed. At present, attribute coding is mainly carried out for colour information. First, the colour information is converted from the RGB colour space to the YUV colour space. Then, the point cloud is recolored using the reconstructed geometry information so that the uncoded attribute information corresponds to the reconstructed geometry information. In colour information encoding, there are mainly two transform methods, one is distance-based lifting transform that relies on LOD partitioning, and the other is direct RAHT. Both methods will convert the colour information from the spatial domain to the frequency domain, obtain high-frequency coefficients and low-frequency coefficients through transform, and finally quantize and encode the coefficients to generate a binary bitstream, as specifically shown in FIG. 4A and FIG. 4B.

Further, when predicting attribute information using geometry information, a nearest neighbour search may be performed using a Morton code, and a Morton code corresponding to each point in the point cloud may be obtained from the geometry coordinates of the point. The specific method of calculating the Morton code is described as follows. For a three-dimensional coordinate where each component is represented by a d-bit binary number, its three components can be expressed as:

$$x = {\sum }_{ℓ = 1}^{d} {2}^{d - ℓ} {x}_{ℓ} , \qquad ( 15 )$$

$$y = {\sum }_{ℓ = 1}^{d} {2}^{d - ℓ} {y}_{ℓ} ,$$

$$z = {\sum }_{ℓ = 1}^{d} {2}^{d - ℓ} {z}_{ℓ}$$

Where [symbol] , [symbol] , [symbol] ∈{0, 1} are binary values corresponding to the highest bit ( [symbol] =1) to the lowest bit ( [symbol] =d) of x, y, z, respectively. for x, y, z, Morton code M is generated by interleaving [symbol] , [symbol] , [symbol] sequentially from the highest bit to the lowest bit. The calculation formula of M is as follows:

$$M = {\sum }_{ℓ = 1}^{d} {2}^{3 ( d - ℓ )} ( 4 {x}_{ℓ} + 2 {y}_{ℓ} + {z}_{ℓ} ) = {\sum }_{{ℓ}^{′} = 1}^{3 d} {2}^{3 d - {ℓ}^{′}} {m}_{{ℓ}^{′}} \qquad ( 16 )$$

Where [symbol] ∈{0, 1} are the values of the highest bit ( [symbol] =1) to the lowest bit ( [symbol] =3d) of M, respectively. After the Morton code M of each point in the point cloud is obtained, the points in the point cloud are arranged in ascending order of the Morton codes, and the weight value w of each point is set to 1.

It is also understood that for the G-PCC encoding and decoding framework, the general test conditions are as follows.

(1) There are 4 kinds of test conditions:

Condition 1: limited lossy geometry, lossy attributes.

Condition 2: lossless geometry, lossy attributes.

Condition 3: lossless geometry, limited lossy attributes.

Condition 4: lossless geometry, lossless attributes.

(2) The general test sequence includes four categories: Cat1A, Cat1B, Cat3-fused, and Cat3-frame. The Cat2-frame point cloud only includes reflectance attribute information, the Cat1A and Cat1B point clouds only include colour attribute information, and the Cat3-fused point cloud includes both colour and reflectance attribute information.

(3) Technical approaches: there are two kinds in total, which are distinguished by the algorithm used in geometry compression.

### Technical Approach 1: Octree Coding Branch.

At the encoding end, the bounding boxes are partitioned in turn to obtain sub-cubes, and the non-empty sub-cubes (including points in the point cloud) are continuously partitioned until the partitioned leaf nodes are 1×1×1 unit cubes. In the case of geometry lossless coding, the number of points included in the leaf nodes needs to be encoded, and finally the geometry octree coding is completed to generate a binary bitstream.

At the decoding end, the decoding end obtains the occupancy code of each node by continuously parsing in the order of breadth-first traversal, and continuously partitions the nodes in turn until the unit cube of 1×1×1 is obtained by partitioning. In the case of geometry lossless decoding, it is necessary to parse the number of points included in each leaf node, and finally restore the geometry reconstruction point cloud information.

### Technical Approach 2: Predictive Coding Branch.

At the encoding end, the prediction tree structure is established in two different modes, including: high-latency slow mode (KD-Tree) and low-latency fast mode (using Lidar calibration information). When using Lidar calibration information, each point is partitioned into different lasers, and the prediction tree structure is established according to different lasers. Then, based on the structure of the prediction tree, each node in the prediction tree is traversed, and the geometry position information of the node is predicted by selecting different prediction modes to obtain the prediction residual, and the geometry prediction residual is quantized by using quantization parameters. Finally, through continuous iteration, the prediction residual, prediction tree structure and quantization parameters of the prediction tree node position information are encoded to generate a binary bitstream.

At the decoding end, the decoding end reconstructs the prediction tree structure by continuously parsing the bitstream, and then obtains the geometry position prediction residual information and quantization parameters of each prediction node by parsing, and performs inverse quantization on the prediction residual to restore the reconstructed geometry position information of each node, and finally completes the geometry reconstruction of the decoding end.

It should also be noted that, as shown in FIG. 4A or FIG. 4B, the current G-PCC coding framework includes three attribute coding methods: Predicting transform (PT), Lifting Transform (LT), and Region Adaptive Hierarchical Transform (RAHT). Where the first two perform prediction coding on the point cloud based on the generation order of LOD, while RAHT performs adaptive transform on the attribute information from bottom to top according to the construction hierarchy of octree. These three point cloud attribute coding methods will be introduced in detail below.

### (a) Prediction Coding of Point Cloud Attribute Information.

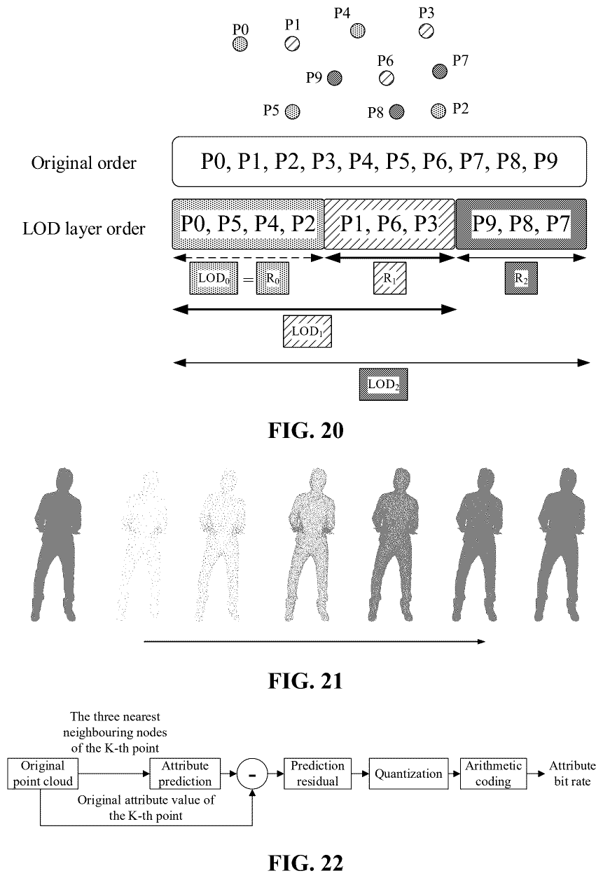

At present, the attribute prediction module of G-PCC adopts a nearest neighbour attribute prediction coding scheme based on LOD structure. The construction methods of LOD include a distance-based LOD construction scheme, a fixed sampling rate-based LOD construction scheme and an octree-based LOD construction scheme. In the distance threshold-based LOD construction scheme, Morton sorting is performed on the point cloud before constructing LOD to ensure strong attribute correlation between neighbouring nodes. FIG. 20 is a schematic diagram of a distance-based LOD construction process. As shown in FIG. 20, according to L Manhattan distances (dl) preset by the user in advance, where l=0, 1, . . . L−1. The point cloud is partitioned into L different point cloud detail layers (Rl), where l=0, 1, . . . L−1, where (dl)l=0, 1, . . . L−1 meets the condition of dl<dl−1. The construction process of LOD is described below.

(1) First, all points in the point cloud are marked as unvisited, and a set V is established to store the visited point sets. (2) For each iteration l, the points in the point cloud are traversed, the current node is ignored if it has been visited, otherwise the minimum distance D from the current node to the point set V is calculated, and the point is ignored if D<dl; otherwise, the current node is marked as visited and added to the detail layer Rl and point set V. (3) The points in LOD1 are composed of points in the detail layers R0, R1, R2 . . . Rl. (4) the above steps are repeated until all the points are marked as visited.

On the basis of the structure of LOD, linear weighted prediction is performed on the attribute value of each point by using the attribute reconstruction value of the point in the LOD of the same layer or a higher layer, where the maximum number of reference prediction neighbours is determined by the high-layer syntax element of the encoder. For the attributes of each point, the encoding end uses the rate-distortion optimization algorithm to select the attributes of N searched nearest neighbouring nodes for weighted prediction or the attribute of a single nearest neighbouring node for prediction, and finally encodes the selected prediction mode and prediction residual.

$${Attr}_{i}^{′} = Round ( \frac{1}{N} {\sum }_{m ∈ {p}_{i}} \frac{\frac{1}{{D}_{m}^{2}}}{{\sum }_{m ∈ {p}_{i}} \frac{1}{{D}_{m}^{2}}} {Attr}_{m} ) \qquad ( 17 )$$

Where N represents the number of prediction points in the nearest neighbouring node set of point i, Pi represents the sum of N nearest neighbouring nodes of point i, Dm represents the spatial geometry distance from the nearest neighbouring node m to the current node i, Attrm represents the attribute value after reconstruction of the nearest neighbouring node m, Attrᵢ′ represents the attribute prediction value of the current node i, and the point number N is a preset value in advance.

In order to balance attribute coding efficiency and parallel processing between different LOD layers, a switch is introduced in the high-layer syntax element of the encoder to control whether to introduce LOD intra-layer prediction. If the switch is on, LOD intra-layer prediction is enabled, and points within the same LOD layer can be used for prediction. It should be noted that LOD intra-layer prediction is always used when the number of LOD layers is 1.

FIG. 21 is a schematic diagram of a visualization result of a LOD generation process. As shown in FIG. 21, a subjective example of a distance-based LOD generation process is provided here. Specifically (from left to right): the points in the first layer represent the outer contour of the point cloud; as the detail layer increases, the detail description of point cloud gradually becomes clear.

FIG. 22 is a schematic diagram of an encoding process of an attribute prediction. As shown in FIG. 22, illustrating the specific process of G-PCC attribute prediction: for the original point cloud, three neighbouring nodes of the K-th point are first searched, and then attribute prediction is performed. The prediction residual of the K-th point can be obtained by calculating the difference between the attribute prediction value of the K-th point and the original attribute value of the K-th point. Then quantization and arithmetic coding are performed, and finally the attribute bitrate is generated.

### (i) Selection of Optimal Prediction Value.

After the LOD is constructed, according to the generation order of LOD, the three nearest neighbouring nodes of the current to-be-encoded point are first found from the encoded data points. Taking the attribute reconstruction values of the three nearest neighbouring nodes as the candidate prediction values of the current to-be-encoded point. Then, the optimal prediction value is selected from the candidate prediction values according to Rate-Distortion Optimization (RDO). For example, when encoding the attribute value of the point P2 in FIG. 20, the predictor index of the attribute value of the nearest neighbouring node P4 is set to 1; the attribute predictor indexes of the second nearest neighbouring node P5 and the third nearest neighbouring node P0 are set to 2 and 3, respectively; the predictor index of the weighted average of the points P0, P5, and P4 is set to 0, as shown in Table 1; finally, the optimal predictor variable is selected by using RDO. The formula for the weighted average is as follows:

$${\hat{a}}_{i} = Round ( {\sum }_{j = 0}^{2} \frac{{\tilde{w}}_{ij}}{{\sum }_{j = 0}^{2} {\tilde{w}}_{ij}} {\tilde{a}}_{j} ) \qquad ( 18 )$$

Where \tilde{w}ᵢⱼ represents the spatial geometry weight from the nearest neighbouring node j to the current node i:

$${\tilde{w}}_{ij} = \frac{1}{{( {x}_{i} - {x}_{i j} )}^{2} + {( {y}_{i} - {y}_{i j} )}^{2} + {( {z}_{i} - {z}_{i j} )}^{2}} \qquad ( 19 )$$

Where âᵢ represents the attribute prediction value of the current node i, j represents the index of three neighbouring nodes, ãⱼ represents the attribute values after reconstruction of the neighbouring nodes, xᵢ, yᵢ, zᵢ are the geometry position coordinates of the current node i, and xᵢⱼ, yᵢⱼ, zᵢⱼ are the geometry coordinates of the neighbouring node j.

Exemplarily, Table 1 provides an example sample of candidate predictors for attribute coding.

TABLE 1

| Prediction | |
|---|---|
| Mode | Prediction value |
| 0 | Attribute weighted average of three nearest |
| 1 | P4 (attribute value of the nearest neighbour) |
| 2 | P5 (attribute value of the second nearest |
| 3 | P0 (attribute value of the third nearest |

### (ii) Attribute Prediction Residual and Quantification.

Through the above prediction, the attribute prediction value (âᵢ)_{i∈0 . . . k-1} of the current node i is obtained (k is the total number of points in the point cloud). Let (aᵢ)_{i∈0 . . . k-1} be the original attribute value of the current node, then the attribute residual (rᵢ)_{i∈0 . . . k-1} is denoted as:

$${r}_{i} = {a}_{i} - {\hat{a}}_{i} \qquad ( 20 )$$

The prediction residuals are further quantified:

$${Q}_{i} = \frac{{r}_{i}}{Q s} \qquad ( 21 )$$

Where Qᵢ represents the quantized attribute residual of the current node i, and Qs is the Quantization step (Qs), which can be calculated by the Quantization Parameter (QP) specified by CTC.

(iii) Encoding End Attribute Value Reconstruction.

The purpose of encoding end reconstruction is for the prediction of subsequent points. Before reconstructing the attribute value, the residual should be inversely quantized, and \hat{r}ᵢ is the residual after inverse quantization:

$${\hat{r}}_{i} = {Q}_{i} \times Q s \qquad ( 22 )$$

The prediction value ãᵢ of point i is obtained by adding \hat{r}ᵢ to the prediction value âᵢ:

$${\tilde{a}}_{i} = {\hat{r}}_{i} + {\hat{a}}_{i} \qquad ( 23 )$$

When performing attribute nearest neighbour search on the basis of LOD partitioning, there are currently two major types of algorithms: intra nearest neighbour search and inter nearest neighbour search. Where the inter nearest neighbour search algorithm is as follows. The intra nearest neighbour search can be divided into two algorithms: inter-layer nearest neighbour search and intra-layer nearest neighbour search.

### (i) Intra Nearest Neighbour Search:

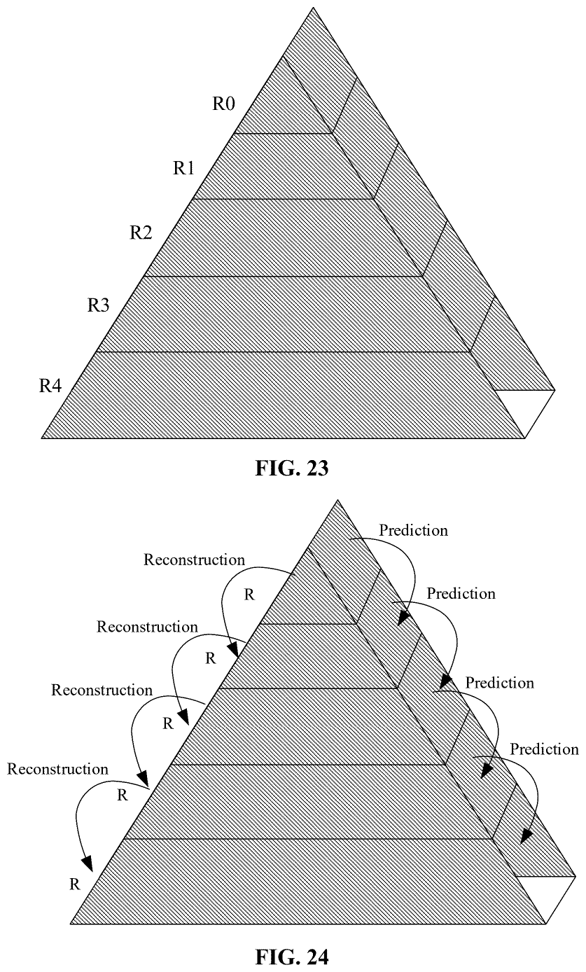

Intra nearest neighbour search is divided into two algorithms: inter-layer nearest neighbour search and intra-layer nearest neighbour search. After the LOD is partitioned, it resembles a pyramid structure, as shown in FIG. 23.

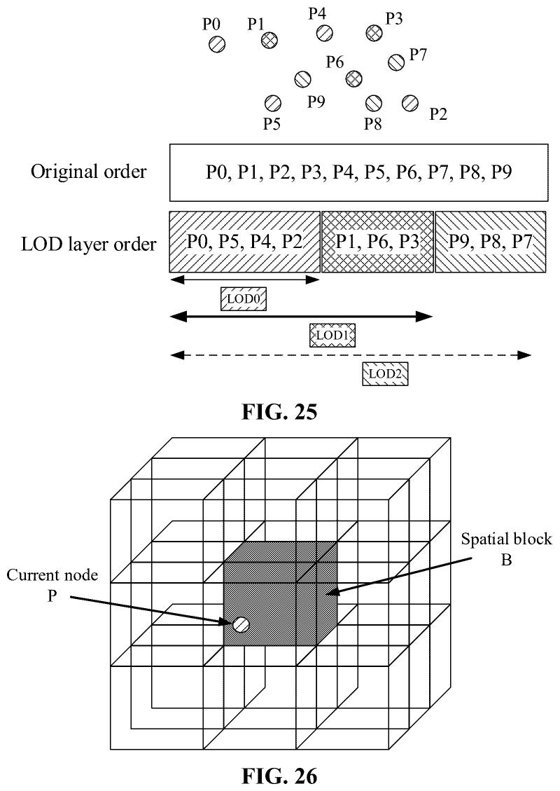

In a specific implementation, for the inter-layer nearest neighbour search, the pyramid structure is shown in FIG. 24. FIG. 25 is a schematic diagram of an LOD construction process for inter-layer nearest neighbour search. As shown in FIG. 25, different LOD layers are obtained based on geometry information partitioning, and LOD0, LOD1 and LOD2 are obtained. The points in LOD0 are used to predict the attributes of the points in the next layer LOD in the process of inter-layer nearest neighbour search.

The entire process of intra nearest neighbour search will be described in detail below.

Throughout the partitioning of the LOD, there are three sets O(k), L(k), and I(k). Where k is the index of the LOD layer when performing LOD partitioning, and I(k) is the input point set when the current LOD layer is partitioned. After LOD partitioning, the O(k) set and the L(k) set are obtained. The O(k) set stores the sample set, and L(k) is the point set in the current LOD layer. That is, the entire LOD partitioning process is as follows:

(1) Initialization.

$$if k = 0 , L ( k ) ← \{ \} ; Otherwise , L ( k ) ← L ( k - 1 ) ;$$

$$O ( k ) ← \{ \} .$$

(2) Using the LOD partitioning algorithm, the samples are stored in O(k), and the remaining points are partitioned into L(k).

(3) When the next iteration is performed, I←(k).

Here, it should be noted that since the entire LOD partitioning process is based on the Morton code, O(k), L(k), and I(k) store the Morton code index corresponding to the points.

When performing the inter-layer nearest neighbour search, that is, the points in the L(k) set perform the nearest neighbour search in the O(k) set, the specific search algorithm is as follows.

Taking the nearest neighbour search based on the spatial relationship as an example, when predicting the current node P, the neighbour search is performed using the parent block (Block B) corresponding to the point P, and as shown in FIG. 26, the points in the neighbouring block coplanar and collinear with the current parent block are searched to perform attribute prediction.

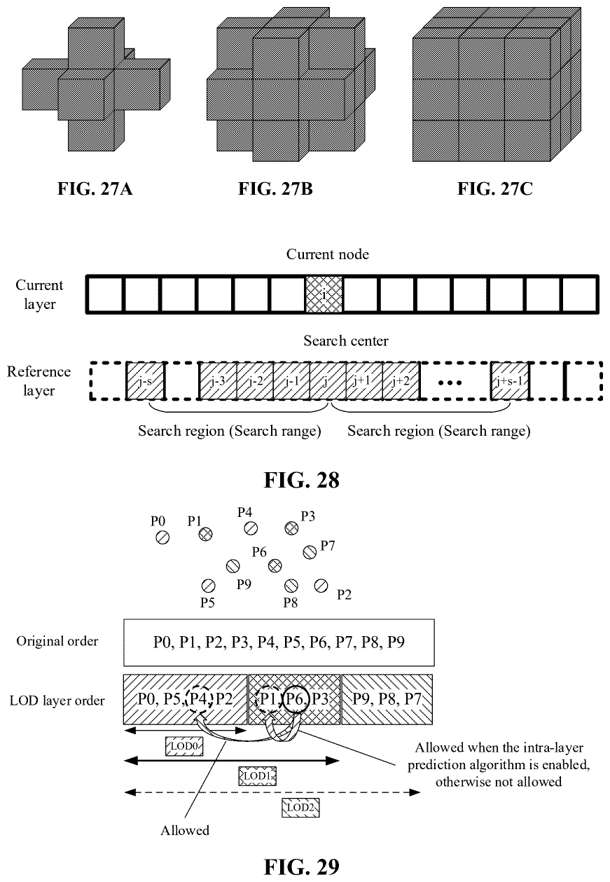

FIG. 27A shows a schematic diagram of a coplanar spatial relationship, in which there are a total of six spatial blocks having a relationship with the current parent block. FIG. 27B shows a schematic diagram of a coplanar and collinear spatial relationship, in which there are a total of 18 spatial blocks having a relationship with the current parent block. FIG. 27C shows a schematic diagram of a coplanar, collinear, and co-point spatial relationship, in which there are a total of 26 spatial blocks having a relationship with the current parent block.

Firstly, the corresponding spatial block is obtained by using the coordinates of the current node, and secondly, the nearest neighbour search is performed in the previously encoded LOD layer, and the spatial block coplanar, collinear and co-point with the current block is searched to obtain N nearest neighbours of the current node.

When the N nearest neighbours of the current node are still not obtained after the coplanar, collinear and co-point nearest neighbour search is performed, the N nearest neighbours of the current node are obtained based on the fast search algorithm, which is as follows.

As shown in FIG. 28, when attribute inter-layer prediction is performed, firstly, the Morton code corresponding to the current node is obtained by using the geometry coordinates of the current to-be-encoded point; secondly, the first one reference node (j) larger than the Morton code of the current node is found in the reference picture based on the Morton code of the current node; and then, the nearest neighbour search is performed in the range of [j−searchRange, j+searchRange].

Other specific algorithms for updating the nearest neighbour are consistent with the inter nearest neighbour search algorithm, and will not be described in detail here, and the specific algorithms will be mentioned in the inter nearest neighbour search algorithm.

In another specific implementation, for the intra-layer nearest neighbour search, FIG. 29 shows a schematic structural diagram of LOD of an attribute intra-layer nearest neighbour search. As shown in FIG. 29, if the intra-layer prediction algorithm is enabled, that is, the syntax element EnableRefferingSameLoD=1, then the intra-layer nearest neighbour search is allowed. For example, for the LOD1 layer, the nearest neighbouring node of the current node P6 may be P1, while searching in other layers is not allowed. If the syntax element EnableRefferingSameLoD=0, then inter-layer search in other layers is allowed. For example, for the LOD1 layer, the nearest neighbouring node of the current node P6 may be P4. That is to say, when the intra-layer prediction algorithm is enabled, the nearest neighbour search will be performed in the encoded point set of the same LOD layer to obtain the N nearest neighbours of the current node (the inter-layer nearest neighbour search will also be performed).

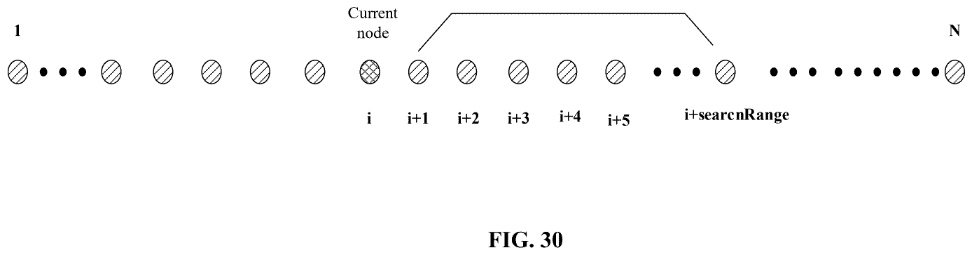

When performing the attribute intra-layer prediction, the nearest neighbour search is performed based on a fast search algorithm, and the specific algorithm is shown in FIG. 30. Where the current node is represented by grids. Assuming that the Morton code index of the current node is i, the nearest neighbour search will be performed within the range [i+1, i+searchRange]. The specific nearest neighbour search algorithm is consistent with the inter block-based fast search algorithm, and will not be described in detail here.

### (ii) Inter Nearest Neighbour Search.

FIG. 28 is a schematic diagram of an attribute inter prediction. As shown in FIG. 28, when the attribute inter prediction is performed, firstly, the Morton code corresponding to the current node is obtained by using the geometry coordinates of the current to-be-encoded point; secondly, the first one reference node (j) larger than the Morton code of the current node is found in the reference picture based on the Morton code of the current node; and then, the nearest neighbour search is performed in the range of [j−searchRange, j+searchRange].

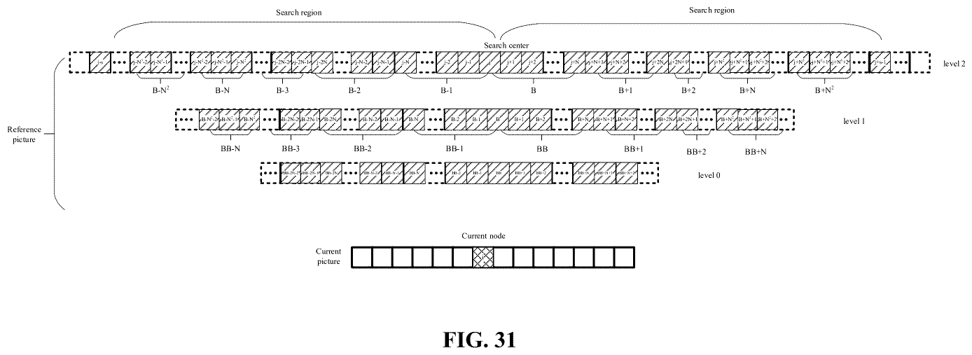

At present, when performing the intra and inter nearest neighbour search, it is performed based on blocks, see FIG. 31 for details. As shown in FIG. 31, when performing neighbourhood search on the current node (the Morton code index is i), the points in the reference picture are first partitioned into N (N=3) layers according to the Morton code. The specific partition algorithm is as follows.

First layer: assuming that the points of the reference picture are numPoints, the points in the reference picture are first partitioned into a block every M (M=2⁵=32) points.

Second layer: on the basis of the first layer, the blocks of the first layer are partitioned into one block every M (M=2⁵=32) blocks also in the order of the Morton code.

Third layer: on the basis of the second layer, the blocks of the second layer are also partitioned into one block every M (M=2⁵=32) blocks in the order of the Morton code.

Finally, the prediction structure as shown in FIG. 31 is obtained.

When attribute prediction is performed based on the prediction structure as shown in FIG. 31. Assuming that the Morton code index of the current to-be-encoded point is i, firstly, the first one point whose Morton code equal to or greater than the Morton code of the current node is obtained in the reference picture, and the index is j. Secondly, the block index of the reference node is calculated based on j, and the specific calculation is as follows.

First layer: BucketSize_0=2⁵=32.

Second layer: BucketSize_1=2⁵=32×BucketSize_0=1024.

Third layer: BucketSize_2=2⁵=32×BucketSize_1=32768.

Assuming that the reference range of the prediction frame of the current node is [j−searchRange, j+searchRange], the starting index of the third layer is calculated by using j−searchRange, and the ending index of the third layer is calculated by using j+searchRange. Secondly, in the blocks of the third layer, it is first determined whether some blocks of the second layer need to perform nearest neighbour search, and then, in the second layer, it is determined whether search needs to be performed for each block in the first layer. If some blocks of the first layer need to perform nearest neighbour search, the points of some blocks in the first layer will be evaluated point by point to update the nearest neighbour.

The following describes the algorithm for calculating the block based on the index. Assuming that the Morton code index corresponding to the current node is an index, the index of the corresponding third layer block is:

$$idx\_ 2 = index / BucketSize\_ 2 \qquad ( 24 )$$

After obtaining the block index idx_2 of the third layer, the starting index and the ending index of the block, in the second layer, corresponding to the current block can be obtained by using idx_2:

$$startIdx 1 = idx\_ 2 \times BucketSize\_ 1 \qquad ( 25 )$$

$$endIdx = idx\_ 2 \times BucketSize\_ 1 + B u c ketSize\_ 1 - 1 \qquad ( 26 )$$

Similarly, the index of the block of the first layer is obtained based on the index of the block of the second layer based on the same algorithm.

When performing the nearest neighbour search based on the block, it is first determined whether the current block needs to perform the nearest neighbour search, that is, the nearest neighbour search of the block is filtered. Each spatial block can be represented by two variables: minPos and maxPos. minPos represents the minimum value of the block, and maxPos represents the maximum value of the block.

Assuming that the distance of the farthest point among the N nearest neighbours searched by the current node is Dist, the coordinates of the to-be-encoded point are (x, y, z), and the current block is represented as (minPos, maxPos), where minPos is the minimum value in three dimensions of the bounding box, and maxPos is the maximum value in three dimensions of the bounding box, the distance D between the current node and the bounding box is calculated as follows:

$$int dx = int ( std \text{::} max ( std \text{::} max ( minPos [ 0 ] - point [ 0 ] , 0 ) , point [ 0 ] - maxPos [ 0 ] ) ) ;$$

$$int dy = int ( std \text{::} max ( std \text{::} max ( minPos [ 1 ] - point [ 1 ] , 0 ) , point [ 1 ] - maxPos [ 1 ] ) ) ;$$

$$int dz = int ( std \text{::} max ( std \text{::} max ( minPos [ 2 ] - point [ 2 ] , 0 ) , point [ 2 ] - maxPos [ 2 ] ) ) ;$$

$$D = dx + dy + dz ;$$

When D is less than or equal to Dist, the points in the current block will be traversed.

### (b) Lifting Transform Encoding of Point Cloud Attribute Information.

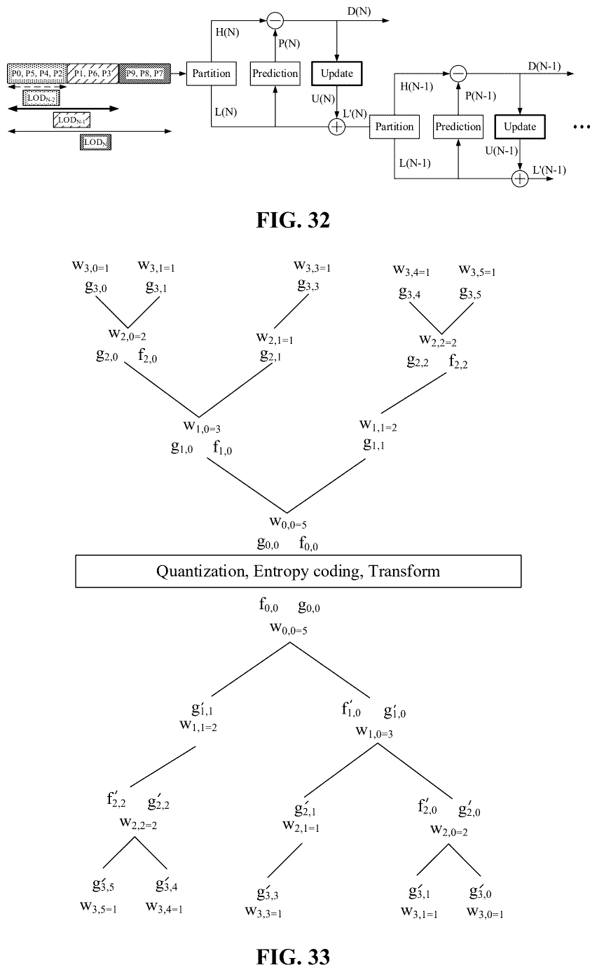

FIG. 32 is a schematic diagram of an encoding process of a lifting transform. Lifting transform is also based on LOD to perform prediction coding on point cloud attributes. The difference from the prediction transform is that the lifting transform will first partition the LOD into high and low layers, predict according to the reverse order of the LOD generation layer, and introduce an update operator in the prediction process to update the quantization weights of the points in the low-layer LOD to improve the accuracy of prediction. This is because the attribute values of the points in the low-layer LOD will be frequently used to predict the attribute values of the points in the high-layer LOD, and the points in the low-layer LOD should have greater influence.

### Step 1: Partition Process.

The partition process is to partition the complete LOD layer into a low LOD layer L(N) and a high LOD layer H(N). If a point cloud has three layers of LOD, that is, (LODₗ)_{l=0, 1, 2}, after partitioning, LOD₂ is a high LOD layer, denoted as H(N), and (LODₗ)_{l=0, 1} is a low LOD layer, denoted as L(N).

### Step 2: Prediction Process.

The point in the high-layer LOD selects the attribute information of the nearest neighbouring node from the low-layer as the attribute prediction value P(N) of the current to-be-encoded point, and the prediction residual D(N) is denoted as:

$$D ( N ) = H ( N ) - P ( N ) \qquad ( 27 )$$

### Step 3: Update Process.

The attribute prediction residual D(N) in the high-layer LOD is updated to obtain U(N), and the attribute values of the points in the low-layer LOD are lifted by using U(N), as shown in the following formula:

$${L}^{′} ( N ) = L ( N ) + U ( N ) \qquad ( 28 )$$

The above process will be iterated continuously to the lowest layer LOD according to the order of LOD from high to low.

Because the LOD-based prediction scheme makes the points in the low-layer LOD have greater influence, the lifting wavelet transform-based transform scheme introduces quantization weights, and updates the prediction residual according to the prediction residual D(N) and the distance between the prediction point and the neighbouring node, and finally uses the quantization weights in the transform process to adaptively quantize the prediction residual. It should be noted that the quantization weight value of each point can be determined by geometry reconstruction at the decoding end, so that there is no need to encode the quantization weights.

### (c) Region Adaptive Hierarchical Transform.

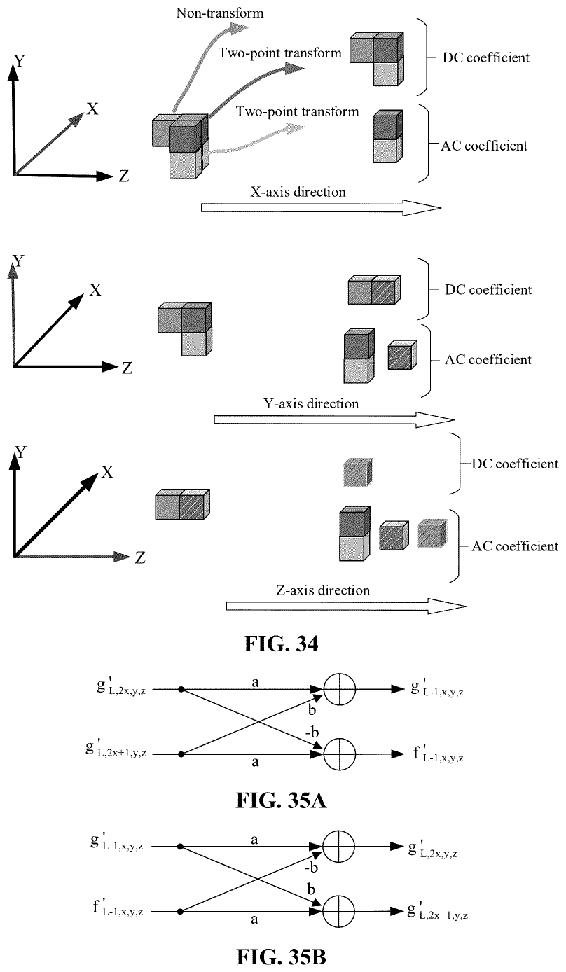

Region adaptive hierarchical transform (RAHT) is a kind of Haar wavelet transform, which can transform point cloud attribute information from spatial domain to frequency domain, further reducing the correlation between point cloud attributes. Its main idea is to transform the nodes in each layer from the three dimensions X, Y, and Z in a bottom-up way according to the octree structure (as shown in FIG. 34), and iterating this process up to the root node of the octree. As shown in FIG. 33, the basic idea is to perform wavelet transform based on the hierarchical structure of the octree, associate attribute information with octree nodes, recursively transform the attributes of the occupied nodes in the same parent node in a bottom-up manner, and transform the nodes in each layer from three dimensions X, Y, and Z until they are transformed to the root node of the octree. In the process of hierarchical transform, the low-pass/low-frequency (DC) coefficients obtained after the transform of nodes in the same layer are transferred to the nodes in the next layer for continued transform, and all the high-pass/high-frequency (AC) coefficients can be encoded by arithmetic encoder.

During the transform process, the transformed DC coefficients (DC components) of nodes of the same layer will be transferred to the next higher layer for continued transform, and the transformed AC coefficients (AC components) of each layer will be quantization coded. The main transform process will be described below.

FIG. 35A is a schematic diagram of a process of a forward RAHT transform, and FIG. 35B is a schematic diagram of a process of an inverse RAHT transform. For the transform and inverse transform processes corresponding to RAHT, it is assumed that

$${g}_{L , 2 x , y , z}^{′} and {g}_{L , 2 x + 1 , y , z}^{′}$$

are two attribute DC coefficients from neighboring points to each other in the L layer. After the linear transform, the information of the L−1 layer is an AC coefficient

$${f}_{L - 1 , x , y , z}^{′}$$

and a DC coefficient

$${g}_{L - 1 , x , y , z}^{′} .$$

### Then

$${f}_{L - 1 , x , y , z}^{′}$$

will no longer be transformed and directly perform quantization coding,

$${g}_{L - 1}^{′} , x , y , z$$

will continue to search the nearest neighbour for transform, and if the nearest neighbour cannot be found, it will be directly passed to the L−2 layer, that is, the RAHT transform is only valid for nodes with neighbouring nodes, and nodes without neighbouring nodes will be directly passed to the next higher layer. In the above transform process, the weights corresponding to

$${g}_{L , 2 x , y , z}^{′} and {g}_{L , 2 x + 2 , y , z}^{′}$$

(the number of non-empty child nodes in the node) are

$${w}_{L , 2 x , y , z}^{′} and {w}_{L , 2 x + 1 , y , z}^{′}$$

$$( abbreviated as {w}_{0}^{′} and {w}_{1}^{′} ) ,$$

respectively, and the weights of

$${g}_{L - 1 , x , y , z}^{′} are {w}_{L - 1 , x , y , z}^{′} ,$$

then the general transform formula is:

$$[ \begin{matrix}{g}_{L - 1 , x , y , z}^{′} \\ {f}_{L - 1 , x , y , z}^{′}\end{matrix} ] = {T}_{w 0 , w 1} [ \begin{matrix}{g}_{L , 2 x , y , z}^{′} \\ {g}_{L , 2 x + 1 , y , z}^{′}\end{matrix} ] \qquad ( 29 )$$

Where T_{w0, w1} is the transform matrix:

$${T}_{w 0 , w 1} = \frac{1}{\sqrt{{w}_{0}^{′} + {w}_{1}^{′}}} [ \begin{matrix}\sqrt{{w}_{0}^{′}} & \sqrt{{w}_{1}^{′}} \\ - \sqrt{{w}_{1}^{′}} & \sqrt{{w}_{0}^{′}}\end{matrix} ] \qquad ( 30 )$$

The transform matrix is adaptively changed and updated according to the corresponding weights of each point. The above process will be iteratively updated according to the partition structure of the octree until the root node of the octree.

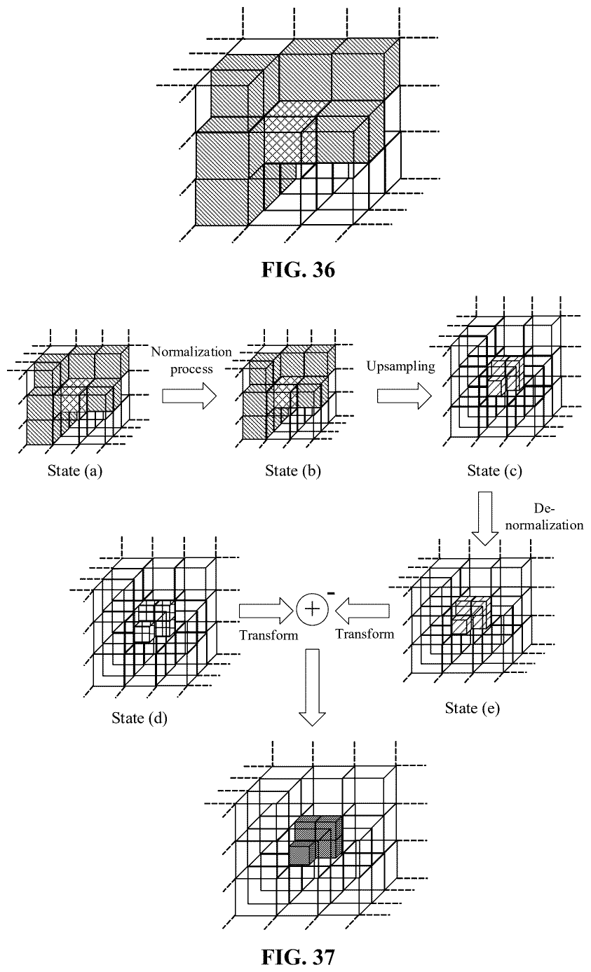

In a specific implementation, for region adaptive hierarchical intra prediction transform coding, prediction may be performed on the basis of RAHT transform coding. As shown in FIG. 33, the RAHT attribute transform is based on the hierarchical order of the octree, and the voxel level is continuously transformed until the root node is obtained, thereby completing the hierarchical transform coding of the entire attribute. In prediction transform coding, attribute prediction transform coding is also performed based on the hierarchical order of the octree, but the transform is continuously performed from the root node to the voxel level. In the process of each RAHT attribute transform, attribute prediction transform coding is performed based on 2×2×2 blocks. Specifically, as shown in FIG. 36, it can be seen that the grid-padded block is the current to-be-encoded block, and the oblique line-padded blocks are neighbourhood blocks that are coplanar and collinear with the current to-be-encoded block. Where the attributes of the current block are normalized in the following manner:

$${A}_{node} = {\sum }_{p ∈ node} attribute ( p ) ;$$

$${w}_{node} = {\sum }_{p ∈ node} 1 = \{ p ∈ node \} ;$$

$${a}_{node} = {A}_{node} / {w}_{node} .$$

First, the attributes of the current block can be obtained by the attribute of points included in the current block, namely: A_{node}. By simply adding the attributes of the points included in the current block, and then normalizing the attributes of the current block with the number of points in the current block, to obtain the mean value a_{node} of the attributes of the current block. The mean value of the attributes of the current block is used to perform attribute transform coding. The specific encoding process is shown in FIG. 37.

As shown in FIG. 37, an overall process of RAHT attribute prediction transform coding is shown here. Here, State (a) is the current block and some coplanar and collinear neighbourhood blocks, State (b) is the normalized blocks, State (c) is the upsampled blocks, State (d) is the attribute of the current block, State (e) is the attribute of the prediction block obtained by using the neighbourhood attributes of the current block for linear weighted fitting, and finally the attribute transform is performed on the both respectively to obtain DC and AC coefficients, and prediction coding is performed on the AC coefficients.

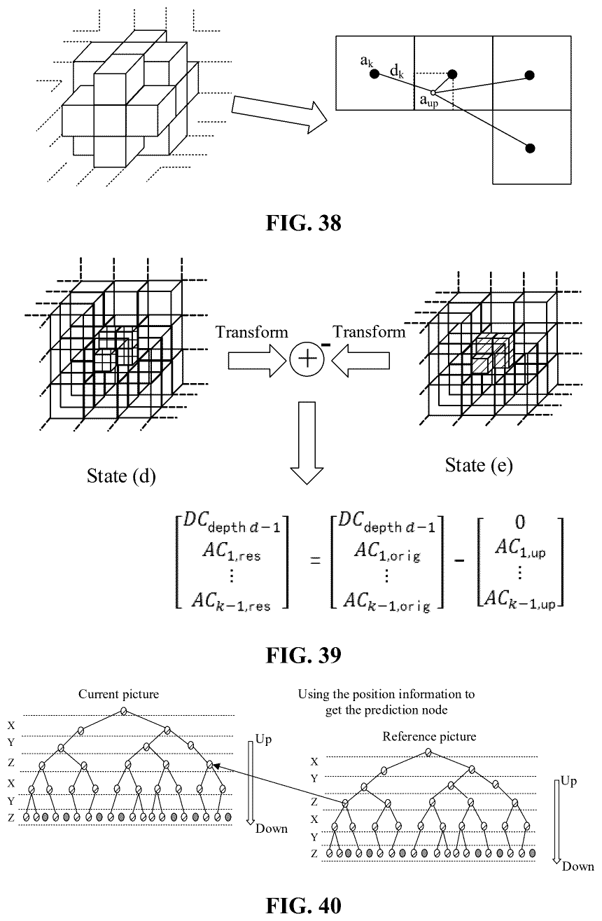

The prediction attribute of the current block can be obtained by performing linear fitting as shown in FIG. 38. As shown in FIG. 38, firstly, 19 neighbourhood blocks of the current block are obtained; secondly, linear weighted prediction is performed on the attribute of each sub-block by using the spatial geometry distance between the neighbourhood block and each sub-block of the current block, and finally the prediction block attribute obtained by linear weighting is used for transform. The specific attribute transform is shown in FIG. 39.

In FIG. 39, State (d) represents the original attribute value, and the corresponding attribute transform coefficients are as follows:

$$[ \begin{matrix}* \\ A {C}_{1 , orig} \\ ⋮ \\ A {C}_{k - 1 , orig}\end{matrix} ] = {T}_{node} [ \begin{matrix}{A}_{1} , orig / \sqrt{{w}_{1}} \\ ⋮ \\ {A}_{k , orig} / \sqrt{{w}_{k}}\end{matrix} ] \qquad ( 31 )$$

State (e) represents the attribute prediction value, and the corresponding attribute transform coefficients are as follows:

$$[ \begin{matrix}* \\ A {C}_{1 , up} \\ ⋮ \\ A {C}_{k - 1 , up}\end{matrix} ] = {T}_{node} [ \begin{matrix}{A}_{1 , up} / \sqrt{{w}_{1}} \\ ⋮ \\ {A}_{k , up} / \sqrt{{w}_{k}}\end{matrix} ] \qquad ( 32 )$$

According to the subtraction operation between the original attribute value and the attribute prediction value, the prediction residual can be obtained as follows:

$$[ \begin{matrix}D {C}_{depth d - 1} \\ A {C}_{1 , res} \\ ⋮ \\ A {C}_{k - 1 , res}\end{matrix} ] = [ \begin{matrix}D {C}_{depth d - 1} \\ A {C}_{1 , orig} \\ ⋮ \\ A {C}_{k - 1 , orig}\end{matrix} ] - [ \begin{matrix}0 \\ A {C}_{1 , up} \\ ⋮ \\ A {C}_{k - 1 , up}\end{matrix} ] \qquad ( 33 )$$

In another specific implementation, for region adaptive hierarchical inter prediction transform coding, a process similar to intra prediction coding is performed in G-PCC attribute inter prediction coding scheme 1. Firstly, the RAHT attribute transform coding structure is constructed based on geometry information, that is, the voxel level is continuously transformed until the root node is obtained, thus completing the hierarchical transform coding of the entire attribute. In this way, an intra coding structure and an inter coding structure are constructed. Here, the inter coding structure of the RAHT attribute can be seen in FIG. 40.

As shown in FIG. 40, firstly, the collocated prediction node of the to-be-encoded node is obtained in the reference picture by using the geometry information of the current to-be-encoded node, and secondly, the prediction attribute of the current to-be-encoded node is obtained by using the geometry information and attribute information of the reference node.

The attribute prediction value of the current to-be-encoded node is obtained according to the following two different manners.

\textcircled{1} The inter prediction node of the current node is valid: that is, if the collocated node exists, the attribute of the prediction node is directly used as the attribute prediction value of the current to-be-encoded node.

\textcircled{2} The inter prediction node of the current node is invalid: that is, the collocated node does not exist, the attribute prediction value of the neighbouring node in the frame is used as the attribute prediction value of the to-be-encoded node.

Finally, the obtained attribute prediction value is used to predict the attribute of the current to-be-encoded node. Thereby completing the prediction coding of the entire attribute.

In another specific implementation, for the region adaptive hierarchical inter prediction transform coding, in the G-PCC attribute inter prediction coding scheme 2, unlike the intra prediction coding and the inter prediction coding scheme 1, if the inter prediction coding scheme 2 is enabled, the RAHT attribute transform coding structure is first constructed based on the geometry information of the current to-be-encoded node, that is, nodes are continuously merged from the voxel level until the root node of the entire RAHT transform tree is obtained, thereby completing the transform coding hierarchical structure of the entire attribute. Secondly, according to the RAHT transform structure, partitioning is performed from the root node to obtain N child nodes of each node (N is less than or equal to 8). In the inter prediction coding scheme 2, firstly, the attributes of the N child nodes are independently orthogonally transformed by using the RAHT transform to obtain DC coefficients and AC coefficients, and secondly, the attribute inter prediction is performed on the AC coefficients of the N child nodes in the following manner.

\textcircled{1} The inter prediction node of the current node is valid: that is, if the collocated node exists, the attribute of the prediction node is directly used as the attribute prediction value of the current to-be-encoded node.

\textcircled{2} The current node can find a node with exactly the same position as the current node in the buffer of the reference picture: that is, if the collocated node exists, the AC coefficients of M child nodes included in the collocated node is directly used as the AC coefficient attribute prediction values of N child nodes of the current node.

If the AC coefficient of the prediction node is not zero: the AC coefficient of the prediction node is directly taken as the prediction value.

If the AC coefficient of the prediction node is zero, the AC coefficient of the corresponding child node obtained via intra prediction is taken as the prediction value.

\textcircled{3} The inter prediction node of the current node is invalid: that is, the collocated node does not exist, the attribute prediction value of the neighbouring node in the frame is used as the attribute prediction value of the to-be-encoded node.

In common G-PCC attribute RAHT inter prediction coding, inter prediction performed on the attribute by determining which inter prediction coding scheme to employ in a high-layer Attribute Parameter Set (APS) syntax element, the enabling layer of inter prediction coding is determined by a syntax element treeDepth, and only RAHT intra prediction coding is employed in the lower RAHT coding layer. For common RAHT attribute inter coding, the position of the current node is first used to obtain the corresponding prediction value in the reference picture. If the attribute of the prediction node is not zero, the attribute value of the prediction node of the current node will be directly used as the prediction value of the current node. Otherwise, the prediction values obtained by the intra nodes will be considered.

However, the common attribute prediction coding scheme does not effectively take into account the correlation between inter and intra prediction and attribute value of the current node, but simply default inter prediction value has a higher priority than the priority of the intra prediction value, which leads to the inter coding efficiency of the point cloud attribute to rely more on the time slot correlation of node attributes between the current picture and the reference picture, without adequately combining time slot correlation with the spatial-domain correlation of different nodes, thus resulting in lower RAHT attribute coding efficiency of the current node cloud.

That is, the common attribute prediction coding scheme does not take into account the correlation between inter and intra prediction and the attribute value of the current node, which leads to low RAHT attribute coding efficiency of the current node cloud, reduces the prediction effect of the attribute information, and reduces the encoding and decoding performance of the point cloud.

In order to solve the above problems, in the embodiment of the present disclosure, at the decoding end, the decoder determines a prediction mode corresponding to a current node; in a case where the prediction mode is a first mode, determines neighbouring nodes corresponding to the current node in a current picture, and determines a reference node corresponding to the current node in a reference picture corresponding to the current picture; and determines a prediction value of the current node according to a first prediction value of the reference node and a second prediction value of the neighbouring nodes. At the encoding end, the encoder determines a prediction mode corresponding to a current node according to a rate-distortion optimization algorithm; or determines the prediction mode corresponding to the current node according to a correlation between the current node and a reference node corresponding to the current node in a reference picture, where the prediction mode includes a first mode and a second mode. That is, in the embodiment of the present disclosure, when the attribute information prediction is performed on the current node, if the prediction mode corresponding to the current node is the first mode, the prediction value of the attribute information of the current node may be determined by combining the inter prediction value of the reference node in the reference picture corresponding to the current node and the intra prediction value of the neighbouring nodes in the current picture corresponding to the current node. Thus, in the embodiment of the present disclosure, joint prediction encoding and decoding of the current node can be performed by using the inter prediction value and the intra prediction value corresponding to the current node, so that the spatial-domain correlation of different nodes in the current picture can be taken into account on the basis of considering the time slot correlation of node attributes between the current picture and the reference picture, that is, the temporal correlation and the spatial-domain correlation are combined, so as to improve the RAHT attribute coding efficiency of the point cloud, enhance the prediction effect of the attribute information, and effectively improve the encoding and decoding performance of the point cloud.

Hereinafter, the embodiments of the present disclosure will be described in detail with reference to the drawings.

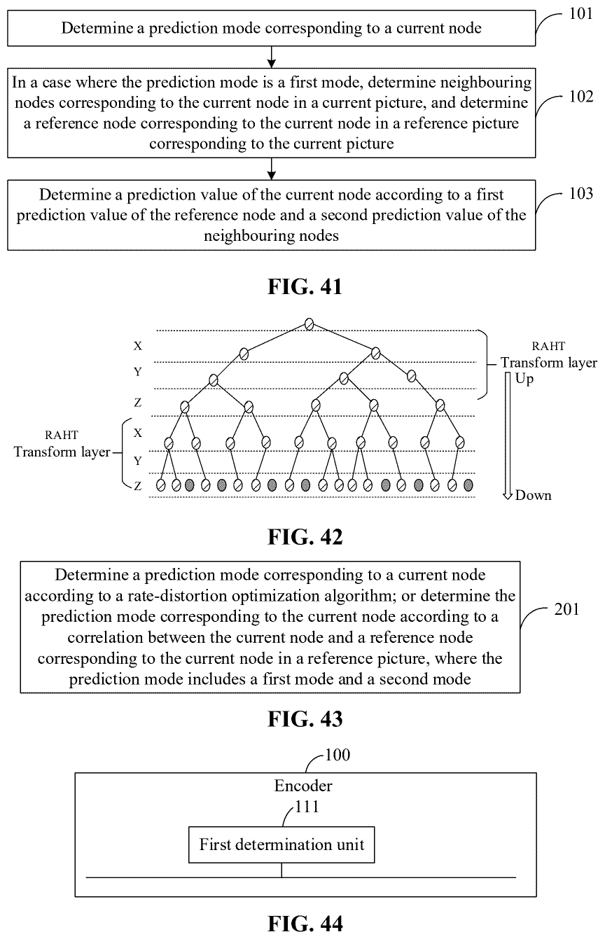

In one embodiment of the present disclosure, referring to FIG. 41, a schematic flowchart of a method for decoding provided by an embodiment of the present disclosure is shown. As shown in FIG. 41, a method for point cloud decoding performed by a decoder may include the following operations.

Operation 101: a prediction mode corresponding to a current node is determined.

In an embodiment of the present disclosure, the prediction mode corresponding to the current node may be determined first.

It should be noted that the method for decoding according to the embodiment of the present disclosure is applied to a point cloud decoder (which may be simply referred to as a “decoder”). The method may be a pointing cloud decoding method, specifically a point cloud attribute decoding method.

Note that, in the RAHT attribute transform according to the embodiment of the present disclosure, the order of the RAHT attribute transform is sequentially partitioned from the root node until the RAHT attribute transform is partitioned to the voxel level. Specifically, when the RAHT attribute transform is partitioned to a unit cube having a size of 1×1×1, the partition is stopped, thereby completing the encoding and reconstruction of the entire point cloud attribute. Here, as shown in FIG. 42, the layer obtained by downsampling along the Z direction, the Y direction and the X direction each time is an RAHT transform layer, i.e., a layer. Then, until it is partitioned into a unit cube of 1×1×1 size, which indicates that it has been partitioned to the voxel level.

It is understood that in an embodiment of the present disclosure, the current node may be a to-be-decoded node in the RAHT transform layer corresponding to the current node cloud.

It should be noted that in an embodiment of the present disclosure, the prediction mode corresponding to the current node may include a first mode or a second mode. The first mode may be a prediction mode in which intra prediction and inter prediction are weighted. The second mode may be a prediction mode in which intra prediction and inter prediction are combined.

Further, in the embodiment of the present disclosure, when determining the prediction mode corresponding to the current node, the prediction mode identification information corresponding to the current layer may be determined by decoding the bitstream, and then the prediction mode corresponding to the current node in the current layer may be determined based on the prediction mode identification information.

Note that, in the embodiment of the present disclosure, the prediction mode identification information corresponding to the current layer may be a syntax element corresponding to an Attribute Block Head (ABH).

It is understood that, in the embodiment of the present disclosure, the current layer may be any RAHT transform layer corresponding to the current node cloud, and accordingly, the prediction mode of the current node in the current layer may be determined by the prediction mode identification information corresponding to the current layer.

Note that, in the embodiment of the present disclosure, when determining the prediction mode corresponding to the current node in the current layer based on the prediction mode identification information, the value of the current prediction mode identification information may be determined first, and then the prediction mode corresponding to the current node may be further determined based on the value of the prediction mode identification.

Exemplarily, in some embodiments, when the value of the prediction mode identification information is the first value, it is determined that the prediction mode corresponding to the current node is the first mode. When the value of the prediction mode identification information is the second value, it is determined that the prediction mode corresponding to the current node is the second mode.

It should also be noted that in the embodiment of the present disclosure, the first value is different from the second value, and the first value and the second value may be in in parameter form or numerical form. Specifically, the first prediction mode identification information and the second prediction mode identification information may be parameters written in a profile, or may be a value of a flag, and are not specifically limited here. Further, for the first value and the second value, the first value may be set to 1 and the second value may be set to 0. Alternatively, the first value may be set to 0 and the second value may be set to 1. Alternatively, the first value may be set to true and the second value may be set to false. Alternatively, the first value may be set to false and the second value may be set to true. However, in the embodiment of the present disclosure, the first value is set to 1 and the second value is set to 0, but there is no specific limitation.

Further, in the embodiment of the present disclosure, when determining the prediction mode corresponding to the current node, the error parameter between the current node and the reference node may be determined according to the occupancy information of the current node and the occupancy information of the reference node. Then the prediction mode is determined according to the error parameter and the error threshold.

It should be noted that, in an embodiment of the present disclosure, the occupancy information of the current node may represent the occupancy of the child nodes of the current node, and may be, for example, the number of valid child nodes of the current node, or the number of occupied child nodes of the current node.

It should be noted that, in an embodiment of the present disclosure, the occupancy information of the reference node may represent the occupancy of the child nodes of the reference node, and may be, for example, the number of valid child nodes of the reference node, or the number of occupied child nodes of the reference node.

It is understood that, in the embodiment of the present disclosure, based on the error parameter determined by the occupancy information of the current node and the occupancy information of the reference node, the geometry position correlation between the current node and the reference node may be determined, and the geometry position error between the current node and the reference node may also be determined.

Exemplarily, in some embodiments, the error parameter determined based on the occupancy information of the current node and the occupancy information of the reference node may be a difference between the occupancy information of the current node and the occupancy information of the reference node, or may be a ratio between the occupancy information of the current node and the occupancy information of the reference node, and the present disclosure does not specifically limit it.

It is understood that in embodiments of the present disclosure, the error threshold may be used to measure the degree of geometry position correlation between the current node and the reference node, or to measure the degree of geometry position error between the current node and the reference node.

For example, in some embodiments, the error threshold may be any preset value. When the error parameter is a difference between the occupancy information of the current node and the occupancy information of the reference node, the error parameter may be a difference threshold. When the error parameter is a ratio between the occupancy information of the current node and the occupancy information of the reference node, the error parameter may be a proportional threshold, which is not specifically limited in the present disclosure.

Further, in the embodiment of the present disclosure, when the prediction mode is determined according to the error parameter and the error threshold, in a case where the error parameter is greater than or equal to the error threshold, the prediction mode corresponding to the current node may be determined to be the first mode; in a case where the error parameter is less than the error threshold, the prediction mode corresponding to the current node may be determined to be the second mode.

Note that, in the embodiment of the present disclosure, after comparing the error parameter and the error threshold, if the error parameter is greater than or equal to the error threshold, it may be considered that the geometry position error between the current node and the reference node is large, and at this time, in order to obtain a more accurate prediction effect, the first mode may be selected to predict the attribute information of the current node, that is, the prediction process of the current node is performed by using the prediction mode in which the intra prediction and the inter prediction are weighted. If the error parameter is less than the error threshold, it may be considered that the geometry position error between the current node and the reference node is small, and at this time, accurate prediction effect can be obtained by using inter prediction, so that the second mode can be selected to predict the attribute information of the current node, that is, the prediction process of the current node is performed by using the prediction mode in which the intra prediction and the inter prediction are combined.

That is to say, in the embodiment of the present disclosure, the prediction encoding and decoding mode of the current layer may be implicitly derived in a certain manner, for example, the enabling of inter prediction coding is determined by the correlation of geometry information between the current node and the prediction point. When the difference in the occupancy information of the inter prediction node (reference node) and the current node (current point) is within a certain range, the inter prediction value is directly used as the prediction value of the current node. When the error is greater than a certain threshold, the inter prediction value and the intra prediction value are linearly weighted to obtain the optimal prediction value of the current node.

Operation 102: in a case where the prediction mode is a first mode, neighbouring nodes corresponding to the current node is determined in the current picture, and a reference node corresponding to the current node is determined in a reference picture corresponding to the current picture.

In an embodiment of the present disclosure, after determining the prediction mode corresponding to the current node, if the prediction mode corresponding to the current node is the first mode, the neighbouring nodes corresponding to the current node may be determined in the current picture, while the reference node corresponding to the current node may be determined in the reference picture corresponding to the current picture.

It should be noted that, in an embodiment of the present disclosure, the neighbouring node may be an encoded/decoded neighbouring node belonging to the same picture as the current node, and the neighbouring nodes corresponding to the current node may be determined in the current picture according to the geometry information of the current node obtained by encoding or decoding.

It should be noted that, in an embodiment of the present disclosure, the reference node may be an encoded/decoded point in one or more encoded/decoded pictures before the current picture where the current node is located, and the reference node corresponding to the current node may be determined in the reference picture corresponding to the current picture by the geometry information of the current node obtained by encoding or decoding.

It can be understood that in the embodiment of the present disclosure, a video frame can be understood as a picture. Exemplarily, a current frame may be understood as a current picture, and a reference frame may be understood as a reference picture.

Operation 103: a prediction value of the current node is determined according to a first prediction value of the reference node and a second prediction value of the neighbouring nodes.

In an embodiment of the present disclosure, in a case where the prediction mode is the first mode, the neighbouring nodes corresponding to the current node are determined in the current picture, and after the reference node corresponding to the current node is determined in the reference picture corresponding to the current picture, the prediction value of the current node may be further determined based on the first prediction value of the reference node and the second prediction value of the neighbouring nodes.

It is understood that in an embodiment of the present disclosure, the first prediction value may be an inter prediction value corresponding to the current node, and the second prediction value may be an intra prediction value corresponding to the current node.

It should be noted that, in the embodiment of the present disclosure, when determining the prediction value of the current node based on the first prediction value of the reference node and the second prediction value of the neighbouring nodes, it is possible to first determine the first weight corresponding to the first prediction value, while determine the second weight corresponding to the second prediction value. Then, a weighted calculation on the first prediction value and the second prediction value according to the first weight and the second weight, to determine the prediction value of the current node.

It is understood that in the embodiment of the present disclosure, the first mode may be a prediction mode in which the intra prediction and the inter prediction are weighted, that is, the prediction mode of the first mode may assign a certain weight to the inter prediction value and the intra prediction value, and finally obtain the attribute prediction value of the current node by linear weighted prediction. Therefore, after determining that the prediction mode corresponding to the current node is the first mode, in addition to determining the intra prediction value and the inter prediction value corresponding to the current node, it is also necessary to determine the weight values corresponding to the inter prediction value and the intra prediction value, and then use the weight values for subsequent weighted operation processing.

Note that, in an embodiment of the present disclosure, the first weight corresponding to the first prediction value is a weight value of the inter prediction value corresponding to the current node, and the second weight corresponding to the second prediction value is a weight value of the intra prediction value corresponding to the current node.

Further, in the embodiment of the present disclosure, when determining the prediction value of the current node according to the first prediction value of the reference node and the second prediction value of the neighbouring nodes, it is first determined whether the current node has a collocated node in the prediction buffer, that is, whether the reference node exists, if so, the inter prediction value corresponding to the current node may be determined, and the prediction value predVal of the current node can be determined according to the inter prediction value predInterVal, the intra prediction value predIntraVal corresponding to the current node, and the corresponding weight values.

$$predVal = w 1 \times predInterVal + w 2 \times predIntraVal \qquad ( 34 )$$

Where w1 is a weight of inter prediction, i.e., a first weight, and w2 is a weight value of intra prediction, i.e., a second weight.

For example, in some embodiments, it is possible to first determine whether the current node (current point) has a collocated node in the prediction buffer, if so, it is assumed that the inter prediction value is predInterVal, and it is determined whether the current node can perform intra prediction, and if intra prediction can be performed, it is assumed that the intra prediction value of the current node is predIntraVal, and the prediction value of the current node can be calculated by the above formula (34).

Further, in an embodiment of the present disclosure, when determining the first weight corresponding to the first prediction value and the second weight corresponding to the second prediction value, the first weight and the second weight corresponding to the current node may be obtained by decoding the bitstream. That is, the first weight and the second weight may be transmitted from the encoding end to the decoding end through the bitstream.

Further, in the embodiment of the present disclosure, when determining the first weight corresponding to the first prediction value and the second weight corresponding to the second prediction value, temporal interval information between the current picture and the reference picture may be determined first. Furthermore, a first initial weight corresponding to the first prediction value may be determined, and a second initial weight corresponding to the second prediction value may be determined. Further, the first weight may be determined according to the temporal interval information and the first initial weight, and the second weight may be determined according to the temporal interval information and the second initial weight.

It should be noted that, in the embodiment of the present disclosure, the first initial weight of the inter prediction value corresponding to the current node and the second initial weight of the intra prediction value may be determined by decoding the bitstream, and then the first initial weight and the second initial weight may be corrected by using the temporal interval information between the current picture and the reference picture, respectively, and finally the first weight and the second weight used for weighted operation processing may be obtained.

Further, in an embodiment of the present disclosure, when determining the first weight according to the temporal interval information and the first initial weight, the first weight may be determined using any calculation formula based on the temporal interval information and the first initial weight, and for example, a ratio between the first initial weight and the temporal interval information may be determined as the first weight.

Further, in an embodiment of the present disclosure, when determining the second weight according to the temporal interval information and the second initial weight, the second weight may be determined using any calculation formula based on the temporal interval information and the second initial weight, and for example, a product between the second initial weight and the temporal interval information may be determined as the second weight.

That is, in the embodiment of the present disclosure, the first weight corresponding to the inter prediction value and the second weight corresponding to the intra prediction value may be determined by the temporal interval (temporal interval information) between the current picture and the reference picture. That is, the weight value used for the final weighted prediction processing of the inter prediction value and the intra prediction value can be adaptively obtained through the temporal interval between the current picture and the reference picture.

For example, in some embodiments, assuming that the first initial weight of the inter prediction value (first prediction value) of the current node (current point) is W1, the second initial weight corresponding to the intra prediction value (second prediction value) is W2, and the temporal interval (temporal interval information) between the current picture and the reference picture is D, the final calculated prediction value of the current node is:

$$predVal = w 1 \times predInterVal + w 2 \times predIntraVal \qquad ( 35 )$$

Where w1 is a final inter prediction weight value, that is, a first weight, w2 is a final intra prediction weight value, that is, a second weight, and w1 and w2 are calculated as follows:

$$w 1 = W 1 / D \qquad ( 36 )$$

$$w 2 = W 2 \times D \qquad ( 37 )$$

Exemplarily, in some embodiments, it is possible to first determine whether the current node (current point) has a collocated node in the prediction buffer, if so, it is assumed that the inter prediction value is predInterVal, and it is determined whether the current node can perform intra prediction, and if intra prediction can be performed, it is assumed that the intra prediction value of the current node is predIntraVal, and the prediction value of the current node can be calculated by the above formula (35).

Further, in an embodiment of the present disclosure, when determining the first weight corresponding to the first prediction value and the second weight corresponding to the second prediction value, the time slot distance between the current picture and the reference picture and the number of neighbouring nodes of the current node in the current picture may be respectively determined first, and then the first weight may be determined according to the time slot distance between the current picture and the reference picture. While the second weight may be determined according to the number of neighbouring nodes corresponding to the current node.

That is, in the embodiment of the present disclosure, when determining the first weight corresponding to the inter prediction value and the second weight corresponding to the intra prediction value, the inter prediction weight, that is, the first weight, may be determined according to the time slot distance between the current picture and the reference picture; and the intra prediction weight, that is, the second weight, may be determined according to the neighbourhood node number (the number of neighbouring nodes corresponding to the current node).

Further, in the embodiment of the present disclosure, after determining the prediction mode corresponding to the current node, in a case where the prediction mode is the second mode, if there is a reference node corresponding to the current node in the reference picture corresponding to the current picture, the prediction value of the current node may be directly determined according to the first prediction value of the reference node.

Further, in the embodiment of the present disclosure, after determining the prediction mode corresponding to the current node, in a case where the prediction mode is the second mode, if there is no reference node corresponding to the current node in the reference picture corresponding to the current picture, the prediction value of the current node may be determined according to the second prediction value of the neighbouring nodes.

That is, in the embodiment of the present disclosure, for the second mode, a prediction mode in which the inter prediction and the intra prediction are combined may be used when attribute information prediction is performed on the current node.

Exemplarily, in some embodiments, if the current node uses the second mode, an RAHT attribute transform encoding structure is first constructed based on the geometry information of the current node, that is, node merging is continuously performed at the voxel level until the root node of the entire RAHT transform tree is obtained, thereby completing the transform encoding hierarchical structure of the entire attribute. Then, according to the RAHT transform structure, attribute inter prediction is performed in the following manner.

Exemplarily, in some embodiments, if the inter prediction node of the current node is valid, i.e., a collocated node exists, the attribute of the prediction node may be directly taken as the attribute prediction value of the current node. That is, when the reference node corresponding to the current node exists in the reference picture corresponding to the current picture, the prediction value of the current node may be directly determined according to the first prediction value of the reference node.

Exemplarily, in some embodiments, if the inter prediction node of the current node is invalid, i.e., the collocated node does not exist, then the attribute prediction value of the intra neighbouring node may be taken as the attribute prediction value of the current node. That is, when the reference node corresponding to the current node does not exist in the reference picture corresponding to the current picture, the prediction value of the current node may be determined according to the second prediction value of the neighbouring nodes.

Further, in the embodiment of the present disclosure, it is possible to first determine whether the attribute prediction for the current node is allowed, and determine whether the inter attribute prediction for the current node is allowed, and then, in a case where the attribute prediction for the current node is allowed and the inter attribute prediction for the current node is allowed, the determination process for the prediction mode of the current node is performed, that is, the process of determining the prediction mode of operation 101 is performed.

It should be noted that, in the embodiment of the present disclosure, when determining whether the attribute prediction for the current node is allowed, it is possible to first determine the neighbourhood node number of the current node and the parent node neighbourhood node number of the current node. Then, when the neighbourhood node number of the current node is greater than the first threshold and the parent node neighbourhood node number is greater than the second threshold, it is determined that the attribute prediction for the current node is allowed.

It can be understood that in the embodiment of the present disclosure, when prediction coding is performed on the attribute transform coefficient of each point, there is an enabling condition of whether or not to enable the prediction coding, the details are as follows.

\textcircled{1} Whether the neighbourhood node number of the current node is greater than a first threshold.

\textcircled{2} Whether the parent node neighbourhood node number corresponding to the current node is greater than a second threshold.

The attribute coding coefficients of the current node are predicted if and only if both conditions are met simultaneously. However, the first threshold and the second threshold may be the same or different. Based on such encoding enabling conditions, the entire attribute prediction coding is completed.

It should be noted that, in the embodiment of the present disclosure, both the first threshold and the second threshold may be preset values in the decoder, and are used to determine whether the attribute prediction for the current node is allowed.

It should also be noted that, in the embodiment of the present disclosure, before the attribute decoding of the current node is performed, all the geometry information of the nodes in the current node cloud has been decoded.

In summary, in the embodiment of the present disclosure, through the coding and decoding method proposed in operations 101 to 103 described above, when the attribute information of the current node is encoded or decoded, if the attribute prediction can be performed on the current to-be-encoded layer, and when the attribute inter prediction is performed, the weighted prediction is performed by combining the inter prediction value and the intra prediction value of the current node in a certain manner, so as to obtain the optimal prediction value of the current node. The spatial-domain redundancy of different nodes in the current picture and the temporal correlation of the same node across different pictures can be more effectively considered, and the correlation of point cloud attributes can be further eliminated, thus further improving the attribute coding efficiency of the point cloud.

By way of example, in the implementation of the standard text, a specific modification is as follows.

TABLE 2
Attribute data unit header syntax

| | Descriptor | Semantics |
|---|---|---|
| attribute_data_unit_header( ) { | | |
| adu_attr_parameter_set_id | u(4) | 7.4.4.2 |
| adu_reserved_zero_3bits | u(3) | 7.4.4.2 |
| adu_sps_attr_idx | ue(v) | 7.4.4.2 |
| adu_slice_id | ue(v) | 7.4.4.2 |
| if(lod_dist_log2_offset_present) | | |
| lod_dist_log2_offset | se(v) | 10.6.2 |
| if(last_comp_pred_enabled && AttrDim == 3) | | |
| for(dpth = 0; dpth ≤ lod_max_levels_minus1; | | |
| dpth++) | | |
| last_comp_pred_coeff_diff[dpth] | se(v) | 10.6.10.1 |
| if(inter_comp_pred_enabled) | | |
| for(dpth = 0; dpth ≤ lod_max_levels_minus1; | | |
| dpth++) | | |
| for(c = 1; c < AttrDim; c++) | | |
| inter_comp_pred_coeff_diff[dpth][ c] | se(v) | 10.6.10.1 |
| if(attr_qp_offsets_present) | | |
| for(qc = 0; qc < Min(2, AttrDim); qc++) | | |
| attr_qp_offset[qc] | se(v) | 10.7.1 |
| attr_qp_layers_present | u(1) | 10.7.1 |
| if(attr_qp_layers_present) { | | |
| attr_qp_layer_cnt_minus1 | ue(v) | 10.7.1 |
| for(dpth = 0; dpth ≤ attr_qp_layer_cnt_minus1; | | |
| dpth++) | | |
| for(qc = 0; qc < Min(2, AttrDim); qc++) | | |
| attr_qp_layer_offset[dpth][qc] | se(v) | 10.7.1 |
| } | | |
| attr_qp_region_cnt | ue(v) | 10.7.1 |
| if(attr_qp_region_cnt) | | |
| attr_qp_region_bits_minus1 | ue(v) | 10.7.1 |
| for(i = 0; i < attr_qp_region_cnt; i++) { | | |
| if(¬attr_coord_conv_enabled) { | | |
| for(k = 0; k < 3; k++) | | |
| attr_qp_region_origin_xyz[i][k] | u(v) | 10.7.1 |
| for(k = 0; k < 3; k++) | | |
| attr_qp_region_size_minus1_xyz[i][k] | u(v) | 10.7.1 |
| } else { | | |
| for(k = 0; k < 3; k++) | | |
| attr_qp_region_origin_rpi[i][k] | u(v) | 10.7.1 |
| for(k = 0; k < 3; k++) | | |
| attr_qp_region_size_minus1_rpi[i][k] | u(v) | 10.7.1 |
| } | | |
| for(ps = 0; ps < Min(2, AttrDim); ps++) | | |
| attr_qp_region_offset[i][ps] | se(v) | 10.7.1 |
| } | | |
| disableAttrInterPred | u(1) | |
| if(attr_coding_type == 0&& !disableAttrInterPred) | | |
| if(raht_prediction_enabled){ | | |
| attr_code_mode_cnt | ue(v) | |
| for(i = 0; i < attr_code_mode_cnt; i++) | | |
| attr_code_mode[i] | u(1) | |
| } | | |
| byte_alignment( ) | | |
| } | | |

Thus, according to the encoding and decoding method proposed in the present disclosure, when performing RAHT prediction coding on attributes, a prediction coding mode (such as the prediction mode of the current node indicated by the prediction mode identification information corresponding to the current layer) is introduced into each RAHT coding layer to adaptively select an inter prediction coding mode combined with an intra prediction coding mode, or select a linear weighted intra prediction coding and an inter prediction coding mode, and finally pass the coding mode to the decoding end. The decoding end uses the coding mode to reconstruct the attributes of the point cloud.

It can be understood that, in the embodiment of the present disclosure, precisely because a coding mode is introduced in each RAHT coding layer, the coding mode (such as the first mode) can comprehensively consider the intra prediction and the inter prediction by weighting in a certain way, so that spatial-domain redundancy characteristics and temporal redundancy characteristics of different nodes can be further removed.

It should be noted that, in the embodiment of the present disclosure, the optimal coding mode (such as the first mode or the second mode) can be obtained by using the distortion optimization selection algorithm at the encoding end, and secondly, the attributes of the point cloud can be reconstructed by using the decoding mode at the decoding end.

Exemplarily, in some embodiments, the coding mode of each layer may be stored in the ABH, and the decoding mode of the coding layer of the RAHT may be obtained through the ABH at the decoding end, and there is no limitation on the form in which this parameter is encoded.

For example, in some embodiments, the prediction weights of the inter prediction value and the intra prediction value are not limited, and for example, the prediction weights of the inter prediction value and the intra prediction value can be adaptively selected by a rate-distortion optimization algorithm to obtain an optimal prediction value, thereby further improving the attribute coding efficiency of the point cloud.

The embodiment provides a method for decoding. At the decoding end, the decoder determines a prediction mode corresponding to a current node; in a case where the prediction mode is a first mode, determines neighbouring nodes corresponding to the current node in a current picture, and determines a reference node corresponding to the current node in a reference picture corresponding to the current picture; and determines a prediction value of the current node according to a first prediction value of the reference node and a second prediction value of the neighbouring nodes. That is, in the embodiment of the present disclosure, when the attribute information prediction is performed on the current node, if the prediction mode corresponding to the current node is the first mode, the prediction value of the attribute information of the current node may be determined by combining the inter prediction value of the reference node in the reference picture corresponding to the current node and the intra prediction value of the neighbouring nodes in the current picture corresponding to the current node. Thus, in the embodiment of the present disclosure, joint prediction encoding and decoding of the current node can be performed by using the inter prediction value and the intra prediction value corresponding to the current node, so that the spatial-domain correlation of different nodes in the current picture can be taken into account on the basis of considering the time slot correlation of node attributes between the current picture and the reference picture, that is, the temporal correlation and the spatial-domain correlation are combined, so as to improve the RAHT attribute coding efficiency of the point cloud, enhance the prediction effect of the attribute information, and effectively improve the encoding and decoding performance of the point cloud.

In yet another embodiment of the present disclosure, referring to FIG. 43, a schematic flowchart of a method for encoding provided by an embodiment of the present disclosure is shown. As shown in FIG. 43, a method for point cloud encoding performed by an encoder may include the following operations.

Operation 201: a prediction mode corresponding to a current node is determined according to a rate-distortion optimization algorithm; or the prediction mode corresponding to the current node is determined according to a correlation between the current node and a reference node corresponding to the current node in a reference picture, where the prediction mode includes a first mode and a second mode.

In an embodiment of the present disclosure, the prediction mode corresponding to the current node may be determined first.

It should be noted that the method for encoding according to the embodiment of the present disclosure is applied to a point cloud encoder (which may be simply referred to as an “encoder”). The method may be a point cloud encoding method, specifically a point cloud attribute encoding method.

Note that, in the RAHT attribute transform according to the embodiment of the present disclosure, the order of the RAHT attribute transform is sequentially partitioned from the root node until the RAHT attribute transform is partitioned to the voxel level. Specifically, when the RAHT attribute transform is partitioned to a unit cube having a size of 1×1×1, the partition is stopped, thereby completing the encoding and reconstruction of the entire point cloud attribute. Here, as shown in FIG. 42, the layer obtained by downsampling along the Z direction, the Y direction and the X direction each time is an RAHT transform layer, i.e., a layer. Then, until it is partitioned into a unit cube of 1×1×1 size, which indicates that it has been partitioned to the voxel level.

It can be understood that in an embodiment of the present disclosure, the current node may be a to-be-encoded node in the RAHT transform layer corresponding to the current node cloud.

It should be noted that in an embodiment of the present disclosure, the prediction mode corresponding to the current node may include a first mode or a second mode. The first mode may be a prediction mode in which intra prediction and inter prediction are weighted. The second mode may be a prediction mode in which intra prediction and inter prediction are combined.

Further, in an embodiment of the present disclosure, when the prediction mode corresponding to the current node is determined according to the rate-distortion optimization algorithm, the first cost value corresponding to the first mode and the second cost value corresponding to the second mode may be determined according to the rate-distortion optimization algorithm. Then, the prediction mode corresponding to the current node may be determined according to the first cost value and the second cost value.

It should be noted that, in the embodiment of the present disclosure, at the encoding end, the encoder may use the rate-distortion optimization algorithm to perform prediction coding on the attribute information of the current node in the current layer by using two prediction modes (the first mode and the second mode), and finally use the rate-distortion optimization algorithm to obtain the prediction mode of the current node, so as to determine the optimal coding mode of the current layer.

Exemplarily, in some embodiments, in the rate-distortion optimization algorithm, the distortion D between the reconstructed attribute and the original attribute of each prediction mode is first calculated, and the to-be-encoded bitstream R for each prediction mode is secondly obtained, and the rate-distortion cost is calculated as follows:

$$J = D + λ xR \qquad ( 38 )$$

Here, λ can be calculated by the attribute quantization parameter, for example, as follows:

$$λ = {2}^{\frac{QP - 4}{6}} \times N \qquad ( 39 )$$

Here, the parameter N is currently set to a different value depending on the reflectance and the colour.

Further, in an embodiment of the present disclosure, after the first cost value corresponding to the first mode and the second cost value corresponding to the second mode are determined, the prediction mode corresponding to the current node can be determined by using the first cost value and the second cost value.

Exemplarily, in some embodiments, when determining the prediction mode corresponding to the current node according to the first cost value and the second cost value, if the first cost value is greater than or equal to the second cost value, the prediction mode corresponding to the current node may be determined as the first mode, and accordingly, if the first cost value is less than the second cost value, the prediction mode corresponding to the current node may be determined as the second mode.

Note that, in the embodiment of the present disclosure, after the prediction mode corresponding to the current node is determined, the optimal coding mode corresponding to the current layer may be further determined and transmitted to the decoding end, so that the decoding end can use the prediction encoding and decoding mode obtained by parsing to reconstruct and restore the attribute information of points of the current to-be-decoded layer.

Furthermore, in the embodiment of the present disclosure, in a case of determining that the prediction mode corresponding to the current node is the first mode, it is determined that a value of prediction mode identification information corresponding to a current layer is a first value. In a case of determining that the prediction mode corresponding to the current node is the second mode, it is determined that the value of the prediction mode identification information corresponding to the current layer is a second value. Finally, the prediction mode identification information can be signalled in the bitstream and transmitted to the decoding end.

Note that, in the embodiment of the present disclosure, the prediction mode identification information corresponding to the current layer may be a syntax element corresponding to the ABH. That is, the prediction coding mode (prediction mode identification information) of each layer can be finally added to the ABH parameter set.

Accordingly, in the embodiment of the present disclosure, at the decoding end, the decoder determines prediction mode identification information corresponding to the current layer by decoding the bitstream, and then determines the prediction mode corresponding to the current node in the current layer based on the prediction mode identification information.

It is understood that, in the embodiment of the present disclosure, the current layer may be any RAHT transform layer corresponding to the current node cloud, and accordingly, the prediction mode of the current node in the current layer may be determined by the prediction mode identification information corresponding to the current layer.

Note that, in the embodiment of the present disclosure, when determining the prediction mode corresponding to the current node in the current layer based on the prediction mode identification information, the value of the current prediction mode identification information may be determined first, and then the prediction mode corresponding to the current node may be further determined based on the value of the prediction mode identification.

Exemplarily, in some embodiments, when the value of the prediction mode identification information is the first value, it is determined that the prediction mode corresponding to the current node is the first mode. When the value of the prediction mode identification information is the second value, it is determined that the prediction mode corresponding to the current node is the second mode.

It should also be noted that in the embodiment of the present disclosure, the first value is different from the second value, and the first value and the second value may be in in parameter form or numerical form. Specifically, the first prediction mode identification information and the second prediction mode identification information may be parameters written in a profile, or may be a value of a flag, and are not specifically limited here. Further, for the first value and the second value, the first value may be set to 1 and the second value may be set to 0. Alternatively, the first value may be set to 0 and the second value may be set to 1. Alternatively, the first value may be set to true and the second value may be set to false. Alternatively, the first value may be set to false and the second value may be set to true. However, in the embodiment of the present disclosure, the first value is set to 1 and the second value is set to 0, but there is no specific limitation.

Further, in the embodiment of the present disclosure, when determining the prediction mode corresponding to the current node according to the correlation between the current node and the reference node corresponding to the current node in the reference picture, the error parameter between the current node and the reference node may be determined according to the occupancy information of the current node and the occupancy information of the reference node. Then the prediction mode is determined according to the error parameter and the error threshold.

It should be noted that, in an embodiment of the present disclosure, the occupancy information of the current node may represent the occupancy of the child nodes of the current node, and may be, for example, the number of valid child nodes of the current node, or the number of occupied child nodes of the current node.

It should be noted that, in an embodiment of the present disclosure, the occupancy information of the reference node may represent the occupancy of the child nodes of the reference node, and may be, for example, the number of valid child nodes of the reference node, or the number of occupied child nodes of the reference node.

It is understood that, in the embodiment of the present disclosure, based on the error parameter determined by the occupancy information of the current node and the occupancy information of the reference node, the geometry position correlation between the current node and the reference node may be determined, and the geometry position error between the current node and the reference node may also be determined.

Exemplarily, in some embodiments, the error parameter determined based on the occupancy information of the current node and the occupancy information of the reference node may be a difference between the occupancy information of the current node and the occupancy information of the reference node, or may be a ratio between the occupancy information of the current node and the occupancy information of the reference node, and the present disclosure does not specifically limit it.

It is understood that in embodiments of the present disclosure, the error threshold may be used to measure the degree of geometry position correlation between the current node and the reference node, or to measure the degree of geometry position error between the current node and the reference node.

For example, in some embodiments, the error threshold may be any preset value. When the error parameter is a difference between the occupancy information of the current node and the occupancy information of the reference node, the error parameter may be a difference threshold. When the error parameter is a ratio between the occupancy information of the current node and the occupancy information of the reference node, the error parameter may be a proportional threshold, which is not specifically limited in the present disclosure.

Further, in the embodiment of the present disclosure, when the prediction mode is determined according to the error parameter and the error threshold, in a case where the error parameter is greater than or equal to the error threshold, the prediction mode corresponding to the current node may be determined to be the first mode; in a case where the error parameter is less than the error threshold, the prediction mode corresponding to the current node may be determined to be the second mode.

Note that, in the embodiment of the present disclosure, after comparing the error parameter and the error threshold, if the error parameter is greater than or equal to the error threshold, it may be considered that the geometry position error between the current node and the reference node is large, and at this time, in order to obtain a more accurate prediction effect, the first mode may be selected to predict the attribute information of the current node, that is, the prediction process of the current node is performed by using the prediction mode in which the intra prediction and the inter prediction are weighted. If the error parameter is less than the error threshold, it may be considered that the geometry position error between the current node and the reference node is small, and at this time, accurate prediction effect can be obtained by using inter prediction, so that the second mode can be selected to predict the attribute information of the current node, that is, the prediction process of the current node is performed by using the prediction mode in which the intra prediction and the inter prediction are combined.

That is to say, in the embodiment of the present disclosure, the prediction encoding and decoding mode of the current layer may be implicitly derived in a certain manner, for example, the enabling of inter prediction coding is determined by the correlation of geometry information between the current node and the prediction point. When the difference in the occupancy information of the inter prediction node (reference node) and the current node (current point) is within a certain range, the inter prediction value is directly used as the prediction value of the current node. When the error is greater than a certain threshold, the inter prediction value and the intra prediction value are linearly weighted to obtain the optimal prediction value of the current node.

Further, in the embodiment of the present disclosure, based on the first mode, neighbouring nodes corresponding to the current node may be determined in the current picture, while a reference node corresponding to the current node may be determined in a reference picture corresponding to the current picture.

It should be noted that, in an embodiment of the present disclosure, the neighbouring node may be an encoded/decoded neighbouring node belonging to the same picture as the current node, and the neighbouring nodes corresponding to the current node may be determined in the current picture according to the geometry information of the current node obtained by encoding or decoding.

It should be noted that, in an embodiment of the present disclosure, the reference node may be an encoded/decoded point in one or more encoded/decoded pictures before the current picture where the current node is located, and the reference node corresponding to the current node may be determined in the reference picture corresponding to the current picture by the geometry information of the current node obtained by encoding or decoding.

It can be understood that in the embodiment of the present disclosure, a video frame can be understood as a picture. Exemplarily, a current frame may be understood as a current picture, and a reference frame may be understood as a reference picture.

Furthermore, in the embodiment of the present disclosure, based on the first mode, neighbouring nodes corresponding to the current node are determined in the current picture, and after the reference node corresponding to the current node is determined in the reference picture corresponding to the current picture, the prediction value of the current node may be further determined according to the first prediction value of the reference node and the second prediction value of the neighbouring nodes.

It is understood that in an embodiment of the present disclosure, the first prediction value may be an inter prediction value corresponding to the current node, and the second prediction value may be an intra prediction value corresponding to the current node.

It should be noted that, in the embodiment of the present disclosure, when determining the prediction value of the current node based on the first prediction value of the reference node and the second prediction value of the neighbouring nodes, it is possible to first determine the first weight corresponding to the first prediction value, while determine the second weight corresponding to the second prediction value. Then, a weighted calculation on the first prediction value and the second prediction value according to the first weight and the second weight, to determine the prediction value of the current node.

It is understood that in the embodiment of the present disclosure, the first mode may be a prediction mode in which the intra prediction and the inter prediction are weighted, that is, the prediction mode of the first mode may assign a certain weight to the inter prediction value and the intra prediction value, and finally obtain the attribute prediction value of the current node by linear weighted prediction. Therefore, after determining that the prediction mode corresponding to the current node is the first mode, in addition to determining the intra prediction value and the inter prediction value corresponding to the current node, it is also necessary to determine the weight values corresponding to the inter prediction value and the intra prediction value, and then use the weight values for subsequent weighted operation processing.

Note that, in an embodiment of the present disclosure, the first weight corresponding to the first prediction value is a weight value of the inter prediction value corresponding to the current node, and the second weight corresponding to the second prediction value is a weight value of the intra prediction value corresponding to the current node.

Further, in the embodiment of the present disclosure, when determining the prediction value of the current node according to the first prediction value of the reference node and the second prediction value of the neighbouring nodes, it is first determined whether the current node has a collocated node in the prediction buffer, that is, whether the reference node exists, if so, the inter prediction value corresponding to the current node may be determined, and the prediction value predVal of the current node can be determined according to the inter prediction value predInterVal, the intra prediction value predIntraVal corresponding to the current node, and the corresponding weight values, as shown in formula (34). Where w1 is a weight of inter prediction, i.e., a first weight, and w2 is a weight value of intra prediction, i.e., a second weight.

For example, in some embodiments, it is possible to first determine whether the current node (current point) has a collocated node in the prediction buffer, if so, it is assumed that the inter prediction value is predInterVal, and it is determined whether the current node can perform intra prediction, and if intra prediction can be performed, it is assumed that the intra prediction value of the current node is predIntraVal, and the prediction value of the current node can be calculated by the above formula (34).

Further, in an embodiment of the present disclosure, when determining the first weight corresponding to the first prediction value and the second weight corresponding to the second prediction value, the first weight and the second weight may be determined according to the rate-distortion optimization algorithm, and then the first weight and the second weight may be signalled in the bitstream. Accordingly, at the decoding end, the first weight and the second weight corresponding to the current node may be obtained by decoding the bitstream. That is, the first weight and the second weight may be transmitted from the encoding end to the decoding end through the bitstream.

Further, in the embodiment of the present disclosure, when determining the first weight corresponding to the first prediction value and the second weight corresponding to the second prediction value, temporal interval information between the current picture and the reference picture may be determined first. Furthermore, a first initial weight corresponding to the first prediction value may be determined, and a second initial weight corresponding to the second prediction value may be determined. Further, the first weight may be determined according to the temporal interval information and the first initial weight, and the second weight may be determined according to the temporal interval information and the second initial weight.

It should be noted that, in the embodiment of the present disclosure, the first initial weight of the inter prediction value corresponding to the current node and the second initial weight of the intra prediction value may be determined first, and the first initial weight and the second initial weight may be signalled in the bitstream, and then the first initial weight and the second initial weight may be corrected by using the temporal interval information between the current picture and the reference picture, respectively, and finally the first weight and the second weight used for weighted operation processing may be obtained.

Further, in an embodiment of the present disclosure, when determining the first weight according to the temporal interval information and the first initial weight, the first weight may be determined using any calculation formula based on the temporal interval information and the first initial weight, and for example, a ratio between the first initial weight and the temporal interval information may be determined as the first weight.

Further, in an embodiment of the present disclosure, when determining the second weight according to the temporal interval information and the second initial weight, the second weight may be determined using any calculation formula based on the temporal interval information and the second initial weight, and for example, a product between the second initial weight and the temporal interval information may be determined as the second weight.

That is, in the embodiment of the present disclosure, the first weight corresponding to the inter prediction value and the second weight corresponding to the intra prediction value may be determined by the temporal interval (temporal interval information) between the current picture and the reference picture. That is, the weight value used for the final weighted prediction processing of the inter prediction value and the intra prediction value can be adaptively obtained through the temporal interval between the current picture and the reference picture.

For example, in some embodiments, assuming that the first initial weight of the inter prediction value (first prediction value) of the current node (current point) is W1, the second initial weight corresponding to the intra prediction value (second prediction value) is W2, and the temporal interval (temporal interval information) between the current picture and the reference picture is D, the final calculated prediction value of the current node is predVal, as shown in formula (35). Where w1 is a final inter prediction weight value, that is, a first weight, w2 is a final intra prediction weight value, that is, a second weight, and w1 and w2 are calculated as shown in formulas (36) and (37).

Exemplarily, in some embodiments, it is possible to first determine whether the current node (current point) has a collocated node in the prediction buffer, if so, it is assumed that the inter prediction value is predInterVal, and it is determined whether the current node can perform intra prediction, and if intra prediction can be performed, it is assumed that the intra prediction value of the current node is predIntraVal, and the prediction value of the current node can be calculated by the above formula (35).

Further, in an embodiment of the present disclosure, when determining the first weight corresponding to the first prediction value and the second weight corresponding to the second prediction value, the time slot distance between the current picture and the reference picture and the number of neighbouring nodes of the current node in the current picture may be respectively determined first, and then the first weight may be determined according to the time slot distance between the current picture and the reference picture. While the second weight may be determined according to the number of neighbouring nodes corresponding to the current node.

That is, in the embodiment of the present disclosure, when determining the first weight corresponding to the inter prediction value and the second weight corresponding to the intra prediction value, the inter prediction weight, that is, the first weight, may be determined according to the time slot distance between the current picture and the reference picture; and the intra prediction weight, that is, the second weight, may be determined according to the neighbourhood node number (the number of neighbouring nodes corresponding to the current node).

Further, in the embodiment of the present disclosure, for the second mode, if there is a reference node corresponding to the current node in the reference picture corresponding to the current picture, the prediction value of the current node may be directly determined according to the first prediction value of the reference node.

Further, in the embodiment of the present disclosure, for the second mode, if there is no reference node corresponding to the current node in the reference picture corresponding to the current picture, the prediction value of the current node may be determined according to the second prediction value of the neighbouring nodes.

That is, in the embodiment of the present disclosure, for the second mode, a prediction mode in which the inter prediction and the intra prediction are combined may be used when attribute information prediction is performed on the current node.

Exemplarily, in some embodiments, if the current node uses the second mode, an RAHT attribute transform encoding structure is first constructed based on the geometry information of the current node, that is, node merging is continuously performed at the voxel level until the root node of the entire RAHT transform tree is obtained, thereby completing the transform encoding hierarchical structure of the entire attribute. Then, according to the RAHT transform structure, attribute inter prediction is performed in the following manner.

Exemplarily, in some embodiments, if the inter prediction node of the current node is valid, i.e., a collocated node exists, the attribute of the prediction node may be directly taken as the attribute prediction value of the current node. That is, when the reference node corresponding to the current node exists in the reference picture corresponding to the current picture, the prediction value of the current node may be directly determined according to the first prediction value of the reference node.

Exemplarily, in some embodiments, if the inter prediction node of the current node is invalid, i.e., the collocated node does not exist, then the attribute prediction value of the intra neighbouring node may be taken as the attribute prediction value of the current node. That is, when the reference node corresponding to the current node does not exist in the reference picture corresponding to the current picture, the prediction value of the current node may be determined according to the second prediction value of the neighbouring nodes.

Further, in the embodiment of the present disclosure, it is possible to first determine whether the attribute prediction for the current node is allowed, and determine whether the inter attribute prediction for the current node is allowed, and then, in a case where the attribute prediction for the current node is allowed and the inter attribute prediction for the current node is allowed, the determination process for the prediction mode of the current node is performed, that is, the process of determining the prediction mode of operation 201 is performed.

It should be noted that, in the embodiment of the present disclosure, when determining whether the attribute prediction for the current node is allowed, it is possible to first determine the neighbourhood node number of the current node and the parent node neighbourhood node number of the current node. Then, when the neighbourhood node number of the current node is greater than the first threshold and the parent node neighbourhood node number is greater than the second threshold, it is determined that the attribute prediction for the current node is allowed.

It can be understood that in the embodiment of the present disclosure, when prediction coding is performed on the attribute transform coefficient of each point, there is an enabling condition of whether or not to enable the prediction coding, the details are as follows.

\textcircled{1} Whether the neighbourhood node number of the current node is greater than a first threshold.

\textcircled{2} Whether the parent node neighbourhood node number corresponding to the current node is greater than a second threshold.

The attribute coding coefficients of the current node are predicted if and only if both conditions are met simultaneously. However, the first threshold and the second threshold may be the same or different. Based on such encoding enabling conditions, the entire attribute prediction coding is completed.

It should be noted that, in the embodiment of the present disclosure, both the first threshold and the second threshold may be preset values in the encoder, and are used to determine whether the attribute prediction for the current node is allowed.

It should also be noted that, in the embodiment of the present disclosure, before the attribute encoding of the current node is performed, all the geometry information of the nodes in the current node cloud has been encoded.

In summary, in the embodiment of the present disclosure, through the coding and decoding method proposed in operation 201 described above, when the attribute information of the current node is encoded or decoded, if the attribute prediction can be performed on the current to-be-encoded layer, and when the attribute inter prediction is performed, the weighted prediction is performed by combining the inter prediction value and the intra prediction value of the current node in a certain manner, so as to obtain the optimal prediction value of the current node. The spatial-domain redundancy of different nodes in the current picture and the temporal correlation of the same node across different pictures can be more effectively considered, and the correlation of point cloud attributes can be further eliminated, thus further improving the attribute coding efficiency of the point cloud.

Thus, according to the encoding and decoding method proposed in the present disclosure, when performing RAHT prediction coding on attributes, a prediction coding mode (such as the prediction mode of the current node indicated by the prediction mode identification information corresponding to the current layer) is introduced into each RAHT coding layer to adaptively select an inter prediction coding mode combined with an intra prediction coding mode, or select a linear weighted intra prediction coding and an inter prediction coding mode, and finally pass the coding mode to the decoding end. The decoding end uses the coding mode to reconstruct the attributes of the point cloud.

It can be understood that, in the embodiment of the present disclosure, precisely because a coding mode is introduced in each RAHT coding layer, the coding mode (such as the first mode) can comprehensively consider the intra prediction and the inter prediction by weighting in a certain way, so that spatial-domain redundancy characteristics and temporal redundancy characteristics of different nodes can be further removed.

It should be noted that, in the embodiment of the present disclosure, the optimal coding mode (such as the first mode or the second mode) can be obtained by using the distortion optimization selection algorithm at the encoding end, and secondly, the attributes of the point cloud can be reconstructed by using the decoding mode at the decoding end.

Exemplarily, in some embodiments, the coding mode of each layer may be stored in the ABH, and the decoding mode of the coding layer of the RAHT may be obtained through the ABH at the decoding end, and there is no limitation on the form in which this parameter is encoded.

For example, in some embodiments, the prediction weights of the inter prediction value and the intra prediction value are not limited, and for example, the prediction weights of the inter prediction value and the intra prediction value can be adaptively selected by a rate-distortion optimization algorithm to obtain an optimal prediction value, thereby further improving the attribute coding efficiency of the point cloud.

The embodiment provides a method for encoding, at the encoding end, the encoder determines a prediction mode corresponding to a current node according to a rate-distortion optimization algorithm; or determines the prediction mode corresponding to the current node according to a correlation between the current node and a reference node corresponding to the current node in a reference picture, where the prediction mode includes a first mode and a second mode. That is, in the embodiment of the present disclosure, when the attribute information prediction is performed on the current node, if the prediction mode corresponding to the current node is the first mode, the prediction value of the attribute information of the current node may be determined by combining the inter prediction value of the reference node in the reference picture corresponding to the current node and the intra prediction value of the neighbouring nodes in the current picture corresponding to the current node. Thus, in the embodiment of the present disclosure, joint prediction encoding and decoding of the current node can be performed by using the inter prediction value and the intra prediction value corresponding to the current node, so that the spatial-domain correlation of different nodes in the current picture can be taken into account on the basis of considering the time slot correlation of node attributes between the current picture and the reference picture, that is, the temporal correlation and the spatial-domain correlation are combined, so as to improve the RAHT attribute coding efficiency of the point cloud, enhance the prediction effect of the attribute information, and effectively improve the encoding and decoding performance of the point cloud.

Based on the above-described embodiments, another embodiment of the present disclosure proposes a method for encoding and decoding, which is applied to a point cloud codec. The method may refer to a method for point cloud encoding and decoding, in particular a method for point cloud attribute encoding and decoding.

Exemplarily, in some embodiments, as shown in FIG. 42, for the RAHT attribute coding layer, the encoding order of the RAHT attribute transform is sequentially partitioned from the root node to the voxel level (1×1×1), thereby completing the encoding and attribute reconstruction of the entire point cloud attribute. Here, a layer obtained by downsampling along the Z direction, the Y direction and the X direction each time can be defined as an RAHT transform layer, i.e., a layer.

Exemplarily, in some embodiments, based on the RAHT attribute coding layer, a rate-distortion optimization algorithm may be introduced to adaptively select the prediction coding mode of the current layer, where two prediction coding modes may be introduced, including a first mode, i.e., a weighted intra and inter prediction coding, and a second mode, i.e., a combined intra and inter prediction coding mode.

It should be noted that, in the embodiment of the present disclosure, the rate-distortion optimization algorithm is used to perform prediction coding on the attribute information of nodes of the current layer by using two prediction modes at the encoding end. Finally, the optimal coding mode of the current layer is obtained by using the rate-distortion optimization algorithm and transmitted to the decoding end. The decoding end reconstructs and restores the attribute information of points of the current to-be-decoded layer by using the prediction decoding mode obtained by parsing. In the rate-distortion optimization algorithm, the distortion D between the reconstructed attribute and the original attribute of each prediction mode is first calculated, and the to-be-encoded bitstream R for each prediction mode is secondly obtained, and the rate-distortion cost is calculated as shown in formula (38), where λ can be calculated by attribute quantization parameter, and λ is calculated as shown in formula (39), and the parameter N is currently set to different values according to reflectance and colour.

Exemplarily, in some embodiments, the prediction coding mode of each layer may be ultimately added to the ABH parameter set and transmitted to the decoding end.

That is, in the embodiment of the present disclosure, for any prediction coding mode, the coding mode of the current layer can be determined by using a certain manner at the encoding end, and the coding mode of the current node can be transmitted to the decoding end. The decoding end can reconstruct and restore the attribute information of the current layer by using the prediction coding mode.

It should be noted that, in the embodiment of the present disclosure, the prediction decoding mode of the current layer may be implicitly derived in a certain manner, for example, the enabling of the inter prediction coding is determined by the correlation of geometry information between the current node and the prediction node. When the difference in the occupancy information between the inter prediction node and the current node is within a certain range, the inter prediction value is directly used as the prediction value of the current node. When the error is greater than a certain threshold, the inter prediction value and the intra prediction value are linearly weighted to obtain the optimal prediction value of the current node.

Exemplarily, in some embodiments, at the encoding end, it is possible to first adaptively determine whether attribute prediction can be applied to the nodes of the current layer according to the neighbourhood node number of the current layer and the parent node neighbourhood node number. If the attribute prediction and the attribute inter prediction can be applied to the nodes of the current layer, a rate-distortion optimization algorithm is introduced for the current layer, and the cost corresponding to each prediction coding mode is calculated by encoding each node of the current layer to obtain the optimal prediction coding mode.

Here, for the first mode, that is, a weighted intra and inter prediction, it is first determined whether the current node has a collocated node in the prediction buffer, if so, it is assumed that the inter prediction value is predInterVal, and it is determined whether the current node can perform intra prediction, and if it can perform intra prediction, it is assumed that the intra prediction value of the current node is predIntraVal, and the prediction value calculation of the current node is shown in formula (34).

It should be noted that, in the embodiment of the present disclosure, certain weights may be assigned for the inter prediction value and the intra prediction value, and finally the attribute prediction value of the current node may be obtained by linear weighted prediction, or the attribute inter and intra weighted prediction modes may be further modified, for example, the corresponding weight value may be adaptively obtained through temporal interval between the current picture and the reference picture.

Exemplarily, in some embodiments, it may be assumed that the inter prediction weight of the current node is W1 (first initial weight), the intra prediction weight is W2 (second initial weight), and the temporal interval between the current picture and the reference picture is D, then the final linear weighting manner is as shown in formula (35).

Then, it is possible to first determine whether the current node has a collocated node in the prediction buffer, if so, it is assumed that the inter prediction value is predInterVal, and it is determined whether the current node can perform intra prediction, and if it can perform intra prediction, it is assumed that the intra prediction value of the current node is predIntraVal, where w1 is the final inter prediction weight value, w2 is the final intra prediction weight value, and the calculation of w1 and w2 are shown in formulas (36) and (37).

For the second mode, that is, the combined intra and inter prediction coding mode, if the current node has a collocated node in the prediction buffer, the attribute prediction value predVal of the current node is predInterVal. Otherwise, if the current node can perform intra prediction, the attribute prediction value predVal of the current node is predIntraVal.

Further, in the embodiment of the present disclosure, after determining the prediction mode corresponding to the current node by using the rate-distortion algorithm, the optimal prediction coding mode is used to the prediction coding is finally performed on the attribute of nodes of the current layer.

Exemplarily, in some embodiments, at the decoding end, it is possible to first adaptively determine whether attribute prediction can be applied to the nodes of the current layer according to the neighbourhood node number of the current layer and the parent node neighbourhood node number. If the attribute prediction and the attribute inter prediction can be applied to the nodes of the current layer, the node obtains the optimal prediction decoding mode of the current layer. Finally, prediction decoding is performed on the attributes of nodes of the current layer by using the optimal prediction decoding mode.

In summary, in the embodiment of the present disclosure, through the encoding and decoding method described above, when the attribute information of the current node is encoded or decoded, if the attribute prediction can be performed on the current to-be-encoded layer, and when the attribute inter prediction is performed, the weighted prediction is performed by combining the inter prediction value and the intra prediction value of the current node in a certain manner, so as to obtain the optimal prediction value of the current node. The spatial-domain redundancy of different nodes in the current picture and the temporal correlation of the same node across different pictures can be more effectively considered, and the correlation of point cloud attributes can be further eliminated, thus further improving the attribute coding efficiency of the point cloud.

Thus, according to the encoding and decoding method proposed in the present disclosure, when performing RAHT prediction coding on attributes, a prediction coding mode (such as the prediction mode of the current node indicated by the prediction mode identification information corresponding to the current layer) is introduced into each RAHT coding layer to adaptively select an inter prediction coding mode combined with an intra prediction coding mode, or select a linear weighted intra prediction coding and an inter prediction coding mode, and finally pass the coding mode to the decoding end. The decoding end uses the coding mode to reconstruct the attributes of the point cloud.

It can be understood that, in the embodiment of the present disclosure, precisely because a coding mode is introduced in each RAHT coding layer, the coding mode (such as the first mode) can comprehensively consider the intra prediction and the inter prediction by weighting in a certain way, so that spatial-domain redundancy characteristics and temporal redundancy characteristics of different nodes can be further removed.

It should be noted that, in the embodiment of the present disclosure, the optimal coding mode (such as the first mode or the second mode) can be obtained by using the distortion optimization selection algorithm at the encoding end, and secondly, the attributes of the point cloud can be reconstructed by using the decoding mode at the decoding end.

Exemplarily, in some embodiments, the coding mode of each layer may be stored in the ABH, and the decoding mode of the coding layer of the RAHT may be obtained through the ABH at the decoding end, and there is no limitation on the form in which this parameter is encoded.

For example, in some embodiments, the prediction weights of the inter prediction value and the intra prediction value are not limited, and for example, the prediction weights of the inter prediction value and the intra prediction value can be adaptively selected by a rate-distortion optimization algorithm to obtain an optimal prediction value, thereby further improving the attribute coding efficiency of the point cloud.

The embodiment provides a method for decoding, at the decoding end, the decoder determines a prediction mode corresponding to a current node; in a case where the prediction mode is a first mode, determines neighbouring nodes corresponding to the current node in a current picture, and determines a reference node corresponding to the current node in a reference picture corresponding to the current picture; and determines a prediction value of the current node according to a first prediction value of the reference node and a second prediction value of the neighbouring nodes. At the encoding end, the encoder determines a prediction mode corresponding to a current node according to a rate-distortion optimization algorithm; or determines the prediction mode corresponding to the current node according to a correlation between the current node and a reference node corresponding to the current node in a reference picture, where the prediction mode includes a first mode and a second mode. That is, in the embodiment of the present disclosure, when the attribute information prediction is performed on the current node, if the prediction mode corresponding to the current node is the first mode, the prediction value of the attribute information of the current node may be determined by combining the inter prediction value of the reference node in the reference picture corresponding to the current node and the intra prediction value of the neighbouring nodes in the current picture corresponding to the current node. Thus, in the embodiment of the present disclosure, joint prediction encoding and decoding of the current node can be performed by using the inter prediction value and the intra prediction value corresponding to the current node, so that the spatial-domain correlation of different nodes in the current picture can be taken into account on the basis of considering the time slot correlation of node attributes between the current picture and the reference picture, that is, the temporal correlation and the spatial-domain correlation are combined, so as to improve the RAHT attribute coding efficiency of the point cloud, enhance the prediction effect of the attribute information, and effectively improve the encoding and decoding performance of the point cloud.

In still another embodiment of the present disclosure, based on the same inventive concept as the above embodiments, FIG. 44 illustrates a first schematic structural diagram of a composition of an encoder according to an embodiment of the present disclosure. As illustrated in FIG. 44, the encoder 100 may include a first determination unit 111.

The first determination unit 111 is configured to determine a prediction mode corresponding to a current node according to a rate-distortion optimization algorithm; or determine a prediction mode corresponding to the current node according to a correlation between the current node and a reference node corresponding to the current node in a reference picture, where the prediction mode includes a first mode and a second mode.

It should be noted that, in the embodiment of the present disclosure, the encoder 100 may also be regarded as a data processing mode (or “entropy encoder”) for performing encoding processing on the value of the to-be-encoded syntax element.

It may be understood that in the embodiments of the present disclosure, the “unit” may be a part of a circuit, a part of a processor, a part of a program or software, etc., and of course, it may also be a module, or may be non-modular. Moreover, in this embodiment, each component may be integrated in one processing unit, each unit may physically exist separately, or two or more units may be integrated in one unit. The above integrated unit may be implemented in the form of hardware or software functional modules.

If the integrated unit is implemented in the form of a software functional module and is not sold or used as an independent product, it may be stored in a computer readable storage medium. With this understanding, the technical solution of the present embodiment in essence or in part contributing to the prior art, or all or part of the technical solution may be embodied in the form of a software product. The computer software product is stored in a storage medium, and includes instructions for causing a computer device (which may be a personal computer, a server, a network device, etc.) or a processor to perform all or part of the steps of the methods of the present embodiments. The above storage medium includes a U disk, a removable hard disk, a Read Only Memory (ROM), a Random Access Memory (RAM), a magnetic disk or an optical disk and other medium capable of storing program codes.

Accordingly, the embodiments of the present disclosure provide a computer readable storage medium. The computer readable storage medium is applied to the encoder 100, and the computer readable storage medium stores a computer program. When the computer program is executed by the first processor, the method for encoding of any of the preceding embodiments is implemented.

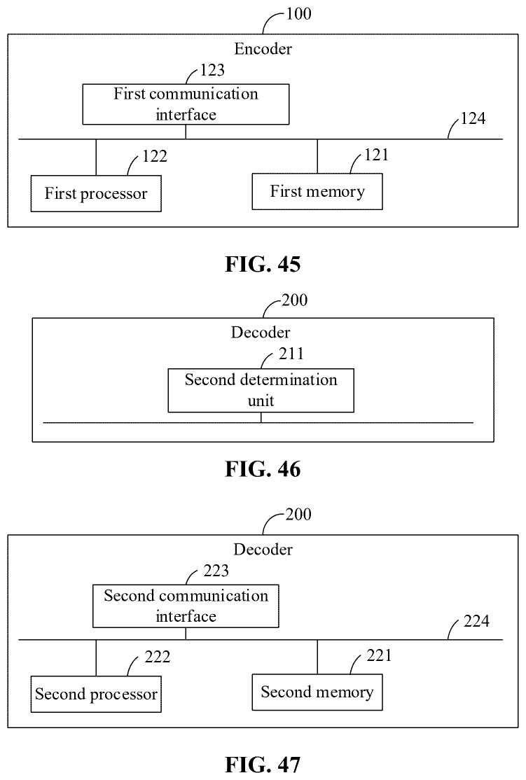

Based on the composition of the encoder 100 and the computer readable storage medium described above, FIG. 45 is a second schematic structural diagram of a composition of an encoder. As shown in FIG. 45, the encoder 100 may include a first memory 121 and a first processor 122, a first communication interface 123, and a first bus system 124. The first memory 121, the first processor 122, and the first communication interface 123 are coupled together by the first bus system 124. It may be understood that the first bus system 124 is used to implement connection communication between these components. The first bus system 124 includes a power bus, a control bus, and a status signal bus in addition to a data bus. However, for the sake of clarity of illustration, various buses are designated as the first bus system 124 in FIG. 10.

The first communication interface 123 is configured to receive and transmit signals in the process of transmitting and receiving information with other external network elements.

The first memory 121 is configured to store a computer program executable on the first processor.

The first processor 122 is configured to, when executing the computer program, determine a prediction mode corresponding to a current node according to a rate-distortion optimization algorithm; or determine a prediction mode corresponding to the current node according to a correlation between the current node and a reference node corresponding to the current node in a reference picture, where the prediction mode includes a first mode and a second mode.

It is understood that the first memory 121 in the embodiment of the present disclosure may be a volatile memory or a non-volatile memory, or may include both volatile and non-volatile memory. The non-volatile memory may be a ROM, a Programmable ROM (PROM), an Erasable PROM (EPROM), an Electrically EPROM (EEPROM), or a flash memory. The volatile memory may be a RAM, which serves as an external cache. By way of illustration but not limitation, many forms of RAM are available, such as a static RAM (SRAM), a Dynamic RAM (DRAM), a Synchronous DRAM (SDRAM), a Double Data Rate SDRAM (DDRSDRAM), an Enhanced SDRAM (ESDRAM), a Synchlink DRAM (SLDRAM) and a Direct Rambus RAM (DRRAM). The first memory 121 of the systems and methods described herein is intended to include, but is not limited to, these and any other suitable type of memory.

The first processor 122 may be an integrated circuit chip having signal processing capabilities. In implementation, the operations of the above method may be completed by integrated logic circuitry of hardware in the first processor 122 or instructions in the form of software. The above-described first processor 122 may be a general-purpose processor, a Digital Signal Processor (DSP), an Application Specific Integrated Circuit (ASIC), a Field Programmable Gate Array (FPGA) or other programmable logic device, a discrete gate or transistor logic device, or a discrete hardware component. The methods, steps, and logical block diagrams disclosed in the embodiments of the present disclosure may be implemented or executed. The general purpose processor may be a microprocessor or the processor may be any conventional processor or the like. The steps of the method disclosed in connection with the embodiments of the present disclosure may be directly embodied as execution by the hardware decoding processor, or may be executed by combining hardware and software modules in the decoding processor. The software module may be located in a storage medium mature in the art, such as a RAM, a flash memory, a ROM, a PROM, or an EEPROM, a register, etc. The storage medium is located in the first memory 121, and the first processor 122 reads the information in the first memory 121, and completes the steps of the above method in combination with its hardware.

It will be understood that the embodiments described herein may be implemented in hardware, software, firmware, middleware, microcode, or combinations thereof. For hardware implementation, the processing unit may be implemented in one or more Application Specific Integrated Circuits (ASICs), Digital Signal Processors (DSPs), DSP Devices (DSPDs), Programmable Logic Devices (PLDs), Field-Programmable Gate Arrays (FPGAs), general purpose processors, controllers, microcontrollers, microprocessors, other electronic units for performing the functions described herein, or combinations thereof. For software implementations, the techniques described herein may be implemented by modules (e.g., procedures, functions, etc.) that perform the functions described herein. The software code may be stored in memory and executed by a processor. The memory may be implemented in the processor or external to the processor.

Alternatively, as another embodiment, the first processor 122 is further configured to perform the method of any one of the preceding embodiments when executing the computer program.

This embodiment provides an encoder that determines a prediction mode corresponding to a current node according to a rate-distortion optimization algorithm; or determines the prediction mode corresponding to the current node according to a correlation between the current node and a reference node corresponding to the current node in a reference picture, where the prediction mode includes a first mode and a second mode. That is, in the embodiment of the present disclosure, when the attribute information prediction is performed on the current node, if the prediction mode corresponding to the current node is the first mode, the prediction value of the attribute information of the current node may be determined by combining the inter prediction value of the reference node in the reference picture corresponding to the current node and the intra prediction value of the neighbouring nodes in the current picture corresponding to the current node. Thus, in the embodiment of the present disclosure, joint prediction encoding and decoding of the current node can be performed by using the inter prediction value and the intra prediction value corresponding to the current node, so that the spatial-domain correlation of different nodes in the current picture can be taken into account on the basis of considering the time slot correlation of node attributes between the current picture and the reference picture, that is, the temporal correlation and the spatial-domain correlation are combined, so as to improve the RAHT attribute coding efficiency of the point cloud, enhance the prediction effect of the attribute information, and effectively improve the encoding and decoding performance of the point cloud.

In still another embodiment of the present disclosure, based on the same inventive concept as the above embodiments, FIG. 46 is a first schematic structural diagram of a composition of a decoder. As shown in FIG. 46, the decoder 200 may include a second determination unit 211.

The second determination unit 211 is configured to determine a prediction mode corresponding to a current node; in a case where the prediction mode is a first mode, determine neighbouring nodes corresponding to the current node in a current picture, and determine a reference node corresponding to the current node in a reference picture corresponding to the current picture; and determine a prediction value of the current node according to a first prediction value of the reference node and a second prediction value of the neighbouring nodes.

It should be noted that, in the embodiment of the present disclosure, the decoder 200 may also be regarded as a data processing mode (or “entropy decoder”), and is used to decode the value of the to-be-decoded syntax element.

It may be understood that in the present embodiment, the “unit” may be a part of a circuit, a part of a processor, a part of a program or software, etc., and of course, it may also be a module, or may be non-modular. Moreover, in this embodiment, each component may be integrated in one processing unit, each unit may physically exist separately, or two or more units may be integrated in one unit. The above integrated unit may be implemented in the form of hardware or software functional modules.

If the integrated unit is implemented in the form of a software functional module and is not sold or used as an independent product, it may be stored in a computer readable storage medium. With this understanding, the present embodiment provides a computer readable storage medium. The computer readable storage medium is applied to the decoder 200, and the computer readable storage medium stores a computer program. When the computer program is executed by the second processor, the method of any of the preceding embodiments is implemented.

Based on the composition of the decoder 200 and the computer readable storage medium described above, FIG. 47 is a second schematic structural diagram of a composition of a decoder. As shown in FIG. 47, the decoder 200 may include a second memory 221 and a second processor 222, a second communication interface 223, and a second bus system 224. The second memory 221 and the second processor 222, the second communication interface 223 are coupled together by the second bus system 224. It may be understood that the second bus system 224 is used to implement connection communication between these components. The second bus system 224 includes a power bus, a control bus, and a status signal bus in addition to a data bus. However, for the sake of clarity of illustration, various buses are designated as the second bus system 224 in FIGS. 12A to 12C.

The second communication interface 223 is configured to receive and transmit signals in the process of transmitting and receiving information with other external network elements.

The second memory 221 is configured to store a computer program executable on the second processor.

The second processor 222 is configured to, when the computer program is executed, determine a prediction mode corresponding to a current node; in a case where the prediction mode is a first mode, determine neighbouring nodes corresponding to the current node in a current picture, and determine a reference node corresponding to the current node in a reference picture corresponding to the current picture; and determine a prediction value of the current node according to a first prediction value of the reference node and a second prediction value of the neighbouring nodes.

It can be understood that the second memory 221 in the embodiments of the present disclosure may be a volatile memory or a non-volatile memory, or may include both the volatile memory and the non-volatile memory. The non-volatile memory can be a read-only memory (ROM), a programmable ROM (PROM), an erasable PROM (EPROM), an electrically EPROM (EEPROM) or a flash memory. The volatile memory can be a random access memory (RAM), which is used as an external cache. It is exemplarily but unlimitedly described that RAMs in various forms may be adopted, such as a Static RAM (SRAM), a Dynamic RAM (DRAM), a Synchronous DRAM (SDRAM), a Double Data Rate SDRAM (DDR SDRAM), an Enhanced SDRAM (ESDRAM), a Synchlink DRAM (SLDRAM) and a Direct Rambus RAM (DRRAM). The second memory 221 of the systems and methods described herein is intended to include, but is not limited to, memories of these and any other suitable type.

The second processor 222 may be an integrated circuit chip with signal processing capability. In the implementation process, various operations in the above method can be implemented by an integrated logic circuit of hardware in the second processor 222 or instructions in the form of software. The above mentioned second processor 222 can be a general purpose processor, a Digital Signal Processor (DSP), an Application Specific Integrated Circuit (ASIC), a Field Programmable Gate Array (FPGA) or other programmable logic devices, discrete gates or transistor logic devices, and discrete hardware components. Various methods, operations and logic block diagrams disclosed in the embodiments of the present disclosure can be implemented or executed. The general-purpose processor may be a microprocessor or the processor may be any conventional processor or the like. The operations of the methods disclosed in connection with the embodiments of the present disclosure can be directly embodied as being implemented by a hardware decoding processor, or by a combination of the hardware and software modules in the decoding processor. The software module can be located in a random memory, a flash memory, a read-only memory, a programmable read-only memory or an electrically erasable programmable memory, a register and other mature storage media in the art. The storage medium is located in the second memory 221, and the second processor 222 reads information in the second memory 221 and implements the operations of the above methods in combination with its hardware.

It can be understood that the embodiments described herein may be implemented in a hardware, a software, a firmware, a middleware, a microcode or a combination thereof. For a hardware implementation, the processing unit may be implemented in one or more ASICs, DSPs, DSP devices (DSPDs), Programmable Logic Devices (PLDs), FPGAs, general purpose processors, controllers, microcontrollers, microprocessors, other electronic units for performing the functions described herein, or combinations thereof. For a software implementation, the techniques described herein may be implemented by modules (e.g. procedures, functions, etc.) that perform the functions described herein. The software code may be stored in a memory and executed by a processor. The memory can be implemented inside the processor or outside the processor.

Optionally, as another embodiment, the second processor 222 is further configured to perform the method of any of the preceding embodiments when executing the computer program.

This embodiment provides a decoder that determines a prediction mode corresponding to a current node; in a case where the prediction mode is a first mode, determines neighbouring nodes corresponding to the current node in a current picture, and determines a reference node corresponding to the current node in a reference picture corresponding to the current picture; and determines a prediction value of the current node according to a first prediction value of the reference node and a second prediction value of the neighbouring nodes. That is, in the embodiment of the present disclosure, when the attribute information prediction is performed on the current node, if the prediction mode corresponding to the current node is the first mode, the prediction value of the attribute information of the current node may be determined by combining the inter prediction value of the reference node in the reference picture corresponding to the current node and the intra prediction value of the neighbouring nodes in the current picture corresponding to the current node. Thus, in the embodiment of the present disclosure, joint prediction encoding and decoding of the current node can be performed by using the inter prediction value and the intra prediction value corresponding to the current node, so that the spatial-domain correlation of different nodes in the current picture can be taken into account on the basis of considering the time slot correlation of node attributes between the current picture and the reference picture, that is, the temporal correlation and the spatial-domain correlation are combined, so as to improve the RAHT attribute coding efficiency of the point cloud, enhance the prediction effect of the attribute information, and effectively improve the encoding and decoding performance of the point cloud.

Further, an embodiment of the present disclosure further proposes a bitstream, where the bitstream is generated by bit encoding according to to-be-encoded information. The to-be-encoded information includes at least prediction mode identification information, a first weight, a second weight, a first initial weight, a second initial weight, an error threshold, a first threshold, or a second threshold.

Embodiments of the present disclosure provide a method for encoding, a method for decoding, a bitstream, an encoder, a decoder, and a storage medium, which can improve the RAHT attribute coding efficiency of the point cloud, enhance the prediction effect of the attribute information, and thereby effectively improve the encoding and decoding performance of the point cloud.

The technical solution of the embodiment of the present disclosure can be realized as follows.

According to a first aspect, an embodiment of the present disclosure provides a method for decoding, which is applied to a decoder, the method includes the following operations.

A prediction mode corresponding to a current node is determined.

In a case where the prediction mode is a first mode, neighbouring nodes corresponding to the current node are determined in a current picture, and a reference node corresponding to the current node is determined in a reference picture corresponding to the current picture.

A prediction value of the current node is determined according to a first prediction value of the reference node and a second prediction value of the neighbouring nodes.

According to a second aspect, an embodiment of the present disclosure provides a method for encoding, which is applied to an encoder, the method includes the following operations.

A prediction mode corresponding to a current node is determined according to a rate-distortion optimization algorithm.

Alternatively, the prediction mode corresponding to the current node is determined according to a correlation between the current node and a reference node corresponding to the current node in a reference picture, where the prediction mode includes a first mode and a second mode.

According to a third aspect, an embodiment of the present disclosure provides a bitstream. The bitstream is generated by bit encoding according to to-be-encoded information. Where the to-be-encoded information includes at least one of the following.

Prediction mode identification information, a first weight, a second weight, a first initial weight, a second initial weight, an error threshold, a first threshold, or a second threshold.

According to a fourth aspect, an embodiment of the present disclosure provides an encoder, which includes a first determination unit.

The first determination unit is configured to determine a prediction mode corresponding to a current node according to a rate-distortion optimization algorithm; or determine a prediction mode corresponding to the current node according to a correlation between the current node and a reference node corresponding to the current node in a reference picture, where the prediction mode includes a first mode and a second mode.

According to a fifth aspect, an embodiment of the present disclosure provides an encoder, which includes a first memory and a first processor.

The first memory is configured to store a computer program executable on the first processor.

The first processor is configured to perform the method according to the second aspect when executing the computer program.

According to a sixth aspect, an embodiment of the present disclosure provides a decoder, which includes a second determination unit.

The second determination unit configured to: determine a prediction mode corresponding to a current node; in a case where the prediction mode is a first mode, determine neighbouring nodes corresponding to the current node in a current picture, and determine a reference node corresponding to the current node in a reference picture corresponding to the current picture; and determine a prediction value of the current node according to a first prediction value of the reference node and a second prediction value of the neighbouring nodes.

According to a seventh aspect, an embodiment of the present disclosure provides a decoder, which includes a second memory and a second processor.

The second memory is configured to store a computer program executable on the second processor.

The second processor is configured to perform the method according to the first aspect when the computer program is executed.

According to an eighth aspect, an embodiment of the present disclosure provides a computer-readable storage medium, having stored thereon a computer program that, when executed, implements the method according to the first aspect or the method according to the second aspect.

An embodiment of the present disclosure provides a method for encoding, a method for decoding, a bitstream, an encoder, a decoder, and a storage medium. At the decoding end, the decoder determines a prediction mode corresponding to a current node; in a case where the prediction mode is a first mode, determines neighbouring nodes corresponding to the current node in a current picture, and determines a reference node corresponding to the current node in a reference picture corresponding to the current picture; and determines a prediction value of the current node according to a first prediction value of the reference node and a second prediction value of the neighbouring nodes. At the encoding end, the encoder determines a prediction mode corresponding to a current node according to a rate-distortion optimization algorithm; or determines the prediction mode corresponding to the current node according to a correlation between the current node and a reference node corresponding to the current node in a reference picture, where the prediction mode includes a first mode and a second mode. That is, in the embodiment of the present disclosure, when the attribute information prediction is performed on the current node, if the prediction mode corresponding to the current node is the first mode, the prediction value of the attribute information of the current node may be determined by combining the inter prediction value of the reference node in the reference picture corresponding to the current node and the intra prediction value of the neighbouring nodes in the current picture corresponding to the current node. Thus, in the embodiment of the present disclosure, joint prediction encoding and decoding of the current node can be performed by using the inter prediction value and the intra prediction value corresponding to the current node, so that the spatial-domain correlation of different nodes in the current picture can be taken into account on the basis of considering the time slot correlation of node attributes between the current picture and the reference picture, that is, the temporal correlation and the spatial-domain correlation are combined, so as to improve the RAHT attribute coding efficiency of the point cloud, enhance the prediction effect of the attribute information, and effectively improve the encoding and decoding performance of the point cloud.

It should be noted that in the present disclosure, the terms “comprising”, “including” or any other variation thereof are intended to encompass a non-exclusive inclusion such that a process, method, article, or apparatus including a series of elements includes not only those elements, but also other elements not explicitly listed, or elements inherent to such a process, method, article, or apparatus. Without further limitation, an element defined by the statement “including a” does not preclude the presence of additional identical elements in a process, method, article, or apparatus that includes the element.

The above-described serial numbers of the embodiments of the present disclosure are for description only, and do not represent the advantages and disadvantages of the embodiments.

The methods disclosed in several method embodiments provided in the present disclosure may be arbitrarily combined without conflict to obtain new method embodiments.

The features disclosed in several product embodiments provided in the present disclosure may be arbitrarily combined without conflict to obtain new product embodiments.

The features disclosed in several method or device embodiments provided in the present disclosure may be arbitrarily combined without conflict to obtain new method or device embodiments.

The above is merely specific embodiments of the present disclosure, but the scope of protection of the present disclosure is not limited thereto, and any person skilled in the art can easily think of changes or substitutions within the technical scope disclosed in the present disclosure, which should be covered within the scope of protection of the present disclosure. Therefore, the scope of protection of the present disclosure should be based on the scope of protection of the claims.

### INDUSTRIAL PRACTICALITY

An embodiment of the present disclosure provides a method for encoding, a method for decoding, a bitstream, an encoder, a decoder, and a storage medium. At the decoding end, the decoder determines a prediction mode corresponding to a current node; in a case where the prediction mode is a first mode, determines neighbouring nodes corresponding to the current node in a current picture, and determines a reference node corresponding to the current node in a reference picture corresponding to the current picture; and determines a prediction value of the current node according to a first prediction value of the reference node and a second prediction value of the neighbouring nodes. At the encoding end, the encoder determines a prediction mode corresponding to a current node according to a rate-distortion optimization algorithm; or determines the prediction mode corresponding to the current node according to a correlation between the current node and a reference node corresponding to the current node in a reference picture, where the prediction mode includes a first mode and a second mode. That is, in the embodiment of the present disclosure, when the attribute information prediction is performed on the current node, if the prediction mode corresponding to the current node is the first mode, the prediction value of the attribute information of the current node may be determined by combining the inter prediction value of the reference node in the reference picture corresponding to the current node and the intra prediction value of the neighbouring nodes in the current picture corresponding to the current node. Thus, in the embodiment of the present disclosure, joint prediction encoding and decoding of the current node can be performed by using the inter prediction value and the intra prediction value corresponding to the current node, so that the spatial-domain correlation of different nodes in the current picture can be taken into account on the basis of considering the time slot correlation of node attributes between the current picture and the reference picture, that is, the temporal correlation and the spatial-domain correlation are combined, so as to improve the RAHT attribute coding efficiency of the point cloud, enhance the prediction effect of the attribute information, and effectively improve the encoding and decoding performance of the point cloud.

1. A method for decoding, applied to a decoder, the method comprising:
determining a prediction mode corresponding to a current node;
in a case where the prediction mode is a first mode, determining neighbouring nodes corresponding to the current node in a current picture, and determining a reference node corresponding to the current node in a reference picture corresponding to the current picture; and
determining a prediction value of the current node according to a first prediction value of the reference node and a second prediction value of the neighbouring nodes.

2. The method according to claim 1, wherein determining the prediction mode corresponding to the current node comprises:
decoding a bitstream to determine prediction mode identification information corresponding to a current layer; and
determining the prediction mode corresponding to the current node in the current layer according to the prediction mode identification information.

3. The method according to claim 2, wherein determining the prediction mode corresponding to the current node in the current layer according to the prediction mode identification information comprises:
in a case where a value of the prediction mode identification information is a first value, determining that the prediction mode corresponding to the current node is the first mode; and
in a case where the value of the prediction mode identification information is a second value, determining that the prediction mode corresponding to the current node is a second mode.

4. The method according to claim 1, wherein determining the prediction mode corresponding to the current node comprises:
determining an error parameter between the current node and the reference node according to occupancy information of the current node and occupancy information of the reference node; and
determining the prediction mode according to the error parameter and an error threshold.

5. The method according to claim 4, wherein determining the prediction mode according to the error parameter and the error threshold comprises:
in a case where the error parameter is greater than or equal to the error threshold, determining that the prediction mode corresponding to the current node is the first mode; and
in a case where the error parameter is less than the error threshold, determining that the prediction mode corresponding to the current node is a second mode.

6. The method according to claim 2, wherein
the first mode is a prediction mode in which intra prediction and inter prediction are weighted; and
the second mode is a prediction mode in which intra prediction and inter prediction are combined.

7. The method according to claim 1, wherein determining the prediction value of the current node according to the first prediction value of the reference node and the second prediction value of the neighbouring nodes comprises:
determining a first weight corresponding to the first prediction value, and determining a second weight corresponding to the second prediction value; and
performing a weighted calculation on the first prediction value and the second prediction value according to the first weight and the second weight, to determine the prediction value of the current node.

8. The method according to claim 7, wherein determining the first weight corresponding to the first prediction value, and determining the second weight corresponding to the second prediction value comprises:
decoding a bitstream to determine the first weight and the second weight.

9. The method according to claim 7, wherein determining the first weight corresponding to the first prediction value, and determining the second weight corresponding to the second prediction value comprises:
determining temporal interval information between the current picture and the reference picture;
determining a first initial weight corresponding to the first prediction value, and determining a second initial weight corresponding to the second prediction value; and
determining the first weight according to the temporal interval information and the first initial weight, and determining the second weight according to the temporal interval information and the second initial weight.

10. The method according to claim 7, wherein determining the first weight corresponding to the first prediction value, and determining the second weight corresponding to the second prediction value comprises:
determining the first weight according to a time slot distance between the current picture and the reference picture; and
determining the second weight according to a number of neighbouring nodes corresponding to the current node.

11. The method according to claim 4, further comprising:
in a case where the prediction mode is the second mode, if the reference node corresponding to the current node exists in the reference picture corresponding to the current picture, determining the prediction value of the current node according to the first prediction value of the reference node.

12. The method according to claim 4, further comprising:
in a case where the prediction mode is the second mode, if the reference node corresponding to the current node does not exist in the reference picture corresponding to the current picture, determining the prediction value of the current node according to the second prediction value of the neighbouring nodes.

13. The method according to claim 1, further comprising:
performing a determination process for the prediction mode of the current node in a case where attribute prediction for the current node is allowed and inter attribute prediction for the current node is allowed.

14. The method according to claim 13, further comprising:
determining a neighbourhood node number of the current node and a parent node neighbourhood node number of the current node; and
determining that attribute prediction for the current node is allowed in a case where the neighbourhood node number of the current node is greater than a first threshold and the parent node neighbourhood node number is greater than a second threshold.

15. The method according to claim 2, wherein
the prediction mode identification information corresponding to the current layer is a syntax element corresponding to an Attribute Block Head (ABH).

16. A method for encoding, applied to an encoder, the method comprising:
determining a prediction mode corresponding to a current node according to a rate-distortion optimization algorithm; or
determining the prediction mode corresponding to the current node according to a correlation between the current node and a reference node corresponding to the current node in a reference picture, wherein the prediction mode comprises a first mode and a second mode.

17. The method according to claim 16, wherein determining the prediction mode corresponding to the current node according to the rate-distortion optimization algorithm comprises:
determining a first cost value corresponding to the first mode and a second cost value corresponding to the second mode according to the rate-distortion optimization algorithm; and
determining the prediction mode corresponding to the current node according to the first cost value and the second cost value.

18. The method according to claim 17, further comprising:
in a case of determining that the prediction mode corresponding to the current node is the first mode, determining that a value of prediction mode identification information corresponding to a current layer is a first value;
in a case of determining that the prediction mode corresponding to the current node is the second mode, determining that the value of the prediction mode identification information corresponding to the current layer is a second value; and
signalling the prediction mode identification information in a bitstream.

19. The method according to claim 16, wherein determining the prediction mode corresponding to the current node according to a correlation between the current node and the reference node corresponding to the current node in the reference picture comprises:
determining an error parameter between the current node and the reference node according to occupancy information of the current node and occupancy information of the reference node; and
determining the prediction mode according to the error parameter and an error threshold.

20. A non-transitory computer-readable storage medium, having a computer program and a bitstream stored thereon, wherein the computer program, when executed by a processor, enables the processor to perform operations to generate the bitstream, wherein the operations comprise:
determining a prediction mode corresponding to a current node according to a rate-distortion optimization algorithm; or
determining the prediction mode corresponding to the current node according to a correlation between the current node and a reference node corresponding to the current node in a reference picture, wherein the prediction mode comprises a first mode and a second mode.
